(19) United States
(12) Patent Application Publication
(10) Pub. No.: US 2009/0077001 A1
(43) Pub. Date: Mar. 19, 2009

(54) Integrating optimization directly into databases

(76) Inventors: William Macready, West Vancouver (CA); Kai Fan Tang, Vancouver (CA); Michael David Coury, Vancouver (CA); Ivan King Yu Sham, Markham (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/152,621

(22) Filed: May 14, 2008

Related U.S. Application Data
(63) Continuation-in-part of application No. 11/932,261, filed on Oct. 31, 2007.
(60) Provisional application No. 60/864,127, filed on Nov. 2, 2006.
(60) Provisional application No. 60/938,167, filed on May 15, 2007.
(60) Provisional application No. 60/987,010, filed on Nov. 9, 2007.

(51) Int. Cl. G06N 7/08; G06N 5/02; G06F 17/30; G06F 7/06

(52) U.S. Cl. 706/57; 706/46; 707/4; 707/E17.014

(57) ABSTRACT

Systems, methods and articles solve computationally complex problems. Example embodiments provide data query language features that may be used to express optimization problems. An expression of an optimization problem in the provided data query language may be transformed into a primitive problem that is equivalent to the optimization problem. An optimization solver may be invoked to provide a solution to the primitive problem. Analog processors such as quantum processors as well as digital processors may be used to solve the primitive problem. This abstract is provided to comply with rules requiring an abstract, and is submitted with the intention that it will not be used to interpret or limit the scope or meaning of the claims.

### CROSS-REFERENCE(S) TO RELATED APPLICATION(S)

This application is a continuation-in-part of U.S. patent application Ser. No. 11/932,261 filed Oct. 31, 2007, which claims benefit under 35 U.S.C. 119(e) to U.S. Provisional Patent Application No. 60/864,127 filed Nov. 2, 2006; this application also claims benefit under 35 U.S.C. 119(e) to U.S. Provisional Patent Application No. 60/938,167 filed May 15, 2007; and U.S. Provisional Patent Application No. 60/987,010 filed Nov. 9, 2007; each of which is hereby incorporated by reference in its entirety.

### FIELD OF THE DISCLOSURE

The present systems, methods and articles are generally related to application program interfaces for generating solutions to discrete optimization problems and complex search problems.

### BACKGROUND

A Turing machine is a theoretical computing system, described in 1936 by Alan Turing. A Turing machine that can efficiently simulate any other Turing machine is called a Universal Turing Machine (UTM). The Church-Turing thesis states that any practical computing model has either the equivalent or a subset of the capabilities of a UTM.

Analog computation involves using the natural physical evolution of a system as a computational system. A quantum computer is any physical system that harnesses one or more quantum effects to perform a computation. A quantum computer that can efficiently simulate any other quantum computer is called a Universal Quantum Computer (UQC).

In 1981 Richard P. Feynman proposed that quantum computers could be used to solve certain computational problems more efficiently than a UTM and therefore invalidate the Church-Turing thesis. See, e.g., Feynman R. P., “Simulating Physics with Computers”, International Journal of Theoretical Physics, Vol. 21 (1982) pp. 467-488. For example, Feynman noted that a quantum computer could be used to simulate certain other quantum systems, allowing exponentially faster calculation of certain properties of the simulated quantum system than is possible using a UTM.

Approaches to Quantum Computation

There are several general approaches to the design and operation of quantum computers. One such approach is the “circuit model” of quantum computation. In this approach, qubits are acted upon by sequences of logical gates that are the compiled representation of an algorithm. Circuit model quantum computers have several serious barriers to practical implementation. In the circuit model, it is required that qubits remain coherent over time periods much longer than the single-gate time. This requirement arises because circuit model quantum computers require operations that are collectively called quantum error correction in order to operate. Quantum error correction cannot be performed without the circuit model quantum computer's qubits being capable of maintaining quantum coherence over time periods on the order of 1,000 times the single-gate time. Much research has been focused on developing qubits with coherence sufficient to form the basic information units of circuit model quantum computers. See, e.g., Shor, P. W. “Introduction to Quantum Algorithms,” arXiv.org:quant-ph/0005003 (2001), pp. 1-27. The art is still hampered by an inability to increase the coherence of qubits to acceptable levels for designing and operating practical circuit model quantum computers.

Another approach to quantum computation, involves using the natural physical evolution of a system of coupled quantum systems as a computational system. This approach does not make critical use of quantum gates and circuits. Instead, starting from a known initial Hamiltonian, it relies upon the guided physical evolution of a system of coupled quantum systems wherein the problem to be solved has been encoded in the terms of the system's Hamiltonian, so that the final state of the system of coupled quantum systems contains information relating to the answer to the problem to be solved. This approach does not require long qubit coherence times. Examples of this type of approach include adiabatic quantum computation, cluster-state quantum computation, one-way quantum computation, quantum annealing and classical annealing, and are described, for example, in Farhi, E. et al., “Quantum Adiabatic Evolution Algorithms versus Simulated Annealing,” arXiv.org:quant-ph/0201031 (2002), pp 1-16.

Qubits

As mentioned previously, qubits can be used as fundamental units of information for a quantum computer. As with bits in UTMs, qubits can refer to at least two distinct quantities; a qubit can refer to the actual physical device in which information is stored, and it can also refer to the unit of information itself, abstracted away from its physical device. Examples of qubits include quantum particles, atoms, electrons, photons, ions, and the like.

Qubits generalize the concept of a classical digital bit. A classical information storage device can encode two discrete states, typically labeled “0” and “1”. Physically these two discrete states are represented by two different and distinguishable physical states of the classical information storage device, such as direction or magnitude of magnetic field, current, or voltage, where the quantity encoding the bit state behaves according to the laws of classical physics. A qubit also contains two discrete physical states, which can also be labeled “0” and “1”. Physically these two discrete states are represented by two different and distinguishable physical states of the quantum information storage device, such as direction or magnitude of magnetic field, current, or voltage, where the quantity encoding the bit state behaves according to the laws of quantum physics. If the physical quantity that stores these states behaves quantum mechanically, the device can additionally be placed in a superposition of 0 and 1. That is, the qubit can exist in both a “0” and “1” state at the same time, and so can perform a computation on both states simultaneously. In general, N qubits can be in a superposition of 2^{N} states. Quantum algorithms make use of the superposition property to speed up some computations.

In standard notation, the basis states of a qubit are referred to as the |0> and |1> states. During quantum computation, the state of a qubit, in general, is a superposition of basis states so that the qubit has a nonzero probability of occupying the |0> basis state and a simultaneous nonzero probability of occupying the |1> basis state. Mathematically, a superposition of basis states means that the overall state of the qubit, which is denoted |Ψ>, has the form |Ψ>=a|0>+b|1>, where a and b are coefficients corresponding to the probabilities |a|² and |b|², respectively. The coefficients a and b each have real and imaginary components, which allows the phase of the qubit to be characterized. The quantum nature of a qubit is largely derived from its ability to exist in a coherent superposition of basis states and for the state of the qubit to have a phase. A qubit will retain this ability to exist as a coherent superposition of basis states when the qubit is sufficiently isolated from sources of decoherence.

To complete a computation using a qubit, the state of the qubit is measured (i.e., read out). Typically, when a measurement of the qubit is performed, the quantum nature of the qubit is temporarily lost and the superposition of basis states collapses to either the |0> basis state or the |1> basis state and thus regaining its similarity to a conventional bit. The actual state of the qubit after it has collapsed depends on the probabilities |a|² and |b|² immediately prior to the readout operation.

Superconducting Qubits

There are many different hardware and software approaches under consideration for use in quantum computers. One hardware approach uses integrated circuits formed of superconducting materials, such as aluminum or niobium. Some of the technologies and processes involved in designing and fabricating superconducting integrated circuits are similar in some respects to those used for conventional integrated circuits.

Superconducting qubits are a type of superconducting device that can be included in a superconducting integrated circuit. Typical superconducting qubits, for example, have the advantage of scalability and are generally classified depending on the physical properties used to encode information including, for example, charge and phase devices, phase or flux devices, hybrid devices, and the like. Superconducting qubits can be separated into several categories depending on the physical property used to encode information. For example, they may be separated into charge, flux and phase devices, as discussed in, for example Makhlin et al., 2001, Reviews of Modern Physics 73, pp. 357-400. Charge devices store and manipulate information in the charge states of the device, where elementary charges consist of pairs of electrons called Cooper pairs. A Cooper pair has a charge of 2e and consists of two electrons bound together by, for example, a phonon interaction. See, e.g., Nielsen and Chuang, Quantum Computation and Quantum Information, Cambridge University Press, Cambridge (2000), pp. 343-345. Flux devices store information in a variable related to the magnetic flux through some part of the device. Phase devices store information in a variable related to the difference in superconducting phase between two regions of the phase device. Recently, hybrid devices using two or more of charge, flux and phase degrees of freedom have been developed. See, e.g., U.S. Pat. No. 6,838,694 and U.S. Patent Application Publication No. 2005-0082519.

Examples of flux qubits that may be used include rf-SQUIDs, which include a superconducting loop interrupted by one Josephson junction, or a compound junction (where a single Josephson junction is replaced by two parallel Josephson junctions), or persistent current qubits, which include a superconducting loop interrupted by three Josephson junctions, and the like. See, e.g., Mooij et al., 1999, Science 285, 1036; and Orlando et al., 1999, Phys. Rev. B 60, 15398. Other examples of superconducting qubits can be found, for example, in Il'ichev et al., 2003, Phys. Rev. Lett. 91, 097906; Blatter et al., 2001, Phys. Rev. B 63, 174511, and Friedman et al., 2000, Nature 406, 43. In addition, hybrid charge-phase qubits may also be used.

The qubits may include a corresponding local bias device. The local bias devices may include a metal loop in proximity to a superconducting qubit that provides an external flux bias to the qubit. The local bias device may also include a plurality of Josephson junctions. Each superconducting qubit in the quantum processor may have a corresponding local bias device or there may be fewer local bias devices than qubits. In some embodiments, charge-based readout and local bias devices may be used. The readout device(s) may include a plurality of dc-SQUID magnetometers, each inductively connected to a different qubit within a topology. The readout device may provide a voltage or current. The dc-SQUID magnetometers including a loop of superconducting material interrupted by at least one Josephson junctions are well known in the art.

Quantum Processor

A computer processor may take the form of an analog processor, for instance a quantum processor such as a superconducting quantum processor. A quantum processor may include a number of qubits and associated local bias devices, for instance two or more superconducting qubits.

A quantum processor may include a number of coupling devices operable to selectively couple respective pairs of qubits. Examples of superconducting coupling devices include rf-SQUIDs and dc-SQUIDs, which couple qubits together by flux. SQUIDs include a superconducting loop interrupted by one Josephson junction (an rf-SQUID) or two Josephson junctions (a dc-SQUID). The coupling devices may be capable of both ferromagnetic and anti-ferromagnetic coupling, depending on how the coupling device is being utilized within the interconnected topology. In the case of flux coupling, ferromagnetic coupling implies that parallel fluxes are energetically favorable and anti-ferromagnetic coupling implies that anti-parallel fluxes are energetically favorable. Alternatively, charge-based coupling devices may also be used. Other coupling devices can be found, for example, in U.S. Patent Application Publication No. 2006-0147154, U.S. Provisional Patent Application No. 60/886,253, U.S. Provisional Patent Application No. 60/915,657 and U.S. Provisional Patent Application No. 60/975,083. Respective coupling strengths of the coupling devices may be tuned between zero and a maximum value, for example, to provide ferromagnetic or anti-ferromagnetic coupling between qubits.

Databases and Query Languages

Many entities employ relational databases to store information. The information may be related to almost any aspect of business, government or individuals. For example, the information may be related to human resources, transportation, order placement or picking, warehousing, distribution, budgeting, oil exploration, surveying, polling, images, geographic maps, network topologies, identification, security, commercial transactions, etc.

A relational database stores a set of “relations” or “relationships.” A relation is a two-dimensional table. The columns of the table are called attributes and the rows of the table store instances or “tuples” of the relation. A tuple has one element for each attribute of the relation. The schema of the relation consists of the name of the relation and the names and data types of all attributes. Typically, many such relations are stored in the database with any given relation having perhaps millions of tuples.

Searching databases typically employs the preparation of one or more queries expressed in a declarative language, such as a data query language. One common way of formatting queries is through Structured Query Language (SQL). SQL-99 is the most recent standard, however many database vendors offer slightly different dialects or extensions of this standard. The basic query mechanism in SQL is the statement: SELECT L FROM R WHERE C, in which L identifies a list of columns in the relation(s) R, and c is a condition that evaluates to TRUE, FALSE or UNKNOWN. Typically, only tuples that evaluate to TRUE are returned. Other query languages are also known, for example DATALOG, which may be particularly useful for recursive queries.

In addition, work has been done to add the ability to specify preferences with SQL, which has resulted in Preference SQL. The syntax for this this functionality is the SELECT FROM WHERE PREFERRING command where the PREFERRING block allows a user to specify preferences. This specification enables one to search for best matching objects in a database by preference conditions. A careful design of preferences has resulted in implementations that are both natural to the kinds of preferences usually desired by users, and efficiently implementable. Nevertheless, the class of preferences that can be expressed is limited. Further details regarding Preference SQL may be found in W. Kieβling et al, “Preference SQL—design, implementation, experience,” Proceedings of the 28th International Conference on Very Large Data Bases, 2002.

Traditional querying or searching of databases presents a number of problems. Boolean matching is particularly onerous and unforgiving. Hence, searchers must specify a query that will locate the desired piece of information, without locating too much undesired information. Overly constrained queries will have no exact answer. Queries with insufficient constraints will have too many answers to be useful. Thus, the searcher must correctly constrain the query, with a suitable number of correctly selected constraints.

In addition, existing query languages may not be well suited to the concise expression and/or solution of complex problems, such as search and/or optimization problems. This problem is related to the operation of the standard SQL SELECT statement, which includes a tuple in a result set when a specified condition is true for the tuple. In addition, even though it may be possible to solve some search and/or optimization problems using one or more SELECT statements and other standard SQL language features, such solutions may be awkward and lengthy, making them difficult to comprehend, maintain, and/or debug. Furthermore, such solutions typically do not scale well as the size of the problem domain increases. For example, for some solutions, one or more temporary tables may need to be created, and the number of rows in the temporary tables may increase as a function of the problem size.

Furthermore, existing optimization tools are typically not well integrated with database systems. An example system that may be used to express complex problems is the MX Solver, which is a logic-based, general-purpose framework for modeling search and/or optimization problems, by solving constraint satisfaction problems. The MX Solver may call solvers to find a solution to a provided constraint satisfaction problem and additionally translate the solution provided from the solver to the MX Solver into the logic-based, general-purpose framework. Further details regarding the operation of the MX Solver are provided in Mitchell et al., “Model Expansion as a Framework for Modelling and Solving Search Problems,” Simon Frasier University Technical Report TR 2006-24, 2006. The MX Solver, however, is not capable of accessing a database system to obtain data representative of a problem.

In addition, to interface a database with optimization tools currently available to users, infrastructure (e.g., a network, etc.) is required to connect the database and the optimization software and/or hardware. This infrastructure requires professionals to ensure any problems effecting the connection between database and the optimization hardware are corrected with minimal service interruption. The maintenance required to manage, sustain, or otherwise administer the connection between the database and the optimization software and/or hardware can be costly due to the professionals required to monitor the system. Also, the hardware costs of such infrastructure can be considerable depending upon the infrastructure and the types of connections that must be made between the database and the optimization hardware.

These problems limit the usefulness of existing data query languages and databases in particular, and various other programming or software development methodologies and technologies in particular.

Extensions of standard query languages such as relational algebra and SQL, by adding constraint modeling capabilities, has been discussed in Cadoli et al., “Combining Relational Algebra, SQL, Constraint Modeling, and Local Search”, arXiv.org:cs.AI/0601043 (2006), pp. 1-30.

### BRIEF DESCRIPTION OF THE DRAWINGS

FIG. 1A is a functional block diagram showing a computing system employing at least one analog processor and a relational database, according to at least one illustrated embodiment of the present systems, methods and articles.

FIG. 1B is a functional block diagram showing a computing system employing a relational database, according to at least one illustrated embodiment of the present systems, methods and articles.

FIG. 2 is a block diagram illustrating operation of, and interaction between, various functional modules that are configured to solve search problems, according to at least one illustrated embodiment of the present systems, methods and articles.

FIGS. 3A-3B illustrate various example search problems that may be solved by at least one illustrated embodiment of the present systems, methods and articles.

FIG. 4 is a flow diagram showing a method of operating a computing system to interact with an analog processor to solve a search problem, according to at least one illustrated embodiment of the present systems, methods and articles.

FIG. 5 is a flow diagram showing a method of operating a computing system to interact with a solver to solve a search problem, according to at least one illustrated embodiment of the present systems, methods and articles.

FIG. 6 is a flow diagram showing a method of operating a computing system to interact with a solver to solve a search problem, according to at least one illustrated embodiment of the present systems, methods and articles.

FIG. 7 is a flow diagram showing an exemplary method performed by an application program interface configured to obtain solutions to optimization problems by interacting with a server computing system operable to obtain problem solutions from an analog processor.

FIG. 8 is a flow diagram showing a method of operating a computing system to interact with a solver to solve a search problem, according to at least one illustrated embodiment of the present systems, methods and articles.

FIG. 9 is a flow diagram showing a method translating a problem expression in a data query language into an intermediate problem expression.

### SUMMARY

In one embodiment, a method for facilitate modeling and solving a constraint satisfaction and optimization problem may be summarized as comprising: receiving an indication of a statement in a data query language, the statement including an expression specifying source data, an expression specifying at least one constraint to apply to the source data, and an expression specifying at least one optimization criteria to apply to the source data that satisfies the at least one constraint; computationally translating the statement in a data query language into a first problem expression in an intermediate mathematical language; and computationally initiating at least one solvers to determine from the source data at least one solution that satisfies the at least one constraint and the at least one optimization criteria, based at least in part on the first problem expression in the intermediate language.

Another embodiment provides a computer-readable medium whose contents enable a computing system to facilitate modeling and solving constraint satisfaction and optimization problems, by: receiving an indication of a statement in a data query language, the statement specifying source data, at least one constraint to apply to the source data, and at least one optimization criteria to apply to the source data that satisfies the at least one constraint; computationally translating the statement in a data query language into a first problem expression in an intermediate mathematical language; and computationally initiating the at least one solver to determine from the source data at least one solution that satisfies the at least one constraint and the at least one optimization criteria, based at least in part on the first problem expression in the intermediate language.

In another embodiment, a computing system for modeling and solving constraint satisfaction and optimization problems may be summarized as comprising: one or more memories; and a data query language processing component configured to receive an indication of a statement in a data query language, the statement specifying source data, at least one constraint to apply to the source data, and at least one optimization criteria to apply to the source data; translate the statement in a data query language into a first problem expression in an intermediate mathematical language; and initiate at least one solver to determine from the source data at least one or more solution that satisfies the at least one constraint and the at least one optimization criteria, based at least in part on the first problem expression in the intermediate language.

In one embodiment, a method for processing problems expressed in a data query language may be summarized as comprising: receiving an expression in a data query language; interacting with an analog processor configured to determine a response to at least some of the received expression; and providing the determined response.

Another embodiment provides a computer-readable medium storing instructions for causing a computing system to process problems expressed in a data query language, by: receiving a statement in a data query language; utilizing an analog processor configured to determine a response to at least some of the received statement; and providing the determined response.

In another embodiment, a system for processing problems expressed in a data query language may be summarized as comprising: a memory; and a module stored on the memory that is configured, when executed, to: receive a query in a data query language; invoke an analog processor configured to determine an answer to a portion of the received query; and provide the determined answer.

In yet another embodiment, a method for processing problems expressed in a data query language may be summarized as comprising: receiving an expression in a data query language; transforming the received expression into a primitive problem expression; invoking an optimization solver configured to determine one or more solutions to the primitive problem expression; and providing the determined one or more solutions as a response to the received expression.

Another embodiment provides a computer-readable medium storing instructions for causing a computing system to process problems expressed in a data query language, by: receiving a query; transforming a portion of the received query into a primitive problem expression; invoking an optimization solver configured to determine one or more solutions to the primitive problem expression; and providing the determined one or more solutions as a response to the received query.

In yet another embodiment, a system for processing problems expressed in a data query language may be summarized as comprising: a memory; and a module stored on the memory that is configured, when executed, to: receive an statement in a data query language; compile a part of the received statement into a primitive problem expression; interact with an optimization solver configured to determine one or more solutions to the primitive problem expression; and provide the determined one or more solutions as a response to the received statement.

In another embodiment, a method for processing problems expressed in a data query language is provided, the method comprising: receiving an expression in a data query language; interacting with an analog processor configured to determine a response to at least some of the received expression; and providing the determined response.

Another embodiment provides a computer-readable medium storing instructions for causing a computing system to process problems expressed in a data query language, by performing a method comprising: receiving a statement in a data query language; utilizing an analog processor configured to determine a response to at least some of the received statement; and providing the determined response.

In another embodiment, a system for processing problems expressed in a data query language is provided, the system comprising: a memory; and a module stored on the memory that is configured, when executed, to: receive a query in a data query language; invoke an analog processor configured to determine an answer to a portion of the received query; and provide the determined answer.

In yet another embodiment, a method for processing problems expressed in a data query language is provided, the method comprising: receiving an expression in a data query language; transforming the received expression into a primitive problem expression; invoking an optimization solver configured to determine one or more solutions to the primitive problem expression; and providing the determined one or more solutions as a response to the received expression.

Another embodiment provides a computer-readable medium storing instructions for causing a computing system to process problems expressed in a data query language, by performing a method comprising: receiving a query; transforming a portion of the received query into a primitive problem expression; invoking an optimization solver configured to determine one or more solutions to the primitive problem expression; and providing the determined one or more solutions as a response to the received query.

In yet another embodiment, a system for processing problems expressed in a data query language is provided, the system comprising: a memory; and a module stored on the memory that is configured, when executed, to: receive an statement in a data query language; compile a part of the received statement into a primitive problem expression; interact with an optimization solver configured to determine one or more solutions to the primitive problem expression; and provide the determined one or more solutions as a response to the received statement.

### DETAILED DESCRIPTION

In the following description, certain specific details are set forth in order to provide a thorough understanding of various embodiments of the present systems, methods and articles. However, one skilled in the art will understand that the present systems, methods and articles may be practiced without these details. In other instances, well-known structures associated with computers have not been shown or described in detail to avoid unnecessarily obscuring descriptions of the embodiments of the present systems, methods and articles.

Unless the context requires otherwise, throughout the specification and claims which follow, the words “comprise” and “include” and variations thereof, such as, “comprises”, “comprising”, “includes” and “including” are to be construed in an open, inclusive sense, that is, as “including, but not limited to.” Reference throughout this specification to “one embodiment”, “an embodiment”, “one alternative”, “an alternative” or similar phrases means that a particular feature, structure or characteristic described is included in at least one embodiment of the present systems, methods and articles. Thus, the appearances of such phrases in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the present systems, methods and apparatus.

Unless the context requires otherwise, throughout the specification and claims which follow, references to a computer language, such as SQL, encompass various implementations of that language, regardless of whether the language standard is partially implemented or modifications have been introduced in a particular implementation. Thus, for example, when SQL is used, reference is intended to include real-world SQL implementations as used by various database servers (e.g., Oracle, MySQL, PostgreSQL, Microsoft SQL Server), regardless of an implementation's adherence to any of the SQL standards. For ease of understanding, SQL will be used as an illustrative declarative data query language and a relational database will be used as an exemplary data source but such should not be considered limiting. Those of skill in the art will appreciate that while data query languages such as SQL are occasionally referred to herein, reference to a particular data query language is for illustrative purposes only, and the present systems, methods and articles may be employed using any declarative language, data query language, and/or declarative language features provided in the context of other types of languages, such as object oriented languages, scripting languages, logic programming languages, etc.

In addition, various methods, systems, and articles for solving complex problems are discussed. Even though many examples described herein focus on generating solutions to constraint satisfaction problems, such examples are for illustrative purposes only, and the discussed techniques are equally applicable to optimization problems, such as logistics, planning, network utilization, etc., to constraint satisfaction problems, such as scheduling and configuration management, etc., as well as to other types of problems. Many classes of problems may be represented at least in part as constraint satisfaction problems. For example, an optimization problem may be expressed as a set of constraints over one or more variables and an objective function, where the goal is to find a set of values that satisfies the constraints and maximizes/minimizes the objective function and the optimization problem may be purely solved as a sequence of constraint satisfaction problems with no objective function. Accordingly, the described techniques may be utilized to solve, or to generate or construct systems that solve, a wide range of computationally complex problems. Constraint satisfaction and optimization problems may arise in many practical applications. Both constraint satisfaction problems and optimization problems are related to a search over a space of possible configurations to find one which meets a number of criteria. In some embodiments throughout this specification, constraint satisfaction and optimization problems are collectively referred to as search problems.

System Hardware

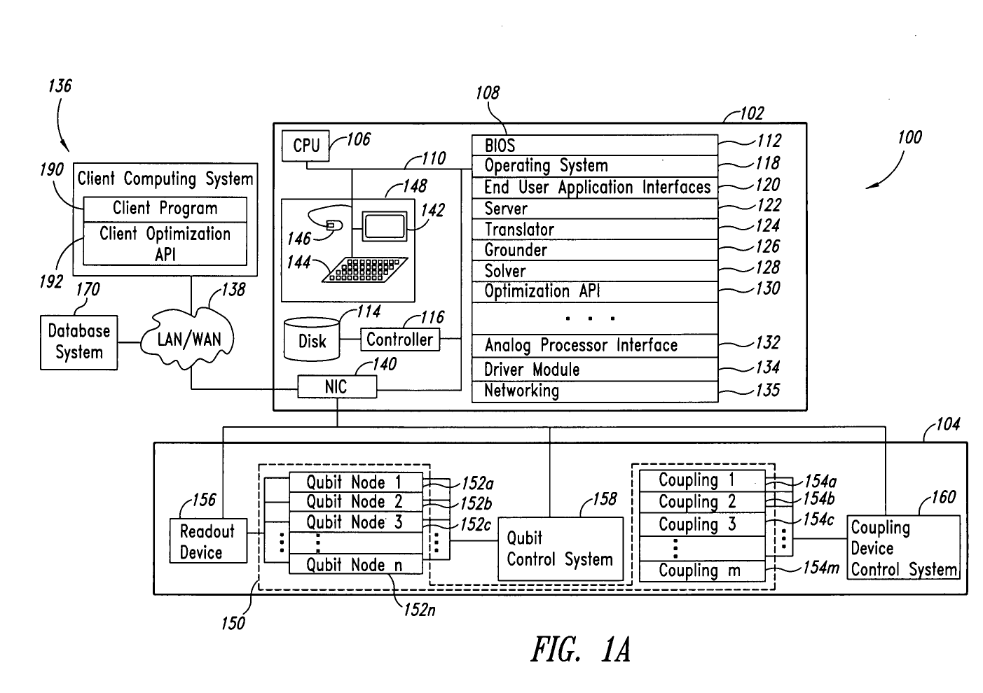

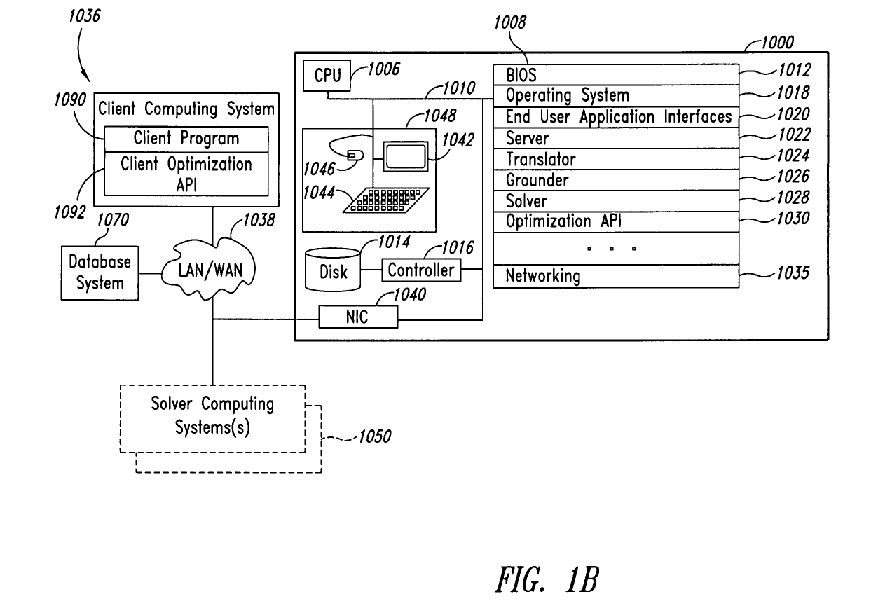

FIGS. 1A and 1B, as well as the following discussion, provide a brief and general description of suitable computing environments in which various embodiments of the computing system may be implemented. Although not required, embodiments will be described in the general context of computer-executable instructions, such as program application modules, objects or macros being executed by a computer. Those skilled in the relevant art will appreciate that the present systems, methods and apparatus can be practiced with other computing system configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

FIG. 1A shows a computing system 100 operable to solve search problems expressed in a data query language by interacting with an analog processor, according to one illustrated embodiment.

Computing system 100 includes a digital computing subsystem 102 and an analog computing subsystem 104 communicatively coupled to digital computing subsystem 102.

Digital computing subsystem 102 includes one or more processing units 106, system memories 108, and system buses 110 that couple various system components including system memory 108 to processing unit 106. Digital computing subsystem 102 will at times be referred to in the singular herein, but this is not intended to limit the application to a single digital computing subsystem 102 since in typical embodiments, there will be more than one digital computing subsystem 102 or other device involved. Other computing systems may be employed, such as conventional and personal computers, where the size or scale of the system allows. Processing unit 106 may be any logic processing unit, such as one or more central processing units (“CPUs”), digital signal processors (“DSPs”), application-specific integrated circuits (“ASICs”), etc. Unless described otherwise, the construction and operation of the various blocks shown in FIG. 1A are of conventional design. As a result, such blocks need not be described in further detail herein, as they will be understood by those skilled in the relevant art.

System bus 110 can employ any known bus structures or architectures, including a memory bus with memory controller, a peripheral bus, and a local bus. System memory 108 may include read-only memory (“ROM”) and random access memory (“RAM”). A basic input/output system (“BIOS”) 112, which can form part of the ROM, contains basic routines that help transfer information between elements within digital computing subsystem 102, such as during startup.

Digital computing subsystem 102 also includes non-volatile memory 114. Non-volatile memory 114 may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with processing unit 106 via system bus 110. The hard disk drive, optical disk drive and magnetic disk drive may include appropriate interfaces or controllers 116 coupled between such drives and system bus 110, as is known by those skilled in the relevant art. The drives, and their associated computer-readable media, provide non-volatile storage of computer readable instructions, data structures, program modules and other data for digital computing subsystem 102. Although the depicted digital computing subsystem 102 has been described as employing hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in system memory 108. For example, system memory 108 may store an operating system 118, end user application interfaces 120, server applications 122, one or more translator modules 124, one or more grounder modules 126, one or more solver modules 128, and/or one or more optimization application program interfaces (“APIs”) 130. Also, system memory 108 may additionally or alternatively store one or more analog processor interface modules 132, and/or driver modules 134. The operation and function of these modules are discussed in detail below.

System memory 108 may also include one or more networking applications 135, for example a Web server application and/or Web client or browser application for permitting digital computing subsystem 102 to exchange data with sources via the Internet, corporate Intranets, or other networks as described below, as well as with other server applications on server computers such as those further discussed below. Networking application 135 in the depicted embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

While shown in FIG. 1A as being stored in system memory 108, operating system 118 and various applications/modules 120, 122, 124, 126, 128, 130, 132, 134 and/or data can be stored on the hard disk of the hard disk drive, the optical disk of the optical disk drive and/or the magnetic disk of the magnetic disk drive.

Digital computing subsystem 102 can operate in a networked environment using logical connections to one or more client computing systems 136 (only one shown) and/or one or more database systems 170, such as one or more remote computers or networks. Digital computing subsystem 102 may be logically connected to one or more client computing systems 136 and/or database systems 170 under any known method of permitting computers to communicate, for example through a network 138 such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, digital computing subsystem 102 is connected to the LAN through an adapter or network interface card 140 (communicative linked to system bus 110). When used in a WAN networking environment, digital computing subsystem 102 may include an interface and modem (not shown) or other device, such as network interface card 140, for establishing communications over the WAN/Internet.

In a networked environment, program modules, application programs, or data, or portions thereof, can be stored in digital computing subsystem 102 for provision to the networked computers. In one embodiment, digital computing subsystem 102 is communicatively linked through network 138 with TCP/IP middle layer network protocols; however, other similar network protocol layers are used in other embodiments, such as user datagram protocol (“UDP”). Those skilled in the relevant art will readily recognize that the network connections shown in FIG. 1A are only some examples of establishing communications links between computers, and other links may be used, including wireless links.

While in most instances digital computing subsystem 102 will operate automatically, where an end user application interface is provided, an operator can enter commands and information into digital computing subsystem 102 through an end user application interface 148 including input devices, such as a keyboard 144, and a pointing device, such as a mouse 146. Other input devices can include a microphone, joystick, scanner, etc. These and other input devices are connected to processing unit 106 through end user application interface 120, such as a serial port interface that couples to system bus 110, although other interfaces, such as a parallel port, a game port, or a wireless interface, or a universal serial bus (“USB”) can be used. A monitor 142 or other display device is coupled to bus 110 via a video interface, such as a video adapter (not shown). Digital computing subsystem 102 can include other output devices, such as speakers, printers, etc.

Analog computing subsystem 104 includes an analog processor, for example, a quantum processor 150. Quantum processor 150 includes multiple qubit nodes 152a-152n (collectively 152) and multiple coupling devices 154a-154m (collectively 154).

Analog computing subsystem 104 includes a readout device 156 for reading out one or more qubit nodes 152. For example, readout device 156 may include multiple dc-SQUID magnetometers, with each dc-SQUID magnetometer being inductively connected to a qubit node 152 and NIC 140 receiving a voltage or current from readout device 156. The dc-SQUID magnetometers comprise a loop of superconducting material interrupted by two Josephson junctions and are well known in the art.

Analog computing subsystem 104 also includes a qubit control system 158 including controller(s) for controlling or setting one or more parameters of some or all qubit nodes 152. Analog computing subsystem 104 further includes a coupling device control system 160 including coupling controller(s) for coupling devices 154. For example, each coupling controller in coupling device control system 160 may be capable of tuning the coupling strength of a coupling device 154 between a minimum and a maximum value. Coupling devices 154 may be tunable to provide ferromagnetic or anti-ferromagnetic coupling between qubit nodes 152.

Analog processor interface module 132 may include run-time instructions for coordinating the solution of computational problems using quantum processor 150. For instance, analog processor interface module 132 may initiate quantum processor 150 to solve an embedded graph problem that is representative of, or equivalent to, a constraint satisfaction problem received by server application 122, discussed below. This may include, e.g., setting initial coupling values and local bias values for coupling devices 154 (FIG. 1A) and qubit nodes 152 respectively. Qubit nodes 152 and associated local bias values may represent vertices of embedded graph, and coupling values for coupling devices 154 may represent edges in embedded graph. For example, a vertex in a graph may be embedded into quantum processor 150 as a set of qubit nodes 152 coupled to each other ferromagnetically and coupling interactions may be embedded as a ferromagnetic or anti-ferromagnetic coupling between sets of coupled qubit nodes 152. For more information, see for example US 2005-0256007, US 2005-0250651 and U.S. Pat. No. 7,135,701 each titled “Adiabatic Quantum Computation with Superconducting Qubits”. Analog processor interface module 132 may also include instructions for reading out the states of one or more qubit nodes 152 at the end of an evolution. This readout may represent a solution to the computational problem.

Where computing system 100 includes a driver module 134, driver module 134 may include instructions to output signals to quantum processor 150. NIC 140 may include appropriate hardware required for interfacing with qubit nodes 152 and coupling devices 154, either directly or through readout device 156, qubit control system 158, and/or coupling device control system 160. Alternatively, NIC 140 may include software and/or hardware that translate commands from driver module 134 into signals (e.g., voltages, currents, optical signals, etc.) that are directly applied to qubit nodes 152 and coupling devices 154. In another alternative, NIC 140 may include software and/or hardware that translate signals (representing a solution to a problem or some other form of feedback) from qubit nodes 152 and coupling devices 154. In some cases, analog processor interface module 132 may communicate with driver module 134 rather than directly with NIC 140 in order to send and receive signals from quantum processor 150.

The functionality of NIC 140 can be divided into two classes of functionality: data acquisition and control. Different types of chips may be used to handle each of these discrete functional classes. Data acquisition is used to measure the physical properties of qubit nodes 152 after quantum processor 150 has completed a computation. Such data can be measured using any number of customized or commercially available data acquisition micro-controllers including, but not limited to, data acquisition cards manufactured by Elan Digital Systems (Fareham, UK) including the AD132, AD136, MF232, MF236, AD142, AD218 and CF241 cards. Alternatively, data acquisition and control may be handled by a single type of microprocessor, such as the Elan D403C or D480C. There may be multiple NICs 140 in order to provide sufficient control over qubit nodes 152 and coupling devices 154 and in order to measure the results of a computation conducted on quantum processor 150.

In the illustrated embodiment, server application 122 facilitates processing of various types of problems expressed in a data query language. In particular, server application 122 receives an expression in a data query language from one of the client computing systems 136. Server application 122 may determine whether the received expression reflects a search problem (e.g. constraint satisfaction, optimization, etc.) or a standard data query. If the received expression is a standard data query, server application 122 interacts with database system 170 to execute, interpret, evaluate, or otherwise process the received query in order to obtain a response (e.g., a result set). The obtained response is then forwarded by server application 122 to client computing system 136.

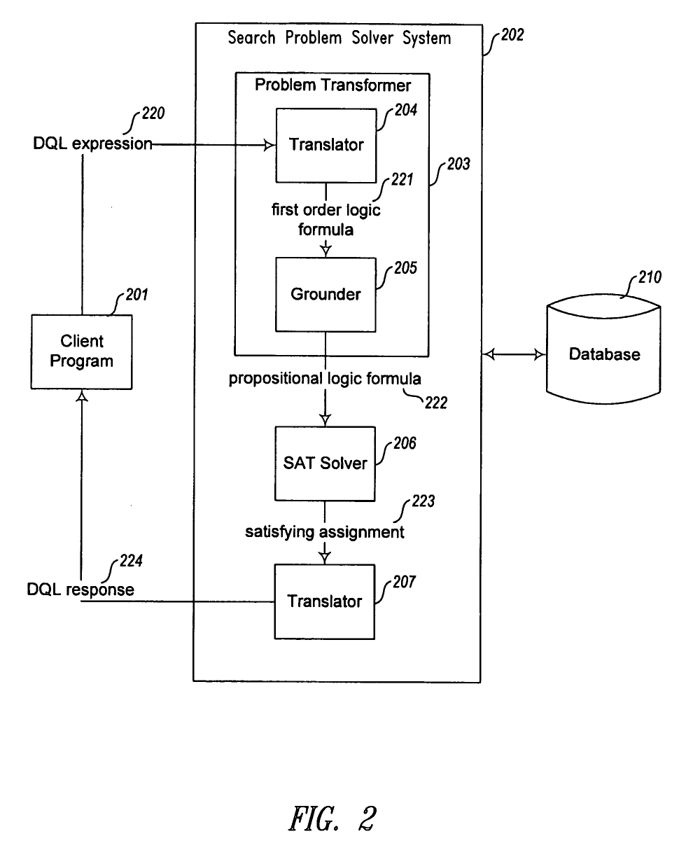

If the received expression reflects a search problem, the server application interacts with translator module 124, grounder modules 126, and/or solver module 128 to obtain a solution to the search problem. In one embodiment, translator module 124 converts the received expression into an intermediate problem expression, which is passed to grounder module 126. Grounder module 126 converts the intermediate problem expression into a primitive problem expression, which is passed to solver module 128. Solver module 128 then interacts with analog processor interface 132 to cause quantum processor 150 to provide a solution to the search problem, according to the received primitive problem expression. In other embodiments, the solver module 128 may instead, or in addition, interact with one or more solvers executing on one or more digital processors. In still other embodiments, the solver module 128 may solve the received primitive problem expression and provide a solution to the problem without interacting with another computing system or subsystem. The solution may then be translated (e.g., by translator module 124) into a response that may be forwarded (e.g., by server application 122) to client computing system 136. Additional details regarding the interaction between, and function of, translator module 124, grounder modules 126, and/or solver module 128 are described with reference to FIG. 2, below.

In addition, the one or more optimization APIs 130 implement a variety of interfaces that client computing systems may utilize to access functionality provided by computing system 100, such as the processing of various types of problems expressed in a data query language. Such interfaces may be provided and/or accessed via various protocols, such as RPC (“Remote Procedure Call”), RMI (“Remote Method Invocation”), HTTP, Web Services (XML-RPC, JAX-RPC, SOAP, etc.).

The client computing system 136 may include a client program 190 and a client optimization application program interface (“API”) 192. In some embodiments, the client program 190 may obtain a solution to a search problem by calling one or more functions provided by the API 192. The API 192 then interacts via the network 138 with the server application 122. The server application 122 operates as described above to obtain a solution to the search problem, and provide the solution to the API 192. Upon receiving the solution to the search problem, the API 192 provides the solution to the client program 190.

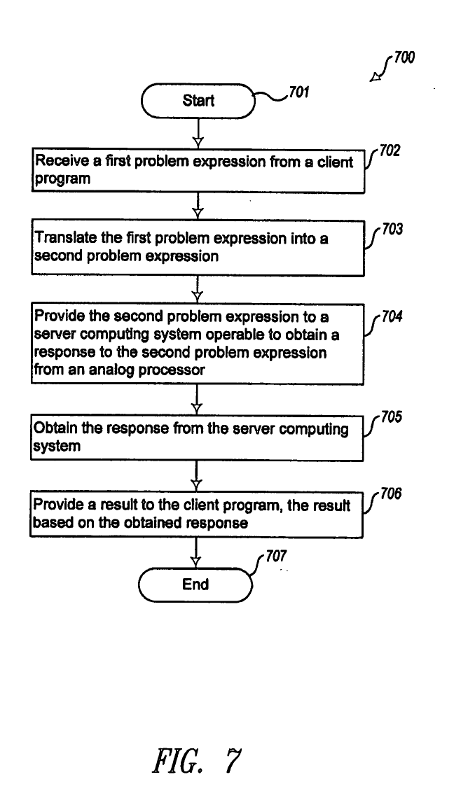

The API 192 may be implemented in various ways, including as a library, an archive, a collection of classes, etc. An example API is described with reference to FIG. 7 and Table 5, below.

FIG. 1B shows a computing system 1000 operable to solve search problems expressed in a data query language by interacting with one or more solvers executing on digital processors, according to one illustrated embodiment.

Computing system 1000 includes one or more processing units 1006, system memories 1008, and system buses 1010 that couple various system components including system memory 1008 to processing unit 1006. Computing system 1000 will at times be referred to in the singular herein, but this is not intended to limit the application to a computing system 1000. Processing unit 1006 may be any logic processing unit, such as one or more CPUs, DSPs, ASICs, etc. Unless described otherwise, the construction and operation of the various blocks shown in FIG. 1B are of conventional design. As a result, such blocks need not be described in further detail herein, as they will be understood by those skilled in the relevant art.

System bus 1010 can employ any known bus structures or architectures, including a memory bus with memory controller, a peripheral bus, and a local bus. System memory 1008 may include ROM and RAM. A BIOS 1012, which can form part of the ROM, contains basic routines that help transfer information between elements within computing system 1000, such as during startup.

Computing system 1000 also includes non-volatile memory 1014. Non-volatile memory 1014 may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with processing unit 1006 via system bus 1010. The hard disk drive, optical disk drive and magnetic disk drive may include appropriate interfaces or controllers 1016 coupled between such drives and system bus 1010, as is known by those skilled in the relevant art. The drives, and their associated computer-readable media, provide non-volatile storage of computer readable instructions, data structures, program modules and other data for computing system 1000. Although the depicted computing system 1000 has been described as employing hard disks, optical disks and/or magnetic disks, those skilled in the relevant art will appreciate that other types of non-volatile computer-readable media that can store data accessible by a computer may be employed, such a magnetic cassettes, flash memory cards, DVDs, Bernoulli cartridges, RAMs, ROMs, smart cards, etc.

Various program modules or application programs and/or data can be stored in system memory 1008. For example, system memory 1008 may store an operating system 1018, end user application interfaces 1020, server applications 1022, one or more translator modules 1024, one or more grounder modules 1026, one or more solver modules 1028, and/or one or more optimization application program interfaces (“APIs”) 1030.

System memory 1008 may also include one or more networking applications 1035, for example a Web server application and/or Web client or browser application for permitting computing system 1000 to exchange data with sources via the Internet, corporate Intranets, or other networks as described below, as well as with other server applications on server computers such as those further discussed below. Networking application 1035 in the depicted embodiment is markup language based, such as HTML, XML or WML, and operates with markup languages that use syntactically delimited characters added to the data of a document to represent the structure of the document.

While shown in FIG. 1B as being stored in system memory 1008, operating system 1018 and various applications/modules 1020, 1022, 1024, 1026, 1028, 1030 and/or data can be stored on the hard disk of the hard disk drive, the optical disk of the optical disk drive and/or the magnetic disk of the magnetic disk drive.

Computing system 1000 can operate in a networked environment using logical connections to one or more client computing systems 1036 (only one shown), one or more solver computing systems 1050 (dotted boxes in this illustrated embodiment indicate that the one or more solver computing systems 1050 are optional), and/or one or more database systems 1070, such as one or more remote computers or networks. Computing system 1000 may be logically connected to one or more client computing systems 1036, one or more solover computing systems 1050, and/or database systems 1070 under any known method of permitting computers to communicate, for example through a network 1038 such as a local area LAN and/or a WAN including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, computing system 1000 is connected to the LAN through an adapter or network interface card 1040 (communicatively linked to system bus 1010). When used in a WAN networking environment, computing system 1000 may include an interface and modem (not shown) or other device, such as network interface card 1040, for establishing communications over the WAN/Internet.

In a networked environment, program modules, application programs, or data, or portions thereof, can be stored in computing system 1000 for provision to the networked computers. In one embodiment, computing system 1000 is communicatively linked through network 1038 with TCP/IP middle layer network protocols; however, other similar network protocol layers are used in other embodiments, such as UDP. Those skilled in the relevant art will readily recognize that the network connections shown in FIG. 1B are only some examples of establishing communications links between computers, and other links may be used, including wireless links.

While in some embodiments computing system 1000 may operate automatically, where an end user application interface is provided, in other embodiments an operator may enter commands and information into computing system 1000 through an end user application interface 1048 including input devices, such as a keyboard 1044, and a pointing device, such as a mouse 1046. Other input devices can include a microphone, joystick, scanner, etc. These and other input devices are connected to processing unit 1006 through end user application interface 1020, such as a serial port interface that couples to system bus 1010, although other interfaces, such as a parallel port, a game port, or a wireless interface, or a universal serial bus USB can be used. A monitor 1042 or other display device is coupled to bus 1010 via a video interface, such as a video adapter (not shown). Computing system 1000 may include other output devices, such as speakers, printers, etc.

In the illustrated embodiment, solver computing systems 1050 may include one or more remote computing systems that provide solvers for solving constraint satisfaction and optimization problems. While the solver computing systems 1050 have been described as digital processor computing systems executing solvers, in other embodiments, solver computing systems 1050 may include one or more quantum computing processors, such as an analog processor described with regard to FIG. 1B.

In the illustrated embodiment, server application 1022 facilitates processing of various types of problems expressed in a data query language. In particular, server application 1022 receives an expression in a data query language from one of the client computing systems 1036. Server application 1022 may determine whether the received expression reflects a search problem or a standard data query. If the received expression is a standard data query, server application 1022 may interact with database system 1070 to execute, interpret, evaluate, or otherwise process the received query in order to obtain a response (e.g., a result set). The obtained response is then forwarded by server application 1022 to client computing system 1036.

If the received expression reflects a search problem, the server application may interact with translator module 1024, grounder modules 1026, and/or solver module 1028 to obtain a solution to the search problem. In some embodiments, translator module 1024 converts the received expression into an intermediate problem expression, which may be passed to grounder module 1026. Grounder module 1026 converts the intermediate problem expression into a primitive problem expression, which may be passed to solver module 1028. Solver module 1028 may then interacts with one or more solver computing systems 150 to obtain a solution to the search problem, according to the received primitive problem expression. In still other embodiments, the solver module 1028 may solve the received primitive problem expression and provide a solution to the problem without interacting with another solver. The solution may then be translated (e.g., by translator module 1024) into a response (e.g., a solution table, result set, etc.) that may be forwarded (e.g., by server application 1022) to client computing system 1036. Additional details regarding the interaction between, and function of, translator module 1024, grounder modules 1026, and/or solver module 1028 are described with reference to FIG. 2, below. In other embodiments, the illustrated translator module 1024 may interact directly with an embodiment of the solver module 1028 and/or with one or more solver computing systems 1050.

In addition, the one or more optimization APIs 1030 implement a variety of interfaces that client computing systems may utilize to access functionality provided by computing system 1000, such as the processing of various types of problems expressed in a data query language. Such interfaces may be provided and/or accessed via various protocols, such as RPC, RMI, HTTP, Web Services, etc. In some embodiments, the client computing system 1036 may interact with computing system 1000 to obtain a solution to a search problem, such as via execution of one or more components similar to the client program 1090 and client optimization API 1092 discussed above with respect to client computing system 1036 of FIG. 1B.

System Logic

FIG. 2 is a block diagram illustrating operation of, and interaction between, various functional modules that are configured to solve search problems, according to at least one illustrated embodiment of the present systems, methods and articles. In particular, FIG. 2 shows a search problem solver system 202 that is configured to facilitate the solution of constraint satisfaction and optimization problems expressed in a data query language. Search problem solver system 202 interacts with a client program 201 and a database 210 to obtain solutions to constraint satisfaction and optimization problems provided by client program 201. Search problem solver system 202 comprises a problem transformer module 203, a solver such as SAT (“satisfiability”) solver module 206, and a translator module 207. Problem transformer module 203 comprises a translator module 204 and a grounder module 205.

In the illustrated embodiment, search problem solver system 202 receives a data query language (“DQL”) expression 220 from client program 201. The received DQL expression 220 reflects a search problem to be solved by search problem solver system 202. For example, DQL expression 220 may reflect a search problem of finding the maximum independent set of nodes in a graph comprised of multiple nodes connected by edges. The graph may be stored in database 210 (e.g., as one or more tables). In response, the problem transformer module 203 transforms (e.g., compiles, translates, converts, etc.) DQL expression 220 into a logically equivalent primitive problem expression, such as a propositional logic formula 222.

The propositional logic formula 222 is an expression in a language or other format that is suitable for processing by SAT solver 206. SAT solver 206 is configured to efficiently determine a satisfying assignment of truth values for a given propositional logic formula. Hence, if the problem expressed by DQL expression 220 is to find a maximum independent set of nodes in a given graph, problem transformer module 203 may convert this problem into an equivalent primitive problem of finding a satisfying assignment for propositional logic formula 222, where finding such an assignment is equivalent to finding the maximum independent set for the given graph. The transformation performed by problem transformer module 203 may be based at least in part on data stored in, or provided by, database 210. For example, in the context of a given maximum independent set problem, the problem graph may be represented as one or more tables in database 210. In such a case, transforming DQL expression 220 may include extracting data that represents the problem graph from database 210 and incorporating the extracted data into propositional formula 222.

SAT solver module 206 determines a satisfying assignment for the propositional logic formula 222. SAT solver module 206 may perform this function in various ways, such as by interacting with an analog processor, such as quantum processor 150 described with reference to FIG. 1A. In other embodiments, SAT solver module 206 may instead, or in addition, solve the provided problem by way of a local or remote solver implementation executing on a digital computer, such as described with reference to FIG. 1B.

SAT solver module 206 provides as output a primitive problem solution, such as a satisfying assignment 223 to propositional logic formula 222. Translator module 207 takes satisfying assignment 223 and converts it into a data query language response 224 that is suitable for processing by client program 201. This may include translating and/or mapping satisfying assignment 223 into the domain of the original problem provided by the client program. For example, if the problem expressed by DQL expression 220 was to find the maximum independent set of nodes in a graph, and the graph was represented in database 210, satisfying assignment 223 would be mapped to a result (e.g., a result set, a solution table, etc.) based on the contents of database 210.

In the illustrated embodiment, problem transformer module 203 comprises translator module 204 and grounder module 205. Translator module 204 translates (e.g., compiles) the received DQL expression 220 into a first order logic formula 221. Grounder module 205 takes first order logic formula 221 and performs further conversion to generate propositional logic formula 222, such as by eliminating first order variables in first order logic formula 221 and replacing them with constant symbols. Note that in other embodiments, problem transformer module 203 may transform DQL expression 220 directly into a primitive problem expression (e.g., propositional logic formula 222) that is suitable for processing by a solver, without first translating DQL expression 220 into some intermediate form (e.g., first order logic formula).

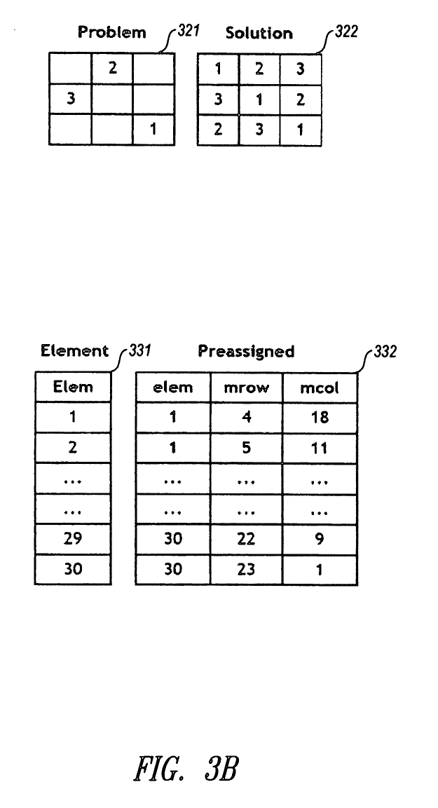

FIG. 4 shows a method 400 of interacting with an analog processor to solve a search problem, according to one illustrated embodiment. Method 400 may be performed by, for example, execution of a module such as search problem solver system 202 described with reference to FIG. 2. In other embodiments, method 400 may be performed by a module executing on a client computing system, such as a library or archive that provides an interface to a local and/or remote solver.

Method 400 starts at 401. At 402, the module receives an expression in a data query language. The expression may be received from, for example, a client program operating on a remote computing system that is communicatively coupled (e.g., via a network) to search problem solver system 202. The received expression may specify a constraint satisfaction problem, and may be a query (e.g., expressed in SQL-like syntax), etc.

At 403, the module interacts with an analog processor configured to determine a response to at least some of the received expression. In some cases, the expression may include at least some elements that are not for processing by the analog processor. In such cases, a first portion of the received expression may be translated or otherwise transformed into a representation suitable for processing by the analog processor, while a second portion of the received expression may be handled in other ways, such as by being processed as a generic database query, arithmetic expression, input/output directive, etc. In addition, the analog processor may be remote from constraint solver system 202.

At 404, the module provides the determined response, by, for example, transmitting the response to a remote client computing system, initiating display of the response on a display medium (e.g., a computer display screen), storing the response (e.g., on a hard disk, in memory, in a database system, etc.), etc. Method 400 terminates at 405, or alternatively may repeat by returning to 401.

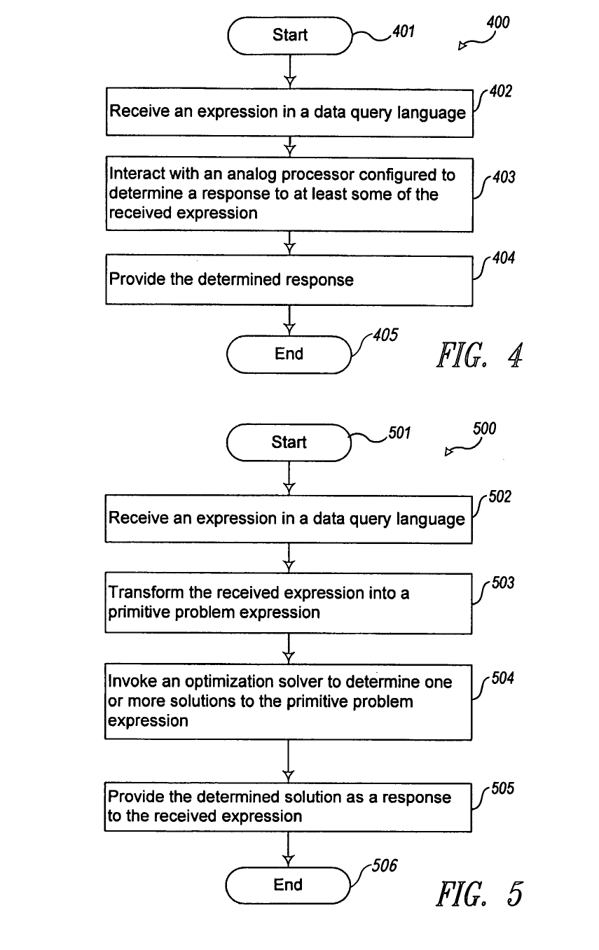

FIG. 5 shows a method 500 of interacting with a solver to solve a search problem, according to one illustrated embodiment. Method 500 may be performed by, for example, execution of a module such as search problem solver system 202 described with reference to FIG. 2. In other embodiments, method 500 may be performed by a module executing on a client computing system, such as a library or archive that provides an interface to a local and/or remote solver.

Method 500 starts at 501. At 502, the module receives an expression in a data query language. The query may be received from, for example, a client program operating on a remote computing system that is communicatively coupled (e.g., via a network) to constraint solver 202.

At 503, the module transforms the received expression into a primitive problem expression. Transforming the received expression may include compiling, translating, grounding, or mapping the received expression into one or more increasingly primitive problem expressions, such as first order predicate logic expressions, propositional logic expressions, etc.

At 504, the module invokes a solver to determine one or more solutions to the primitive problem expression. Invoking the solver may include selecting the solver based on various factors, such as user specified settings and/or preferences, cost, problem type, etc. Various types of solvers may be provided, such as one executing on a local or remote digital computing system or one executing on an analog processor such as a quantum computer.

At 505, the module provides the determined solution as a response to the received expression. Method 500 terminates at 506, or alternatively may repeat by returning to 501.

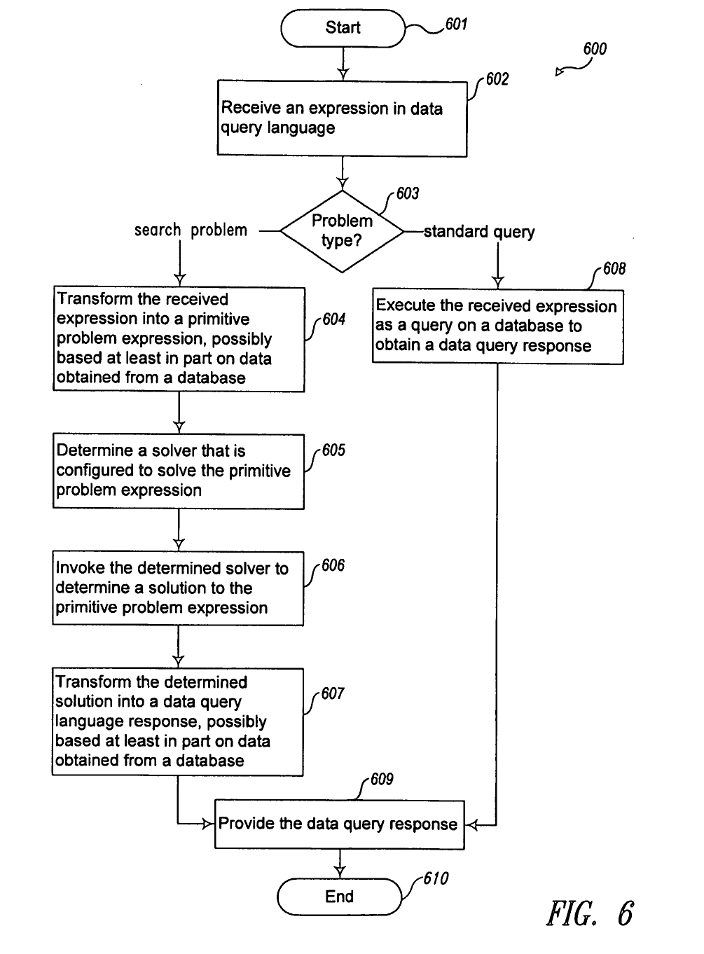

FIG. 6 shows a method 600 of interacting with a solver to solve a search problem, according to one illustrated embodiment. Method 600 may be performed by, for example, execution of a module such as search problem system 202 described with reference to FIG. 2. In other embodiments, the method may be performed by a module executing on a client computing system, such as a library or archive that provides an interface to a local and/or remote solver.

Method 600 starts at 601. At 602, the module receives an expression in data query language. The query may be received from, for example, a client program operating on a remote computing system that is communicatively coupled (e.g., via a network) to constraint solver 202.

At 603, the module determines the problem type expressed by the received expression. The problem type may be determined in some embodiments by inspection of the received expression. For instance, the expression may contain a token (e.g., FIND, as discussed in more detail below), keyword, or other indication that the problem is of a particular type. If it is determined that the problem type is a search problem, the module proceeds to 604. If it is instead determined that the problem type is a standard database query, the module proceeds to 608. A standard database query may be identified in some embodiments by the presence or absence of a particular token, keyword, or other indication of problem type.

At 604, the module transforms the received expression into a primitive problem expression, possibly based at least in part on data obtained from a database, if it was determined that the problem type was a search problem. Transforming the received expression may include compiling, translating, grounding, or mapping the received expression into one or more increasingly primitive problem expressions, such as first order predicate logic expressions, propositional logic expressions, etc. In addition, transforming the received expression may include interacting with a database system to obtain one or more data items that are the subject of the problem specified by received expression (e.g., rows, tables, columns, values, etc.) and that are to be incorporated into the primitive problem expression.

At 605, the module determines a solver that is configured to solve the primitive problem expression. As noted, determining a solver may include selecting a solver based on various factors, such as cost, solver capabilities, solver specialization, problem type, user specification, solver load, etc.

At 606, the module invokes the determined solver to determine a solution to the primitive problem expression. Invoking the determined solver may include transmitting the primitive problem expression over a network that couples the module and the determined solver. In other cases, such as when the solver is executing locally, invoking the solver may include invoking one or more functions, operations, or methods provided by the solver. In addition, the solver may be provided by, or executing on, a digital and/or an analog processor.

At 607, the module transforms the determined solution into a data query language response, possibly based at least in part on data obtained from a database. In some cases, transforming the determined solution to a data query language response may include mapping the determined solution into the language and/or modeling domain of the received expression. For example, if the received expression is an SQL-like query received from a database client program, the determined solution may be mapped into a response (e.g., a database table) suitable for display and/or further manipulation by the database client program. Mapping the determined solution may also include interacting with a database system to obtain data to populate and/or generate result sets, tables, or other data structures that are to be provided as part of the response.

At 608, the module executes the received expression as a query on a database to obtain a data query response, if it was determined that the problem type was a standard database query. As discussed above, in some embodiments, the data query language used may be an extension of a standard relational database query language (e.g., SQL extended with FIND and/or other language features, as discussed in more detail below). In cases where the received expression does not utilize any of the extended features of the data query language, the received expression is an ordinary database query that can be executed directly via a database system, without utilization of a constraint solver.

At 609, the module provides the data query response determined at 607 or 608. The method 600 terminates at 610, or alternatively may repeat by returning to 601.

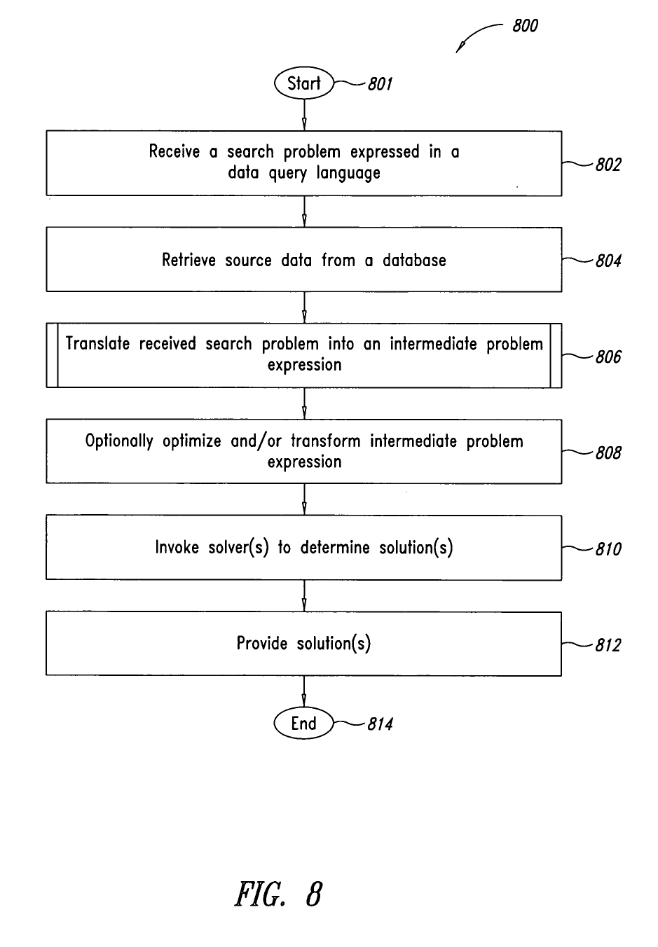

FIG. 8 shows a method 800 of interacting with a solver to solve a search problem, according to one illustrated embodiment. Method 800 may be performed by, for example, execution of a module such as search problem system 202 described with reference to FIG. 2. In other embodiments, the method may be performed by a module executing on a client computing system, such as a library or archive that provides an interface to a local and/or remote solver.

Method 800 starts at 801. At 802, a search problem expressed in a data query language is received. The query expression may be received from, for example, a client program operating on a remote computing system that is communicatively coupled (e.g., via a network) to constraint solver 202 and/or may be received from a locally executing program. In some embodiments, the received search problem may be expressed in a data query language that includes a FIND query (e.g., FIND FROM WHERE and/or FIND FROM WHERE PREFERRING, etc.) as is described elsewhere.

In block 804, source data may be retrieved from a database. In at least some embodiments, the received problem expressed in a data query language may include one or more indications of source data from which a search problem, as described elsewhere, and in at least some such embodiments, at least some of the data may be located in a database. In some embodiments, all the indicated source data that is located in a database may be retrieved prior to initiating one or more solvers to solve the search problem, such as to obviate the need to execute multiple database queries while searching for solutions. In addition, in some embodiments, at least some of the indicated source data may be located in a source other than a database, such as, for example, in the received problem expression and/or other location.

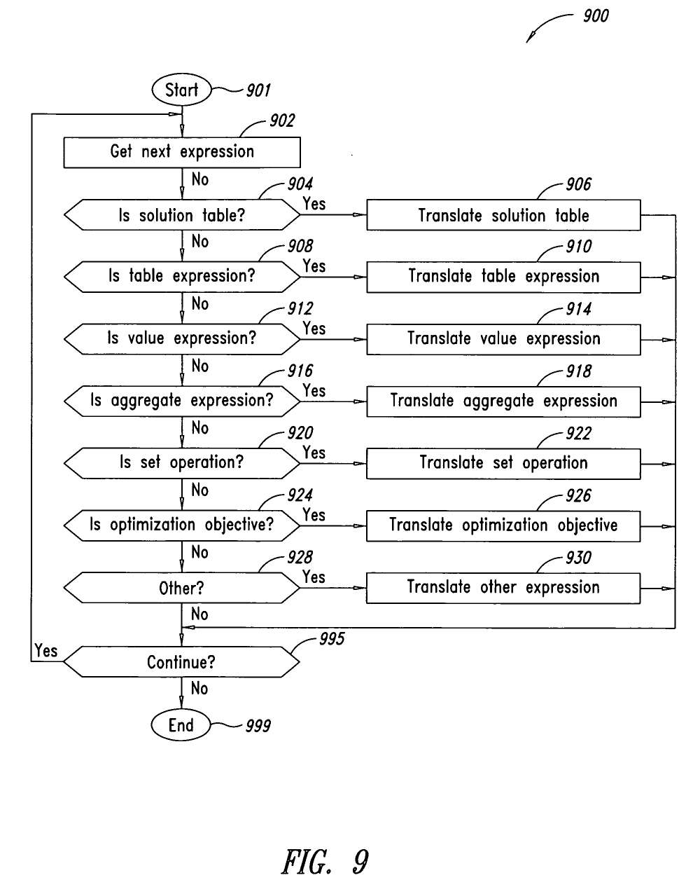

In block 806, the received search problem may be translated to an intermediate problem expression. For example, in some embodiments, the received expression may be translated into a problem expression in an intermediate mathematical language, such as a first order logic language (e.g., MX, etc.). An example embodiment describing such a translation is described in more detail in section “Translating Search Problems Expressed in a DQL,” below, and with respect to FIG. 9.

In block 808, the intermediate problem expression may be optionally optimized and/or transformed. This may include, for example, compiling, translating, grounding, or mapping the intermediate problem expression into a primitive problem expression, such as a propositional logic formula, etc. In addition, as is described in more detail elsewhere, in some embodiments, the intermediate problem expression may be simplified such that it may be easier to solve by one or more available solvers (e.g., logical rewriting, etc.). In other embodiments, the intermediate problem expression may be transformed into a more efficient representation of the intermediate problem expression (e.g., a bytecode representation), such that, for example, the problem may be efficiently transmitted over network, etc. For example, in some embodiments, a problem expressed in an intermediate mathematical language may be transformed into a bytecode representation of the intermediate mathematical language, as discussed elsewhere.

At 810, the method 800 may invoke one or more solvers to determine one or more solutions to the search problem. Invoking the one or more solvers may include selecting one or more of the one or more solvers based on various factors, such as user specified settings and/or preferences, cost, problem type, specialized solvers, etc. In some embodiments, various types of solvers may be provided, such as solvers executing on a local or remote digital computing system and/or solvers executing on an analog processor such as a quantum computer. In some embodiments, invoking one or more solvers may include providing the search problem (e.g., as expressed in an intermediate language, a primitive problem expression, etc.) to the one or more solvers along with the retrieved source data, such that the one or more solvers may determine one or more solutions to the provided problem from the source data.

At 812, the method provides the determined one or more solutions to the search problem received at 802. For example, in some embodiments, one or more solutions may be provided in one or more solution tables.

FIG. 9 shows a method 900 for translating a problem expression in a data query language into an intermediate problem expression, according to one illustrated embodiment. For example, in some embodiments, an intermediate problem expression may include a problem expression in a mathematical language (e.g., first order logic language, MX, AMPL, etc.). Method 900 may be performed by, for example, execution of a module such as search problem system 202 described with reference to FIG. 2. In other embodiments, the method may be performed by a module executing on a client computing system, such as a library or archive that provides an interface to a local and/or remote solver. In some embodiments, the method 900 may be a subroutine invoked by, for example, method 800 at 806 of FIG. 8.

Method 900 starts at 901 where a search problem expressed in a data query language is received. In some embodiments, the search problem expressed in a data query language may consist of one or more expressions in a query statement, such as, for example, a FIND query statement. In some embodiments, such expressions may include one or more of solution table expressions, table expressions, value expressions, aggregate expressions, set operations, optimization objectives, etc.

At 902, the method 900 gets the next expression from the problem statement. At 904, the method determines if the expression is an indication of one or more solution tables. If so, the method may continue to 906 to translate the one or more solution tables into an expression in the intermediate language.

If instead, at 904, the method determines that the expression does not an indication of one or solution tables, the method may continue to 908 to determine if the expression indicates one or more table expressions. In some embodiments, a table expression may indicate one or more tables containing source data for a problem. If it is determined that the expression indicates one or more table expressions, the method may continue to 910 to translate the one or more table expressions into the intermediate language.

If instead, at 908, it was not determined that the expression indicates a table expression, the method may continue to 912 to determine if the expression indicates one or more value expressions. In some embodiments, a value expression may include literals, column references, logic operations, comparisons, etc. If it is determined that the expression indicates one or more value expressions, the method may continue to 914 to translate the one or more value expressions into the intermediate language.

If instead, at 912, it was not determined that the expression indicates a value expression, the method may continue to 916 to determine if the expression indicates one or more aggregate expressions. If it is determined that the expression indicates one or more aggregate expressions, the method may continue to 918 to translate the one or more aggregate expressions into the intermediate language.

If instead, at 916 it was not determined that the expression indicates one or more aggregate expressions, the method may continue to 920 to determine if the expression indicates one or more set operations. If so, the method may continue to 922 to translate the one or more set operations into the intermediate language.

If instead, at 920, it was not determined that the expression indicates one or more set operations, the method may continue to 924 to determine if the expression indicates one or more optimization objectives. If so, the routine may continue to 926 to translate the one or more optimization objectives into the intermediate language.

If instead, at 924, it was not determined that the expression indicates one or more set operations, the method may continue to 928 to determine if other expressions are indicated. If so, the method may continue to 930 to translate the other expressions into the intermediate language.

After 906, 910, 914, 918, 922, 926 and 930, or if it was not determined at 928 that the expression indicates other expressions, the method may continue to 995 to determine if the method should continue, such as, for example, if more expressions remain to be evaluated in the search problem expressed in the data query language. If so, the method may return to 902 to get the next expression. If not, the method may continue to 999 where the method ends and/or returns.

It will be appreciate method 900 is merely illustrative of one embodiment of the types of expressions that may be translated from a data query language into an intermediate language. In other embodiments, other types of expressions may be translated instead of or in addition to those presented. In addition, the routine is not intended to illustrate a complete parser, compiler, and/or translator, and a person of skill in the art will appreciate that other steps may be included to translate from one language into another. In addition, an illustrative example of how one embodiment of a data query language may be translated into an intermediate language is described below in section “Translating Search Problems Expressed in a DQL.” FIG. 7 shows an example method 700 performed by an example application program interface (“API”) configured to obtain solutions to optimization problems by interacting with a server computing system configured to obtain problem solutions from an analog processor. Method 700 may be performed by, for example, the client optimization API 192 described with reference to FIG. 1A.

Method 700 starts at 701. At 702, the API receives a first problem expression from a client program.

At 703, the API translates the first problem expression into a second problem expression. In some embodiments, the first problem expression is transformed into a second, different problem expression that is recognizable by the server computing system and/or an analog processor. In other embodiments, this transformation may be performed by the server computing system. In still other embodiments, this step may be eliminated entirely, such as when the problem expression received at 702 is already in a format recognizable by the server computing system and/or the analog processor.

At 704, the API provides the second problem expression to a server computing system operable to obtain a response to the second problem expression from an analog processor. The server computing system may be, for example, computing system 102 of FIG. 1A. The analog computing system may be, for example, the analog processor 104 of FIG. 1A. The problem expression may be provided to the server in various ways (e.g., such as via a remote procedure call, an HTTP connection, a bare TCP/IP connection, etc.).

At 705, the API obtains the response from the server computing system. The response may be received by way of polling, notification, or other techniques.

At 706, the API provides a result to the client program, the result based on the obtained response. Providing the result may include translating or transforming the obtained response into a format recognizable by the client program. Providing the result may be performed via callbacks, accessor functions, or other methods.

Method 700 terminates at 707, or alternatively may repeat by returning to 701.

Although method 700 is described with respect to obtaining solutions to search problems by interacting with a server computing system configured to obtain problem solutions from an analog processor, in other embodiments, the method 700 may be used with respect to server computing systems configured to obtain problem solutions from one or more solvers executing on digital processors, in addition to or instead of an analog processor.

A Data Query Language for Expressing Complex Problems

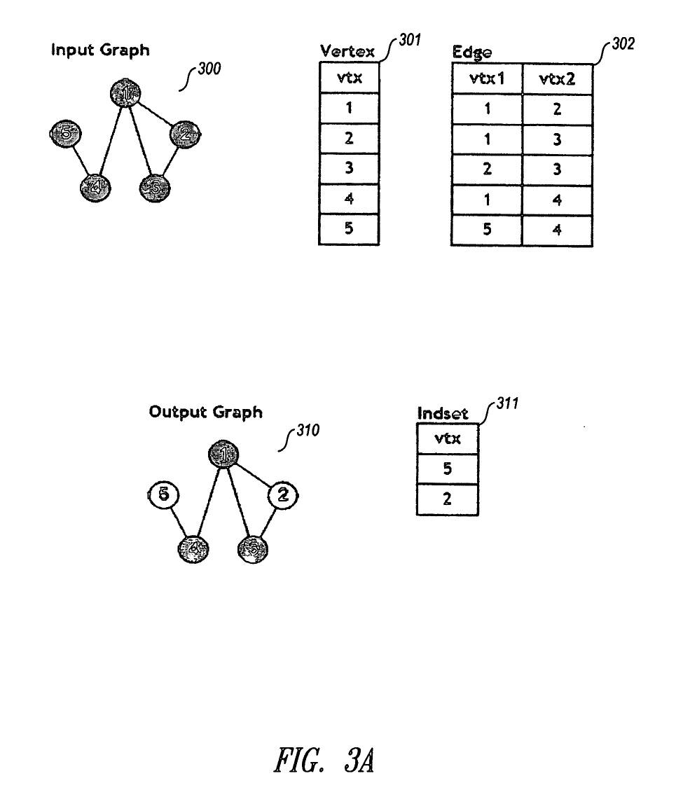

FIGS. 3A-3B illustrate various example search problems that may be solved by at least one illustrated embodiment of the present systems, methods and articles. In addition, Tables 1-10, below, describe a data query language and provide examples of how the data query language may be used by a user (e.g., a programmer, software developer, etc.) to express constraint satisfaction problems, such as those illustrated with respect to FIGS. 3A-3B. Many important classes of problems may be represented at least in part as constraint satisfaction problems. For example, an optimization problem may be expressed as a set of constraints over one or more variables and an objective function, where the goal is to find a set of values that satisfies the constraints and maximizes/minimizes the objective function. In addition, an illustrative example embodiment of how optimization problems may be expressed in a data query language is discussed in more detail below (e.g., see “Adding Optimizations to the Data Query Language”).

The data query language illustrated in Tables 1-9, below, is based on Structured Query Language (“SQL”). In particular, the illustrated data query language extends SQL by adding a new type of statement, a FIND FROM WHERE statement.

The FIND FROM WHERE statement differs from the known SELECT FROM WHERE statement in a number of respects. A SELECT statement, such as SELECT*FROM T WHERE C, directs a database system to obtain those tuples (e.g., rows) from table T where condition c is satisfied. The obtained tuples are provided as a results set. If t represents a row in T, then t is included in the result set whenever t satisfies condition C(t). More formally, t is in the result set if and only if C(t) is true. However, in the context of constraint satisfaction problems, it may be more convenient to express criteria that determine whether a particular row t should be in a given result by allowing greater flexibility in a rule or expression governing what can and cannot appear in the result.

In contrast, the FIND FROM WHERE statement directs a search problem solver system, such as the one described with reference to FIGS. 1A, 1B and 2, to find a solution table that contains a solution to a search condition. The search condition may express any logical relationship, not just if and only if relationships. The search condition may be used to declaratively express a variety of problems, such as constraint satisfaction problems, optimization problems, search problems, etc. In response to a FIND FROM WHERE statement, the constraint solver system generates a solution (if one exists) to the problem expressed in the WHERE clause, based on data (e.g., tables) indicated by the FROM clause. An example embodiment of formal semantics of a FIND query is discussed in more detail below in section “Adding Optimizations to the Data Query Language”.

In addition, a FIND FROM WHERE statement may also be executed in a manner different than that of a SELECT FROM WHERE statement. In particular, FIND statements are translated into a primitive logical description (e.g., a propositional logic formula) and a complete search is performed for solutions that satisfy all logical constraints expressed in the query. As noted, various algorithms and/or systems may be utilized to perform such searches, such as solvers executing on digital computing systems and/or analog computing systems.

Table 1 describes the syntax of the FIND statement. In Table 1, bold type (e.g., FIND, WHERE, etc.) identifies literal characters and keywords. Quotation marks (e.g., “>”) surround literal characters. Braces (e.g., {“,”SOLUTION_TABLE}) are used to group multiple syntactic elements repeated zero or more times. Segments surrounded by square brackets (e.g., [NOT]) are optional. Segments surrounded by non-literal parenthesis and followed by a plus (e.g., (“0”−“9”)+), can be repeated one or more times.

TABLE 1

| | | | |
|---|---|---|---|
| 1. | FIND | ::= | FIND [INTEGER] SOLUTION_TABLE {“,” |
| 2. | | | SOLUTION_TABLE} |
| 3. | | | [WANT WANT_CLAUSE] |
| 4. | | | [FROM FROM_CLAUSE] |
| 5. | | | WHERE SEARCH_CONDITION |
| 6. | | | |
| 7. | SOLUTION_TABLE | ::= | TABLE_NAME “(” TABLE_COLUMN {“,” |
| 8. | | | TABLE_COLUMN } “)” |
| 9. | TABLE_NAME | ::= | IDENTIFIER |
| 10. | TABLE_COLUMN | ::= | COLUMN_NAME COLUMN_TYPE |
| 11. | COLUMN_NAME | ::= | IDENTIFIER |
| 12. | COLUMN_TYPE | ::= | EXISTING_COLUMN_TYPE \| |
| 13. | | | INTEGER_RANGE_TYPE |
| 14. | EXISTING_COLUMN_TYPE | ::= | TABLE_NAME“.”COLUMN_NAME%TYPE |
| 15. | INTEGER_RANGE_TYPE | ::= | INTRANGE“(”INTEGER“..”INTEGER“)” |
| 16. | IDENTIFIER | ::= | ALPHABETIC_CHARACTER |
| 17. | | | {ALPHANUMERIC_CHARACTER \| |
| 18. | | | UNDERSCORE} |
| 19. | ALPHABETIC_CHARACTER | ::= | “A”-“Z” \| “a”-“z” |
| 20. | ALPHANUMERIC_CHARACTER | ::= | ALPHABETIC_CHARACTER \| “0”-“9” |
| 21. | UNDERSCORE | ::= | “_” |
| 22. | WANT_CLAUSE | ::= | “*” \| WANT_SUBCLAUSE {“,” |
| 23. | | | WANT_SUBCLAUSE} |
| 24. | WANT_SUBCLAUSE | ::= | TABLE_NAME“.*” \| |
| 25. | | | TABLE_NAME“.”COLUMN_NAME \| |
| 26. | | | COLUMN_NAME |
| 27. | FROM_CLAUSE | ::= | FROM_TABLE {“,” FROM_TABLE} |
| 28. | FROM_TABLE | ::= | TABLE_NAME [TABLE_ALIAS] |
| 29. | TABLE_ALIAS | ::= | IDENTIFIER |
| 30. | SEARCH_CONDITION | ::= | OR_EXPRESSION |
| 31. | OR_EXPRESSION | ::= | AND_EXPRESSION {OR AND_EXPRESSION} |
| 32. | AND_EXPRESSION | ::= | NOT_EXPRESSION {AND NOT_EXPRESSION} |
| 33. | NOT_EXPRESSION | ::= | [NOT] PREDICATE \| [NOT] “(” |
| 34. | | | SEARCH_CONDITION “)” |
| 35. | PREDICATE | ::= | VALUE COMPARISON_OPERATOR VALUE \| |
| 36. | | | EXISTS “(” SELECT “)” \| |
| 37. | | | VALUE IN “(” SELECT “)” \| |
| 38. | | | VALUE COMPARISON_OPERATOR ANY “(” |
| 39. | | | SELECT “)” \| |
| 40. | | | VALUE COMPARISON_OPERATOR ALL “(” |
| 41. | | | SELECT “)” \| |
| 42. | | | VALUE BETWEEN VALUE AND VALUE |
| 43. | COMPARISON_OPERATOR | ::= | “=” \| “<>” \| “>” \| “<” \| “>=” \| “<=” |
| 44. | SELECT | ::= | SELECT SELECT_CLAUSE |
| 45. | | | FROM FROM_CLAUSE |
| 46. | | | [WHERE SEARCH_CONDITION] |
| 47. | SELECT_CLAUSE | ::= | “*” \| SELECT_SUBCLAUSE {“,” |
| 48. | | | SELECT_SUBCLAUSE} |
| 49. | SELECT_SUBCLAUSE | ::= | COLUMN_REFERENCE \| TABLE_NAME“.*” \| |
| 50. | | | TABLE_ALIAS “.*” |
| 51. | VALUE | ::= | COLUMN_REFERENCE \| INTEGER \| STRING |
| 52. | COLUMN_REFERENCE | ::= | COLUMN_NAME \| |
| 53. | | | TABLE_NAME“.”COLUMN_NAME \| |
| 54. | | | TABLE_ALIAS“.”COLUMN_NAME |
| 55. | INTEGER | ::= | “0”-“9” \| “1”-“9”(“0”-“9”)+ |
| 56. | STRING | ::= | a string literal |

Note that the structure of the FIND statement is similar to that of the SELECT statement. In the illustrated embodiment, the name of the solution table specified by the FIND statement may not be the name of a table that already exists in the database. This is because the operation of the FIND statement is to generate a new solution table. In other embodiments, the FIND statement may be configured otherwise, such as to silently overwrite a table having the same name as the specified solution table. In addition, if the underlying database system supports views, views may be substituted for tables in the context of a FIND statement.

In the illustrated embodiment, the FIND statement supports various SQL features. For example, the FIND statement supports embedded SELECT queries; logical operators such as NOT, AND, and OR; comparison operators such as =, < >, <, >, >=, and <=; and predicates such as EXISTS, IN, ANY, ALL, and BETWEEN. Other features may also be provided, such as set operators (e.g., UNION, INTERSECT, EXCEPT); subqueries in the FROM clause of a FIND statement; specifying the number of solutions to return (as an optional parameter immediately after the keyword FIND); and allowing table names to be qualified by schema names expressed in a FIND statement.

In addition, a number of logical predicates/operators are supported, including FORALL, FORSOME, IF, IFF, and SUCC. Such logical predicates may be employed by users to efficiently express complex problems that are to be solved by the constraint solver.

The syntax of the FORALL predicate is

FORALL (Qry) t WHERE C

In the FORALL predicate, Qry is any query that can serve as a subquery in an EXISTS predicate, t is an identifier that can be a table alias, and c is a Boolean expression. The semantics of the FORALL predicate is: for all rows t given by the query Qry, C is true.

The FORALL predicate is logically equivalent to the following SQL expression:

NOT EXISTS (SELECT*FROM (Qry) t WHERE NOT C)

To complement the FORALL statement, a FORSOME predicate is also available. The syntax of the FORSOME predicate is

FORSOME (Qry) t WHERE C The FORSOME predicate is logically equivalent to the following SQL expression:

EXISTS (SELECT*FROM (Qry) t WHERE C)

In addition, an IF and IFF operator are provided. They are binary Boolean operators (like AND and OR), and have the following syntax:

C1 IF C2

C1 IFF C2

In the IF and IFF operators, C1 and C2 are Boolean expressions. The expression C1 IF C2 is logically equivalent to the expression NOT C2 OR C1. The expression C1 IFF C2 is logically equivalent to the expression (NOT C2 OR C1) AND (NOT C1 OR C2)

Furthermore, a binary successor predicate, SUCC is provided. SUCC (n1, n2) is true if n2 is the “next” element of n1. In the context of the SUCC predicate, the values of n1 and n2 must come from the same data domain (e.g., Integers). SUCC may be useful for problems involving an ordering of elements. In ordinary SQL, a general expression that is equivalent to the successor predicate may be lengthy and/or complex. For example, a user would typically have to specify that n1 is less than n2, and nothing exists that is greater than n1 and less than n2.

In one embodiment, a software module (e.g., a Java archive, a library, etc.) utilized by a client program (e.g., a database system client) translates a FIND statement to a description suitable for a constraint solver, obtains a solution from the constraint solver, and then maps the solution to a table specified by the FIND statement. Various solvers may be utilized, as illustrated by Table 2, below.

TABLE 2

| Example | |
|---|---|
| Solver | Comments |
| Remote quantum | Utilizes a remote quantum processor and algorithms to |
| Solver | efficiently solve computationally complex problems |
| | provided by the client program. |
| Remote MX | Utilizes the MX Solver executing on a remote digital |
| Solver | computing system to solve problems provided by the |
| | client program. |
| Local MX solver | Utilizes the MX solver executing on a machine that is |
| | local to the client program. |

Example Problems

Various example problems are illustrated below including an English description of each problem and a corresponding FIND statement for expressing the problem in a declarative data query language. These problems are merely examples are not intended to be inclusive.

1. The Independent Set Problem

A sample Java-like pseudo-source code segment is shown below in Table 3. Such a code segment may be used to provide, via solver API, a problem expressed as a FIND statement to a local or remote optimization solver. In other embodiments, an optimization API for client programs may be provided for various other programming languages, such as C, C++, C#, Perl, Ruby, Python, JavaScript, Visual Basic, VBScript, etc. Java is here used as a non-exclusive example.

The example code segment of Table 3 solves the independent set problem. The independent set problem is to find an independent set of nodes in a graph comprised of multiple vertices (e.g., nodes) connected by edges. An independent set contains vertices of a given graph that are not directly connected to each other. The maximum independent set (“MIS”) problem is related to the independent set problem. The maximum independent set is the largest independent set of a given graph. MIS is representative of a broad class of complex (e.g., NP-hard) search and optimization problems.

FIG. 3A illustrates example input and output graphs for the independent set problem solved by the code segment of Table 3. In particular, FIG. 3A shows an input graph 300 and an output graph 310. Output graph 310 depicts an example independent set of input graph 300. More specifically, non-shaded vertices 5 and 2 of output graph 310 are an independent set of input graph 300. As is evident from the illustration, vertices 5 and 2 are not directly connected to one another by any edge. Other example independent sets include vertices 1 and 5, vertices 3 and 5, etc. In addition, FIG. 3A shows a vertex table 301 named Vertex and an edge table 302 named Edge used to represent input graph 300, along with a solution table 311 named Indset used to represent the illustrated solution independent set.

In the following code segment, tables named Vertex and Edge are pre-existing, and a table named Indset is generated as a result of execution of the FIND statement.

TABLE 3

| | |
|---|---|
| 1. | // A Simple Java Program that uses the FIND statement to find |
| 2. | // independent sets in a database |
| 3. | |
| 4. | import java.sql.DriverManager; |
| 5. | import java.sql.Connection; |
| 6. | import java.sql.Statement; |
| 7. | import java.sql.ResultSet; |
| 8. | |
| 9. | // Define class FINDINDSET |
| 10. | public class FINDINDSET { |
| 11. | public static void main(String args[ ]) throws Exception { |
| 12. | // Load JDBC driver. |
| 13. | Class.forName(“com.dwavesys.jdbc.Driver”); |
| 14. | |
| 15. | // Create a connection to the database |
| 16. | Connection conn = |
| 17. | DriverManager.getConnection( |
| 18. | // DB URL: |
| 19. | “jdbc:mysql://www.xyz-sys.com/db_xyz”, |
| 20. | // DB account user name: |
| 21. | “foo”, |
| 22. | // DB account password: |
| 23. | “bar”); |
| 24. | |
| 25. | // Define the FIND statement as a string |
| 26. | String findStmt = |
| 27. | “FIND Indset (vtx Vertex.vtx%TYPE) ” + |
| 28. | “FROM Edge ” + |
| 29. | “WHERE NOT EXISTS ” + |
| 30. | “ (SELECT * FROM Indset Indset1, Indset Indset2 ” + |
| 31. | “ WHERE Indset1.vtx = Edge.vtx1 ” + |
| 32. | “ AND Indset2.vtx = Edge.vtx2)”; |
| 33. | |
| 34. | // Execute the FIND statement contained in the string |
| 35. | Statement stmt = conn.createStatement( ); |
| 36. | stmt.execute(findStmt); |
| 37. | |
| 38. | // Get the result of the execution |
| 39. | ResultSet rs = stmt.getResultSet( ); |
| 40. | |
| 41. | // Code that manipulates or utilizes the result |
| 42. | // ... ... |
| 43. | |
| 44. | // Close the database connection |
| 45. | conn.close( ); |
| 46. | } |
| 47. | } |

In lines 12-23, the above code segment allocates and configures a new object which provides an interface to a database and a local or remote solver. Then, in lines 26-32, the code segment defines a FIND statement as a string. In line 36, the code segment invokes execution of the defined FIND statement. Finally, in line 39, the code segment obtains the result of the execution.

The FIND statement defined on lines 26-32 defines a constraint satisfaction problem that is to be solved by the underlying optimization solver. More specifically, the FIND statement of lines 26-32 directs the optimization solver to find a solution table that, for a given graph, contains vertices of the graph, such that, for every pair of vertices in the solution table, the pair is not connected by an edge of the graph. First, the FIND statement specifies the solution table named Indset that contains a single column named vtx. For this problem, the solution table will contain an independent set (if any exist). By using the TYPE keyword, vtx Vertex.vtx % TYPE specifies that Indset.vtx (e.g., column vtx in table Indset) has the same type as Vertex.vtx (e.g., column vtx in table Vertex). This limits the result values in Indset.vtx to those in Vertex.vtx. The TYPE keyword is provided as part of SQL by at least one vendor of database systems. Other vendors and/or implementations may provide alternative syntax to express and/or manipulate data types within queries or other programmatic expressions. Alternatively, a user may utilize the INTRANGE keyword to specify that Indset.vtx is limited to a range of integers (e.g., vtx INTRANGE (1.5)).

As noted above, the FIND statement uses the FROM clause to specify the table or tables that the search condition of the WHERE will be checked against. The FIND statement of lines 26-32 specifies that there is one instance table named Edge.

As also noted above, the FIND statement uses the WHERE clause to specify constraints that must hold with respect to the specified solution table. The WHERE clause may contain Boolean expressions. The WHERE clause of lines 29-32 specifies that no two vertices in the independent set may be connected by an edge. The SELECT statement of lines 30-32 constructs an anonymous table from two copies of table Indset, referred to by aliases Indset1 and Indset2. Each record in the anonymous table is a pair of vertices: one vertex from Indset1 (e.g., Indset1.vtx) and one from Indset2 (e.g., Indset2.vtx). The WHERE clause of lines 29-32 specifies that each record in the anonymous table has a condition, namely, that the two vertices must be connected by the Edge. That is because the illustrated WHERE clause requires that Indset1.vtx equals Edge. vtx1 and that Indset2.vtx equals Edge. vtx2. This condition is precisely what may not be true for a solution table that contains vertices of an independent set. Accordingly, the anonymous table should be empty for any solution table that contains an independent set of vertices. As such, the SELECT statement of lines 30-32 is preceded by the NOT EXISTS operator, which returns true if a SELECT statement provides an empty table.

In contrast to the FIND statement as illustrated above, standard SQL cannot express the problem of finding one independent set of any size. This is because of the implicit if-and-only-if relationship between the rows in the result and the condition.

However, it is awkward but possible to use standard SQL to find all independent sets of any size. The following example of Table 4 shows, given a set of vertices in a table and a set of edges in a table, a SELECT statement to find all independent sets of size five. Each row in the result corresponds to an independent set of size five.

TABLE 4

| | |
|---|---|
| 1. | SELECT V1.vtx, V2.vtx, V3.vtx, V4.vtx, V5.vtx |
| 2. | FROM Vertex V1, Vertex V2, Vertex V3, Vertex V4, Vertex V5 |
| 3. | WHERE NOT EXISTS |
| 4. | (SELECT * FROM Edge |
| 5. | WHERE (V1.vtx = Edge.vtx1 AND V2.vtx = Edge.vtx2) |
| 6. | OR (V1.vtx = Edge.vtx1 AND V3.vtx = Edge.vtx2) |
| 7. | OR (V1.vtx = Edge.vtx1 AND V4.vtx = Edge.vtx2) |
| 8. | OR (V1.vtx = Edge.vtx1 AND V5.vtx = Edge.vtx2) |
| 9. | OR (V2.vtx = Edge.vtx1 AND V3.vtx = Edge.vtx2) |
| 10. | OR (V2.vtx = Edge.vtx1 AND V4.vtx = Edge.vtx2) |
| 11. | OR (V2.vtx = Edge.vtx1 AND V5.vtx = Edge.vtx2) |
| 12. | OR (v3.vtx = Edge.vtx1 AND V4.vtx = Edge.vtx2) |
| 13. | OR (V3.vtx = Edge.vtx1 AND V5.vtx = Edge.vtx2) |
| 14. | OR (V4.vtx = Edge.vtx1 AND V5.vtx = Edge.vtx2)) |

A clear disadvantage of the query of Table 4 is the need to explicitly check that an edge does not connect each pair of vertices. Such an approach does not scale easily with larger graph sizes. In particular, approximately 5000 comparisons would be required for a graph of size 100. In addition, the SQL query of Table 4 searches for all independent sets of size five. If the goal is simply to find one independent set, then the query is computationally excessive with respect to the problem statement.

The FIND version of the independent set problem illustrated in Table 3 is more flexible and easier to express than the corresponding standard SQL query. In particular, it allows rules to be specified on the table being defined (e.g., Indset), in addition to those given (e.g., Vertex and Edge). This allows a user to efficiently express concepts such as: “Two vertices in Indset may not be connected by any edge in Edge,” which applies to independent sets of any size. Furthermore, there is no implicit if-and-only-if relationship between the rows in the solution table and the condition of the FIND statement. At a high level, a FIND query directs the solver to construct a table so that the given condition is satisfied. Advantageously, such an approach applies to all constraint satisfaction problems.

In contrast, in the standard SQL version of the independent set problem illustrated in Table 4, the user must construct a table from five copies of the table Vertex. The rules that may be specified are restricted to the tables existing in the database (e.g., Vertex and Edge). The five copies of Vertex form a big table, in which the specified rules check each record. Each record is in the result if and only if it satisfies the specified rules. A standard SQL SELECT query may only direct the database system to construct a table from a given set of rows, such that each record is in the table if and only if it satisfies the given condition. Such an approach is clearly more restrictive than the approach provided by the FIND statement, and does not apply cleanly to typical constraint satisfaction problems. In addition, suppose the number of vertices in an input graph is N. In order to find all independent sets of any size using standard SQL, a user would write a query similar to the one illustrated in Table 4, for each number from 1 to N. The results of all the queries plus the empty set would be the final result. Such an approach does not scale well with problem size.

In general, the FIND statement and other illustrated language features advantageously facilitate the expression of problems such as search and optimization problems in a manner that parallels the typical conception of such problems. In addition, the illustrated language features encourage a modular separation of problem solution descriptions and problem instances. For example, a user may declaratively express (e.g., by formulating a query) a solution to a problem, where the expressed solution is decoupled from specific instances of the problem (e.g., the content of the query is independent of the size of the particular problem instance being solved). In addition, a user may state a problem directly within SQL, by defining the logical constraints of a solution, as opposed to specifying operations, actions, or functions that are to be performed to obtain a solution. This declarative aspect is possible in part because the FIND statement allows for the specification of a solution table in terms of constraints that must hold for some or all data that is to be part of the solution table.

In some embodiments, an application program interface (“API”) is provided. The API may be used by client programs to interact with a remote analog processor in order to obtain solutions to optimization problems. The code segment of Table 5 illustrates the use of a client API to obtain a solution to the independent set problem from a remote analog processor.

TABLE 5

| 1. | // An example code segment that uses a client API to obtain | |
|---|---|---|
| 2. | // a solution to an independent set problem | |
| 3. | | |
| 4. | if USE_DWAVE | |
| 5. | dimacsStr = adjacency2DIMACSString(Edge); | |
| 6. | server = TrinityServer(... | |
| 7. | ‘sandbox.dwavesys.com’, | ... % Server |
| 8. | ‘/trinity/rest’, | ... % URI |
| 9. | 80, | ... % Port |
| 10. | ‘uname’, | ... % username |
| 11. | ‘pwd123’ | ... % Password |

| | |
|---|---|
| 12. | ); |
| 13. | |
| 14. | |
| 15. | inputStream = server.getClass( ).getClassLoader( ). |
| 16. | getResourceAsStream(‘logging.properties’); |
| 17. | logManager = java.util.logging.LogManager.getLogManager( ); |
| 18. | logManager.readconfiguration(inputStream); |
| 19. | |
| 20. | properties = java.util.HashMap( ); |
| 21. | // optionally set properties, such as: |
| 22. | // USE_QUANTUM_PROCESSOR = ture |
| 23. | // TIMEOUT = −1 |
| 24. | // RNG_SEED = 1 |
| 25. | |
| 26. | %----- Run the job |
| 27. | ISIndex = MIS(server, dimacsStr, properties); |
| 28. | numVertex = size(Edge,1); |
| 29. | MIS = zeros(1,numVertex); |
| 30. | MIS(ISIndex) = 1; |
| 31. | MIS_size = length(ISIndex); |
| 32. | |
| 33. | else |
| 34. | [MIS_size, MIS] = solveMIS(Edge,1000); |
| 35. | end; |

In line 5, the example code obtains an expression of an independent set problem. In lines 6-12, the example code establishes a connection to a server computing system that is operable to provide a solution to the independent set problem. In the illustrated embodiment, the server computing system may interact with an analog processor to obtain the solution. In lines 20-24, the example code may optionally set various properties regarding the operation of the server computing system, such as timeout conditions, whether the server computing system should use an analog processor to solve the problem, whether the server computing system should use a digital processor to solve the problem, etc.

In lines 26-31, the example code interacts with the API to obtain a solution to the independent set problem. In particular, in line 27, the example code calls an API function called “MIS,” and passes the server connection, the problem expression, and server properties to the MIS function as parameters. The MIS function optionally transforms the problem expression into a native problem expression that is configured to be processed by an analog processor. The MIS function then provides the optionally transformed problem expression to the server computing system. The server computing system may then interact with an analog processor to obtain a response to the problem expression. Once the server computing system has obtained the response, it is provided to the MIS function, which then returns. In lines 28-31, the example code obtains information from the API regarding the response obtained from the server computing system.

Additional details regarding the operation of a client API are provided with respect to FIG. 7, above.

2. The Latin Square Completion Problem

A Latin Square of order N, where N is a positive integer, is an N-by-N matrix. In the matrix, N distinct elements (integers 1 to N) are arranged so that each element occurs exactly once in each row and in each column. The Latin Square completion problem is to complete a partially filled Latin Square. FIG. 3B shows a problem square 321, which is a partially filled in Latin Square, and a solution square 322, which is a possible solution to the problem square 321.

In addition, FIG. 3B shows two database tables that may be used to represent an example problem square. In particular, FIG. 3B shows an element table 331 named Element and a matrix table 332 named Preassigned. In the illustrated example, the order N is 30, the table Element stores all 30 elements (e.g., integers 1 to 30), and the table Preassigned describes the partially filled matrix.

There is one solution table named LSC for this problem. It contains three columns, elem, mrow and mcol, specified as follows:

```
LSC (elem Element.elem%TYPE,
            mrow INTRANGE(1..30),
            mcol INTRANGE(1..30))
```

Each record in LSC will indicate that the element denoted by elem is in cell (mrow, mcol) in the matrix. Table 6, below, includes a FIND statement that may be used to solve the Latin Squares problem, as outlined above.

TABLE 6

| | |
|---|---|
| 1. | FIND LSC (elem Element.elem%TYPE, |
| 2. | mrow INTRANGE(1..30), |
| 3. | mcol INTRANGE(1..30)) |
| 4. | FROM Preassigned p, Element e, INTRANGE(1..30) n |
| 5. | WHERE EXISTS (SELECT * FROM LSC l |
| 6. | WHERE l.elem = p.elem |
| 7. | AND l.mrow = p.mrow |
| 8. | AND l.mcol = p.mcol) |
| 9. | AND EXISTS (SELECT * FROM LSC l |
| 10. | WHERE l.elem = e.elem |
| 11. | AND l.mrow = n.intvalue) |
| 12. | AND EXISTS (SELECT * FROM LSC l |
| 13. | WHERE l.elem = e.elem |
| 14. | AND l.mcol = n.intvalue) |
| 15. | AND NOT EXISTS (SELECT * FROM LSC l1, LSC l2 |
| 16. | WHERE l1.elem = l2.elem |
| 17. | AND l1.mrow = l2.mrow |
| 18. | AND l1.mcol <> l2.mcol) |
| 19. | AND NOT EXISTS (SELECT * FROM LSC l1, LSC l2 |
| 20. | WHERE l1.elem = l2.elem |
| 21. | AND l1.mrow <> l2.mrow |
| 22. | AND l1.mcol = l2.mcol) |
| 23. | AND NOT EXISTS (SELECT * FROM LSC l1, LSC l2 |
| 24. | WHERE l1.mrow = l2.mrow |
| 25. | AND l1.mcol = l2.mcol |
| 26. | AND l1.elem <> l2.elem) |

The example FIND statement of Table 6 shows how the keyword INTRANGE is used to declare the type of a column in the solution table. The columns mrow and mcol in LSC are given the type INTRANGE (1 . . . 30). This means that the possible values for both columns are integers 1 to 30.

In addition, an integer range type like INTRANGE (1 . . . 30) may be used as a table. This provides a convenient way to treat an integer range like a table when in fact it is not stored as a table in the database. In the illustrated example, on line 5, INTRANGE (1 . . . 30) is used to represent a table in the FROM clause. This table has one column, intvalue, whose possible values are exactly the integers in the range.

3. The Social Golfer Problem

The Social Golfer problem involves scheduling G*S golfers into G groups of S players over W weeks, where G, S and W are positive integers, such that no two golfers play in the same group for more than one week.

In the following example, G is six, S is six and W is two. Therefore, there are a total of 6*6=36 golfers. The following example also specifies a solution table named Plays. Each record in Plays will denote that a golfer plr plays in the group grp in the week wk. The table Plays is specified as follows:

```
Plays (plr INTRANGE(1..36),
            wk INTRANGE(1..2),
            grp INTRANGE(1..6))
```

To ensure that the size of each group is six, another solution table Map is introduced, which maps each week-player pair to a number between one and six. Players in the same group in any week must be mapped to unique numbers. Accordingly, because players can only be mapped to six numbers, the size of each group must be six. The table Map is specified as follows:

```
Map (wk INTRANGE(1..2),
            plr INTRANGE(1..36),
            gs INTRANGE(1..6))
```

Even though there are two solution tables, Plays and Map, a user would not ordinarily be interested in the definition of Map, because that table is just an auxiliary table that helps describe the problem. To exclude all Map rows from the result, the WANT clause may be used to specify that a user only wants to see the columns for Plays, as follows:

WANT Plays.plr, Plays.wk, Plays.grp

Alternatively, since plr, wk and grp are all of the columns of the Plays table, a wildcard version of the WANT clause could be utilized. The following example specifies that a user wants to see all columns for Plays.

WANT Plays.*

Table 7, below, includes a FIND statement that may be used to solve the Social Golfer problem, as outlined above.

TABLE 7

| | | | |
|---|---|---|---|
| 1. | FIND | Plays | (plr INTRANGE(1..36), |
| 2. | | | wk INTRANGE(1..2), |
| 3. | | | grp INTRANGE(1..6)), |
| 4. | | Map | (wk INTRANGE(1..2), |
| 5. | | | plr INTRANGE(1..36), |
| 6. | | | gs INTRANGE(1..6)) |

| 7. | WANT | Plays.plr, Plays.wk, Plays.grp | |
|---|---|---|---|
| 8. | FROM | INTRANGE(1..36) p, INTRANGE(1..2) w | |
| 9. | WHERE | EXISTS | (SELECT * FROM Plays ps |

| | | |
|---|---|---|
| 10. | WHERE | ps.plr = p.intvalue |
| 11. | AND | ps.wk = w.intvalue) |

| | | | |
|---|---|---|---|
| 12. | AND | NOT EXISTS | (SELECT * FROM Plays ps1, |
| | | | Plays ps2 |

| | | |
|---|---|---|
| 13. | WHERE | ps1.wk = ps2.wk |
| 14. | AND | ps1.plr = ps2.plr |
| 15. | AND | ps1.grp <> ps2.grp) |

| 16. | AND | NOT EXISTS | |
|---|---|---|---|
| 17. | | (SELECT * FROM Plays ps1, Plays ps2, Plays ps3, | |
| | | Plays ps4 | |
| 18. | | WHERE | ps1.plr <> ps2.plr |
| 19. | | 11 AND | ps1.wk = ps2.wk |
| 20. | | AND | ps1.grp = ps2.grp |
| 21. | | AND | ps3.plr = ps1.plr |
| 22. | | AND | ps4.plr = ps2.plr |
| 23. | | AND | ps3.wk = ps4.wk |
| 24. | | AND | ps3.wk <> ps1.wk |
| 25. | | AND | ps3.grp = ps4.grp) |

| 26. | AND | NOT EXISTS | |
|---|---|---|---|
| 27. | | (SELECT * FROM Plays ps1, Plays ps2, Map m1, | |
| | | Map m2 | |
| 28. | | WHERE | ps1.plr <> ps2.plr |
| 29. | | AND | ps1.wk = ps2.wk |
| 30. | | AND | ps1.grp = ps2.grp |
| 31. | | AND | ps1.wk = m1.wk |
| 32. | | AND | m1.wk = m2.wk |
| 33. | | AND | m1.plr = ps1.plr |
| 34. | | AND | m2.plr = ps2.plr |
| 35. | | AND | m1.gs = m2.gs) |

| | | | |
|---|---|---|---|
| 36. | AND | EXISTS | (SELECT * FROM Map m |

| | | |
|---|---|---|
| 37. | WHERE | m.wk = w.intvalue |
| 38. | AND | m.plr = p.intvalue) |

4. The K-Coloring Problem

The K-Coloring problem states that, given a graph, color all its vertices using K different colors, where K is a positive integer, so that adjacent vertices have different colors. Two vertices are adjacent if they share the same edge. In this illustration, it is assumed that the database contains three tables named Vertex, Edge and Color, respectively. The solution table will be Coloring.

Table 8, below, includes a FIND statement that may be used to solve the K-Coloring problem, as outlined above.

TABLE 8

| 1. | FIND | Coloring (vtx Vertex.vtx%TYPE, col Color.col%TYPE) | |
|---|---|---|---|
| 2. | FROM | Vertex v, Edge e | |
| 3. | WHERE | v.vtx IN (SELECT vtx FROM Coloring) | |
| 4. | AND | NOT EXISTS | (SELECT * FROM Coloring cg1, |
| | | | Coloring cg2 |
| 5. | | | WHERE cg1.vtx = v.vtx |
| 6. | | | AND cg2.vtx = v.vtx |
| 7. | | | AND cg1.col <> cg2.col) |
| 8. | AND | NOT EXISTS | (SELECT * FROM Coloring cg1, |
| | | | Coloring cg2 |
| 9. | | | WHERE cg1.vtx = e.vtx1 |
| 10. | | | AND cg2.vtx = e.vtx2 |
| 11. | | | AND cg1.col = cg2.col) |

5. The SONET Problem

The following illustration is based on a simplification of the SONET problem. A SONET communication network has a number of rings, each of which connects some computers. The problem requires that, given N computers, where N is a positive integer, the N computers must be installed in rings, such that that a given communications demand is satisfied. The communications demand specifies which pairs of computers must communicate with each other. Two computers can communicate with each other if and only if they are in the same ring.

A positive integer, M, bounds the number of computers in each ring. In this illustration, M is three. It is further assumed that the database contains two tables named Computer and Demand, respectively, and that the solution table is named Network.

Table 9, below, includes a FIND statement that may be used to solve a variation of the SONET problem outlined above. In this example, the SONET problem is simplified by allowing computer identifiers to be used as ring identifiers, and thus the columns cid and rid may be of the same type. This is possible because the number of rings is at most the number of computers.

TABLE 9

| | | | |
|---|---|---|---|
| 1. | FIND | Network | (cid Computer.cid%TYPE, |
| 2. | | | rid Computer.cid%TYPE, |
| 3. | | | pos INTRANGE(1..3)) |

| 4. | WANT | cid, rid | |
|---|---|---|---|
| 5. | FROM | Computer com, Demand dmnd | |
| 6. | WHERE | com.cid IN (SELECT cid FROM Network) | |
| 7. | AND | EXISTS | (SELECT * FROM Network n1, |
| | | | Network n2 |

| | | |
|---|---|---|
| 8. | WHERE | n1.cid = dmnd.cid1 |
| 9. | AND | n2.cid = dmnd.cid2 |
| 10. | AND | n1.rid = n2.rid) |

| | | | |
|---|---|---|---|
| 11. | AND | NOT EXISTS | (SELECT * FROM Network n1, |
| | | | Network n2 |

| | | |
|---|---|---|
| 12. | WHERE | n1.cid <> n2.cid |
| 13. | AND | n1.rid = n2.rid |
| 14. | AND | n1.pos = n2.pos) |

| | | | |
|---|---|---|---|
| 15. | AND | NOT EXISTS | (SELECT * FROM Network n1, |
| | | | Network n2 |

| | | |
|---|---|---|
| 16. | WHERE | n1.cid = n2.cid |
| 17. | AND | n1.rid = n2.rid |
| 18. | AND | n1.pos <> n2.pos) |

6. The Bounded Spanning Tree Problem

A spanning tree of a graph is a sub-graph that is a tree, which covers every vertex. In the bounded spanning tree problem, given a directed graph and a positive integer K, the problem seeks to find a spanning tree in which no vertex has an out-degree larger than K.

In this illustration, K is two. It is further assumed that the database contains two tables named Vertex and Edge, respectively. In addition, the first solution table, Bstedge, includes the edges in the spanning tree. The second solution table, Permute, gives a permutation of the vertices in the graph. A permutation of the vertices ensures that each edge in the spanning tree must be from a vertex in a lower position in the permutation to a vertex in a higher position. Such an approach will prevent cycles from occurring. The third solution table, Map, maps each vertex to an integer between one and two. The table Map ensures that if there is an edge from a vertex v1 to vertex v2 and an edge from vertex v1 to vertex v3, then vertex v2 and vertex v3 must be mapped to different numbers. This approach restricts the out-degree of each vertex to be at most two.

Table 10, below, includes a FIND statement that may be used to solve a variation of the bounded spanning tree problem outlined above.

TABLE 10

| | | | |
|---|---|---|---|
| 1. | FIND | Bstedge | (vtx1 Vertex.vtx%TYPE, vtx2 Vertex.vtx%TYPE), |
| 2. | | Permute | (vtx1 Vertex.vtx%TYPE, vtx2 Vertex.vtx%TYPE), |
| 3. | | Map | (vtx Vertex.vtx%TYPE, pos INTRANGE(1..2)) |

| 4. | WANT | Bstedge.* | |
|---|---|---|---|
| 5. | FROM | Vertex v | |
| 6. | WHERE | EXISTS (SELECT * FROM Permute p WHERE p.vtx1 = v.vtx) | |
| 7. | AND | EXISTS (SELECT * FROM Permute p WHERE p.vtx2 = v.vtx) | |
| 8. | AND | NOT EXISTS | (SELECT * FROM Permute p1, Permute p2 |

| | | |
|---|---|---|
| 9. | WHERE | p1.vtx1 = p2.vtx1 |
| 10. | AND | p1.vtx2 <> p2.vtx2) |

| | | | |
|---|---|---|---|
| 11. | AND | NOT EXISTS | (SELECT * FROM Permute p1, Permute p2 |

| | | |
|---|---|---|
| 12. | WHERE | p1.vtx1 <> p2.vtx1 |
| 13. | AND | p1.vtx2 = p2.vtx2) |

| | | | |
|---|---|---|---|
| 14. | AND | NOT EXISTS | (SELECT * FROM Permute p |

| 15. | WHERE | p.vtx1 > 1 | |
|---|---|---|---|
| 16. | AND | NOT EXISTS | (SELECT * FROM |
| | | | Bstedge b |
| 17. | | | WHERE p.vtx2 = b.vtx2)) |

| | | | |
|---|---|---|---|
| 18. | AND | NOT EXISTS | (SELECT * FROM Bstedge b, Permute p |
| 19. | | | 11 WHERE p.vtx1 = 1 AND b.vtx2 = p.vtx2) |

| 20. | AND | NOT EXISTS | |
|---|---|---|---|
| 21. | | (SELECT * FROM Permute p1, Permute p2, Bstedge b | |
| 22. | | WHERE | p2.vtx1 <= p1.vtx1 |
| 23. | | AND | b.vtx1 = p1.vtx2 |
| 24. | | AND | b.vtx2 = p2.vtx2) |

| | | | |
|---|---|---|---|
| 25. | AND | NOT EXISTS | (SELECT * FROM Bstedge b |

| | | |
|---|---|---|
| 26. | WHERE NOT EXISTS | (SELECT * FROM Edge e |
| 27. | | WHERE b.vtx1 = e.vtx1 |
| 28. | | AND b.vtx2 = e.vtx2)) |

| | | | |
|---|---|---|---|
| 29. | AND | NOT EXISTS | (SELECT * FROM Bstedge b1, Bstedge b2 |

| | | |
|---|---|---|
| 30. | WHERE | b1.vtx1 <> b2.vtx1 |
| 31. | AND | b1.vtx2 = b2.vtx2) |

| 32. | AND | NOT EXISTS | |
|---|---|---|---|
| 33. | | (SELECT * FROM Bstedge b1, Bstedge b2, Map m1, Map m2 | |
| 34. | | WHERE | b1.vtx1 = b2.vtx1 |
| 35. | | AND | b1.vtx2 <> b2.vtx2 |
| 36. | | AND | b1.vtx2 = m1.vtx |
| 37. | | AND | b2.vtx2 = m2.vtx |
| 38. | | AND | m1.pos = m2.pos) |

| | | |
|---|---|---|
| 39. | AND | EXISTS (SELECT * FROM Map m WHERE m.vtx = v.vtx) |

In the FIND statement above in Table 10, the two NOT EXISTS predicates may have a nested NOT EXISTS predicate as shown below:

| NOT EXISTS | (SELECT * FROM Permute p | |
|---|---|---|
| | WHERE p.vtx1 > 1 | |
| | AND NOT EXISTS | (SELECT * FROM Bstedge b |
| | | WHERE p.vtx2 = b.vtx2)) |

| | |
|---|---|
| NOT EXISTS | (SELECT * FROM Bstedge b |

| | |
|---|---|
| WHERE NOT EXISTS | (SELECT * FROM Edge e |
| | WHERE b.vtx1 = e.vtx1 |
| | AND b.vtx2 = e.vtx2)) |

The two predicates may be rewritten to remove the “double negation”, (e.g., the nested NOT EXISTS predicate within the NOT EXISTS predicates). A FORALL predicate may be written as shown below to remove the “double negation”:

| | |
|---|---|
| (FORALL | (SELECT * FROM Permute WHERE vtx1 > 1) p |
| | WHERE EXISTS (SELECT * FROM Bstedge b |
| | WHERE p.vtx2 = b.vtx2)) |
| (FORALL | (SELECT * FROM Bstedge) b |
| | WHERE EXISTS (SELECT * FROM Edge e |
| | WHERE b.vtx1 = e.vtx1 |
| | AND b.vtx2 = e.vtx2)) |

Adding Optimizations to the Data Query Language

As previously discussed above, in some embodiments, modeling and solution of constraint satisfaction problems may be achieved within a data query language, such as SQL, by adding the FIND FROM WHERE statement. In addition, optimization criteria may be added to the data query language to solve optimization problems.

In particular, the illustrated data query language based on SQL, discussed above, may be further extended by adding a PREFERRING block to the FIND query, such that optimizations may be expressed by a FIND FROM WHERE PREFERRING statement. This command enables the expression of more complex preferences than is possible in Preference SQL. The extension to SQL with FIND and PREFERRING significantly differs from the original Preference SQL. The original Preference SQL extends the SELECT query with the PREFERRING block, which allows one to write a SELECT query that retrieves the best matching tuples from a database table with respect to some preference conditions; however, the original Preference SQL does not address constraint satisfaction and optimization problems.

In contrast, extending SQL with FIND and PREFERRING, as discussed herein, allows for the modeling and solving of search problems (e.g., constraint satisfaction and optimization problems), which enables a user to find an optimal solution to a search problem subject to constraints and optimization objectives. In some embodiments, optimization objectives may include an operator HIGHEST (for maximization) and/or an operator LOWEST (for minimization).

Example embodiments of the semantics of the FIND query with and without PREFERRING are described below.

1. Semantics of FIND FROM WHERE

As previously noted, in some embodiments, a FIND query may define a search problem as a problem of populating one or more tables, called solution tables, subject to a condition, such that the FIND query directs a search problem solver system, such as one described with reference to FIGS. 1A, 1B and 2, to find one or more solution tables subject to the condition. In some embodiments, the data that populates a solution table may come from a relational database. In this example embodiment, each solution table has a name R and one or more columns c₁, . . . , cₙ. A solution table may be referred to by its name.

Each column cᵢ in a solution table must be sourced from a column k in exactly one table T. The column k is the source column of cᵢ, and the table T is the source table of cᵢ. The source column k determines what values may appear in column cᵢ. Specifically, the values that may appear in cᵢ are precisely those in k. These values form the domain of cᵢ.

In a FIND query, the name of the source column is provided for each column in a solution table. The name of each source table must be listed in the FROM clause of the FIND query. In the example below, the solution table R has two columns. The first column is sourced from column x in table SomeTable1, and the second from column y in table SomeTable2.

FIND R (t1.x, t2.y)
FROM SomeTable1 t1, SomeTable2 t2
WHERE ...

If two columns cᵢ and cⱼ in R are respectively sourced from columns k₁ and k₂ in the same table T, then for each tuple r in R, T must have a tuple t such that t.k₁=r.cᵢ and t.k₂=r.cⱼ. Cases where more than two columns in R are sourced from T are similar.

The condition governing what may appear in a solution table is given as a Boolean expression C in the WHERE clause of the FIND query. Each solution to the query corresponds to a way of populating all solution tables that makes C evaluate to true. The condition C may be specified on solution tables. For example, the WHERE clause of the following example FIND query prevents solution table R from having two tuples with the same value for column x but different values for column y.

FIND R (t1.x, t2.y)
FROM SomeTable1 t1, SomeTable2 t2
WHERE NOT EXISTS (SELECT * FROM R r1, R r2 WHERE
r1.x = r2.x AND r1.y < r2.y)

Formal semantics of an embodiment of the FIND FROM WHERE query may be expressed in first-order logic as follows:

Given a FIND query, the source tables in the FROM clause may be denoted collectively as T. The condition C in the WHERE clause may be divided into two parts, C_{T} and C_{\T}, such that C≡C_{T} [symbol] C_{\T}. C_{T} is the condition on the tuples in source tables T, such that C_{T} restricts which tuples in the source tables could appear in the solution tables. C_{\T} is the rest of C and does not impose any condition on the tuples in T. It is an arbitrary condition that must be satisfied by the solution tables. Let the solution tables in the FIND query be R₁, . . . , Rₛ. For each k between 1 and s, suppose the columns in Rₖ are cₖ₁, . . . , cₖₙ_{ₖ}, and they are sourced from tables Tₖ₁, . . . , Tₖₗ_{ₖ}, where each one of Tₖ₁, . . . , Tₖₗ_{ₖ} is in T. The source columns of cₖ₁, . . . , cₖₙ_{ₖ} are denoted as src(cₖ₁), . . . , src(cₖₙ_{ₖ}). Then, in one embodiment, the following formula, Φₖ, defines what it means for the columns in Rₖ to be sourced from Tₖ₁, . . . , Tₖₗ_{ₖ}:

$${Φ}_{k} := ∀ {v}_{k 1} … , {u}_{{kn}_{k}} [ {R}_{k} ( {v}_{k 1} , … , {v}_{{kn}_{k}} ) \to ∃ {u}_{11} … {u}_{1 {m}_{1}} … {u}_{{l}_{k} 1} … {u}_{{l}_{k} {ml}_{k}} ( {{⋀}^{{l}_{k}}}_{i = 1} {T}_{ki} ( {u}_{i 1} , … , {u}_{{im}_{i}} ) ⋀ {C}_{T} ⋀ {{⋀}^{{n}_{k}}}_{j = 1} [ {v}_{kj} = var ( src ( {c}_{kj} ) ) ] ) ] .$$

In the formula Φₖ, the variables vₖ₁, . . . , vₖₙ_{ₖ} represent columns cₖ₁, . . . , cₖₙ_{ₖ} in Rₖ. The atom Rₖ(vₖ₁, . . . , vₖₙ_{ₖ}) is true if and only if the values of vₖ₁, . . . , vₖₙ_{ₖ} form a tuple in Rₖ. For each i between 1 and lₖ, the variables uᵢ₁, . . . , uᵢₘ_{ᵢ} represent the columns in Tₖᵢ. The atom Tₖᵢ(uᵢ₁, . . . , uᵢₘ_{ᵢ}) is true if and only if the values of uᵢ₁, . . . , uᵢₘ_{ᵢ} form a tuple in Tₖᵢ. The notation var(src(cₖⱼ)) denotes the variable representing the source column of cₖⱼ. For each k between 1 and s, the formula Φₖ defines what it means for the columns in Rₖ to be sourced from Tₖ₁, . . . , Tₖₗ_{ₖ}.

Combining Φₖ for all solution tables R₁, . . . , Rₛ results in the following formula Φ:

$$Φ := {{⋀}^{s}}_{k = 1} ∀ {v}_{k 1} … {v}_{{kn}_{k}} [ {R}_{k} ( {v}_{k 1} , … , {v}_{{kn}_{k}} ) \to ∃ {u}_{11} … {u}_{1 {m}_{1}} … {u}_{{l}_{k} 1} … {u}_{{l}_{k} {ml}_{k}} ( {{⋀}^{{l}_{k}}}_{i = 1} {T}_{ki} ( {u}_{i 1} , … , {u}_{{im}_{i}} ) ⋀ {C}_{T} ⋀ {{⋀}^{{n}_{k}}}_{j = 1} [ {v}_{kj} = var ( src ( {c}_{kj} ) ) ] ) ] .$$

Finally, the condition C_{\T} is incorporated into the semantic definition. As previously noted, this condition does not impose conditions on the tuples in the source tables, rather it is a condition that must be satisfied by the solution tables. In this embodiment, C_{\T} may be conjuncted with Φ, which gives the following formula ψ:

$${Ψ}_{FIND} := {{⋀}^{s}}_{k = 1} ∀ {v}_{k 1} … {v}_{{kn}_{k}} [ {R}_{k} ( {v}_{k 1} , … , {v}_{{kn}_{k}} ) \to ∃ {u}_{11} … {u}_{1 {m}_{1}} … {u}_{{l}_{k} 1} … {u}_{{l}_{k} {ml}_{k}} ( {{⋀}^{{l}_{k}}}_{i = 1} {T}_{ki} ( {u}_{i 1} , … , {u}_{{im}_{i}} ) ⋀ {C}_{T} ⋀ {{⋀}^{{n}_{k}}}_{j = 1} [ {v}_{kj} = var ( src ( {c}_{kj} ) ) ] ) ] ⋀ {C}_{\backslash T} .$$

The formula Ψ_{FIND} captures one illustrated embodiment of the semantics of the FIND FROM WHERE query. In this embodiment, a solution to the query exists if and only if there is an interpretation of R₁, . . . , Rₛ that satisfies Ψ_{FIND}. Such an interpretation of R₁, . . . , Rₛ represents a solution to the query.

2. Semantics of FIND FROM WHERE PREFERRING

The FIND query, in the form of FIND FROM WHERE, addresses decision problems. In order to handle optimization problems, in one embodiment, an optional PREFERRING block may be added to the FIND query after the WHERE block.

Given a preference P and two relations R₁ and R₂ with the same schema S, R₁<_{P} R₂ denotes that R₂ is better than (or dominates) R₁ with respect to P, and R₁≅_{P} R₂ denotes that R₁ and R₂ are substitutable (or equally good) with respect to P. Let R_{S} be the domain for all relations with schema S, and D be a totally ordered set. The operators <_{P} and ≅_{P} may be defined as follows:
If P is the maximization of a function ƒ: R_{S}→D, then R₁<_{P} R₂ if and only if ƒ(R₁)<_{D}ƒ(R₂), and R₁≅_{P} R₂ if and only if ƒ(R₁)=_{D}ƒ(R₂).
If P is the minimization of a function ƒ: R_{S}→D, then R₁<_{P} R₂ if and only if ƒ(R₂)<_{D}ƒ(R₁), and R₁≅_{P} R₂ if and only if ƒ(R₁)=_{D}ƒ(R₂).
If P is a Pareto of two preferences P₁ and P₂, then R₁<_{P} R₂ if and only if one of the following two conditions hold:
   R₁<_{P}_{₁} R₂, and R₁<_{P}_{₂} R₂ or R₁≅_{P}_{₂} R₂,
   R₁<_{P}_{₂} R₂, and R₁<_{P}_{₁} R₂ or R₁≅_{P}_{₁} R₂.
R₁≅_{P} R₂ if and only if R₁≅_{P}_{₁} R₂ and R₁≅_{P}_{₂} R₂.
If P is a prioritization of two preferences P₁ and P₂, then R₁<_{P} R₂ if and only if one of the following two conditions hold:
   R₁<_{P}_{₁} R₂,
   R₁≅_{P}_{₁} R₂ and R₁<_{P}_{₂} R₂
R₁≅_{P} R₂ if and only if R₁≅_{P}_{₁} R₂ and R₁≅_{P}_{₂} R₂.

Given a preference P, and relations R₁, . . . , Rₙ and Q₁, . . . , Qₙ where Rᵢ and Qᵢ are of the same schema for each i between 1 and n, (R₁, . . . , Rₙ)<_{P} (Q₁, . . . , Qₙ) if and only if the following two conditions hold: (1) Rᵢ<_{P} Qᵢ for some i between 1 and n, (2) Rⱼ<_{P} Qⱼ or Rⱼ≅_{P} Qⱼ for all j≠i.

Formal semantics of an embodiment of the FIND FROM WHERE PREFERRING query may be expressed in first-order logic by extending the formula Ψ_{FIND} (defined above) to capture what the PREFERRING clause means.

Given a FIND query with PREFERRING, the preference P in the PREFERRING clause may be divided into two parts, P_{T} and P_{\T}, such that P_{T}≡P_{T} [symbol] P_{\T}. P_{T} is the preference on the tuples in source tables T. Only non-dominated tuples with respect to P_{T} in the source tables could go into the solution tables. P_{\T} is the rest of P and does not impose any preference condition on the tuples in T. It is an arbitrary preference that specifies which solutions are preferred to others, i.e., the preferred ways of populating the solution tables.

Incorporating P_{T} into Ψ_{FIND} captures the requirement that only non-dominated tuples with respect to P_{T} in the source tables may go into the solution tables. In one embodiment, this may be expressed in the following formula Θ:

$$Θ := {{⋀}^{s}}_{k = 1} ∀ {v}_{k 1} … {v}_{{kn}_{k}} [ {R}_{k} ( {v}_{k 1} , … , {v}_{{kn}_{k}} ) \to ∃ {u}_{11} … {u}_{1 {m}_{1}} … {u}_{{l}_{k} 1} … {u}_{{l}_{k} {{m}_{l}}_{k}} ( {{⋀}^{{l}_{k}}}_{i = 1} {T}_{ki} ( {u}_{i 1} , … , {u}_{{im}_{i}} ) ⋀ {C}_{T} ⋀ {{⋀}^{{n}_{k}}}_{j = 1} [ {v}_{kj} = var ( src ( {c}_{kj} ) ) ] ⋀ ∃ {w}_{11} … {w}_{1 {m}_{1}} … {w}_{{l}_{k} 1} … {w}_{{l}_{k} {m}_{{l}_{k}}} ( {{⋀}^{{l}_{k}}}_{i = 1} {T}_{ki} ( {w}_{i 1} , … , {w}_{{im}_{i}} ) ⋀ {C}_{T} ⋀ ( u {<}_{{P}_{T}} w ) ) ) ] ⋀ {C}_{\backslash T} .$$

In the formula Θ, the symbol u denotes the variables u₁₁, . . . , u₁ₘ_{₁}, . . . , u₁ₖ_{₁}, . . . , u₁_{ₖ}m₁_{ₖ}. Likewise, w denotes the variables w₁₁, . . . , w₁ₘ_{₁}, . . . , w₁ₖ_{₁}, . . . , w₁_{ₖ}w₁_{ₖ}. The expression u<_{P}_{_{T}} w is true if and only if the tuple represented by u is dominated by the one represented by w with respect to P_{T}.

As previously noted, P_{\T} specifies the preferred ways of populating the solution tables. P_{\T} may be incorporated into the semantic definition by combining Θ and P_{\T} as follows:

Ψ_{FIND/P}:=Θ(R₁, . . . , R_{S}) [symbol] [symbol] ∃R₁′ . . . Rₛ′(Θ)(R₁′, . . . , Rₛ′) [symbol] [(R₁, . . . , Rₛ)<P_{\T}(R₁′, . . . , Rₛ′)]).

The formula Ψ_{FIND/P} captures one embodiment of the semantics of the FIND FROM WHERE PREFERRING query. In the formula, the notation Θ(R₁, . . . , Rₛ) denotes the formula Θ in which the solution tables are represented by R₁, . . . , Rₛ. Similarly, Θ(R₁′, . . . , Rₛ′) denotes Θ in which the solution tables are represented by R₁′, . . . , Rₛ′. For each i between 1 and s, Rᵢ′ is a relation of the same schema as Rᵢ.

Translating Search Problems Expressed in a DQL

As previously discussed, in some embodiments, a search problem expressed in a data query language may be translated, such as by an embodiment of the search problem solver system 202 in FIG. 2, into an intermediate problem expression. For example, in some embodiments, a search problem expressed in a data query language may be translated into a problem expression in a mathematical language, such as, for example, a problem expression in an mathematical language based on first-order logic.

There are many benefits of translating a search problem in a data query language into an intermediate mathematical language. For example, a problem defined in an intermediate mathematical language may be further translated into a representation that may be solved by an existing solver. As one example, first-order logic may be translated to propositional satisfiability and/or linear/integer programming, both of which have advanced solvers available. As another example benefit, a problem defined in an intermediate language may be optimized to facilitate a faster solving process. For example, a problem represented in an intermediate language like first-order logic may be analyzed to determine optimizations that may be performed to make the problem easier to solve. This kind of analysis is more difficult at the data query language level.

In one example embodiment, a search problem expressed in a data query language, such as a search problem expressed using a FIND query, may be translated into first-order Model Expansion (“MX”). As previously noted, MX is a framework that may be used for modeling and solving search problems using logic. Depending on the type of logic used as the modeling language, MX can come in different variations. In this example embodiment, the focus is on first-order MX, in which the modeling language is based on first-order logic.

To model a problem in MX, a problem specification and problem data describing a specific instance of the problem may be provided. For example, if the problem in question is graph coloring, then the problem specification states the constraints for the problem, such as no two adjacent vertices may share the same color, and the problem data describes a specific graph.

Specifically, a problem specification in MX is composed of three sections:

1. Given: This section declares types, instance relations, and constants. For example, the graph coloring problem may have the two types Vertex and Color, and the instance relation Edge: Vertex×Vertex, which represents the edges in the graph.

2. Find: This section declares expansion relations, whose interpretation is determined by the solver. An interpretation of the expansion relations that satisfies the problem constraints corresponds to a solution to the problem. For example, the graph coloring problem may have the expansion relation Coloring: Vertex×Color.

3. Satisfying: This section specifies the problem constraints as first-order logic formulas. A solution to the problem exists if and only if there is an interpretation of the expansion relations that satisfies the constraints. The following formulas express the constraints for the graph coloring problem.

∀xyz [symbol] (Edge(x,y) [symbol] Coloring(x,z) [symbol] Coloring(y,z))

∀x∃y Coloring(x,y)

∀xy₁y₂ [symbol] (Coloring(x,y₁) [symbol] Coloring(x,y₂) [symbol] y₁<y₂)

The problem data defines types, instance relations and constants. For example, for the graph coloring problem, the data defines the colors, the vertices in the graph, and the edges in the graph.

However, first-order MX lacks necessary primitives in which to treat both numeric constraints and optimization objectives. To account for optimization problems, such as those expressed in a FIND query with PREFERRING, MX may be extended. Expanding upon the basic MX framework also allows for better treatment of arithmetic and aggregate operators in SQL which operate on numeric data. In at least one embodiment, MX may be extended to support constraint satisfaction and optimization problems, such as those that may be expressed using the FIND query, by adding one or more arithmetic operators, aggregate operators and support for optimization objectives.

MX may be extended to include the following arithmetic operators: +, −, *, /, MOD and ABS. The meaning of those operators is standard. Search problems with arithmetics involve numeric domains. Numeric domains may be infinite. For example, the continuous domain of real numbers between 1 and 10 is infinite. Currently, domains in MX specifications must be finite. Therefore, in order to make MX capable of handling problems with arithmetics, MX is extended to allow infinite domains.

In addition, MX may be extended to include the following aggregate operators: MAX, MIN, COUNT, DCOUNT, SUM, DSUM, AVG and DAVG. Each aggregate operator takes three operands:

1. an expression ƒ( x̅) composed of constants, variables and arithmetic operators, where x̅ are variables,

2. a collection of variables x̅,

3. a first-order formula Φ( x̅).

The expression ƒ( x̅) is the expression to which the aggregate operation is applied. The formula Φ( x̅) is the condition on which combinations of values for x̅ are put in ƒ( x̅) to compute the aggregate value. Only those combinations that make Φ( x̅) true are put in ƒ( x̅) to compute the aggregate value.

In one embodiment, the semantics of the aggregate operators may be defined as follows:

MAX(ƒ( x̅); x̅; Φ( x̅):=max{ƒ( x̅) |Φ( x̅) [symbol] [symbol] Null(ƒ( x̅))}

MIN(ƒ( x̅); x̅; Φ( x̅)):=min{ƒ( x̅)|Φ( x̅) [symbol] [symbol] Null(ƒ( x̅))}

COUNT(ƒ( x̅); x̅; Φ( x̅)):=|{{ƒ( x̅)|Φ( x̅) [symbol] [symbol] Null(ƒ( x̅))}}|

DCOUNT(ƒ( x̅); x̅; Φ( x̅)):=|{ƒ( x̅) |Φ( x̅) [symbol] [symbol] Null(ƒ( x̅))}|

SUM(ƒ( x̅); x̅; Φ( x̅)):=Σ{{ƒ( x̅)|Φ( x̅) [symbol] [symbol] Null(ƒ( x̅)) }}

DSUM(ƒ( x̅); x̅; Φ( x̅)):=Σ{ƒ( x̅)|Φ( x̅) [symbol] [symbol] Null(ƒ( x̅))}

AVG(ƒ( x̅); x̅; Φ( x̅)):=SUM(ƒ( x̅); x̅; Φ( x̅))/COUNT(ƒ( x̅); x̅; Φ x̅))

DAVG(ƒ( x̅); x̅; Φ( x̅)):=DSUM(ƒ( x̅); x̅; Φ( x̅))/DCOUNT(ƒ( x̅); x̅; Φ( x̅))

In the above definition, {•} indicates a set (no duplicate elements) and {{•}} indicates a multiset (duplicate elements are allowed). For any set or multiset S, |S| gives the number of elements in S.

For MAX, MIN, SUM and DSUM, if the set or multiset is empty, then the value of the aggregate expression is NULL. For COUNT and DCOUNT, the value is 0.

As FIND queries are translated to MX specifications, in order to combine FIND and PREFERRING to handle optimization problems, MX may be extended to include optimization capabilities. In one embodiment, an optional Optimizing section may be added to MX specifications. This new section is where optimization objectives may be specified. In addition, two new keywords are also added to MX, maximum and minimum, for maximization and minimization objectives, respectively.

For example, let f be an arithmetic expression that may contain numeric constants, arithmetic expressions and aggregate expressions. The Optimizing section accepts an expression O of one of the following forms:

maximum ƒ

minimum ƒ

O₁ && O₂

O₁>>O₂

The operators && and >> are Pareto and prioritization operators, respectively. The Pareto operator connects two equally important optimization objectives, while the prioritization operator connects an objective O₁ with another one O₂ which has a lower priority. The Pareto operator forms a new objective from the constituents such that a Pareto optimal point cannot improve either objective O₂ or O₁ without worsening the other O₂ or O₁. The prioritization operator first optimizes for O₁, and in the case of ties on this objective, considers O₂ to break the tie.

Both && and >> are associative:

(O₁ && O₂)&& O₃=O₁ && (O₂ && O₃)

(O₁>>O₂)>>O₃=O₁>>(O₂>>O₃)

In addition a distributive law holds

O₁>>(O₂ && O₃)=(O₁>>O₂)&& (O₁>>O₃)

(O₁ && O₂)>>O₃=(O₁>>O₃)&& (O₂>>O₃)

With these properties any objective involving either operator may be brought into a canonical form, such as

P¹ && P² && P³ && . . . .

where each subproblem Pⁱ is a prioritized chain of objectives having the form

Pⁱ=O₁ⁱ>>O₂ⁱ>>O₃ⁱ>> . . . >>Oₙⁱ.

In this embodiment, a user is not required to specify an objective in the canonical form, this form may be derived from any expression using && and >>. The advantage of the canonical form is that each prioritized chain Pⁱ may be converted to a single objective. For example, without loss of generality, assume that all objectives O₁ⁱ,O₂ⁱ, . . . are maximization problems (since minimum ƒ=−maximum−ƒ); let Mⱼⁱ be an upper bound on the value of maximization objective Oⱼⁱ=maximum ƒⱼⁱ, then

Pⁱ=maximum(ƒₙⁱ+Mₙⁱƒₙ₋₁ⁱ+MₙⁱMₙ₋₁ⁱƒₙ₋₂ⁱ+ . . . +MₙⁱMₙ₋₁ⁱ . . . M₂ⁱƒ₁ⁱ)

Thus, any sequence of && or >> operators may be converted to a standard multi-objective optimization problems which may be addressed by standard means.

In at least one embodiment, translating a search problem expressed in a data query language, such as a problem expressed in SQL extended with the FIND query, into a problem expression in a first order logic language, such as expanded MX, may include several translations. For example, such translations may include translating solution tables, table expression, value expressions, aggregate query expressions, set operations, and optimization objectives that are expressed in a DQL search problem into a problem expressed in a first order logic language.

The following translations illustrate one example embodiment of translating search problems expressed in SQL extended with FIND queries into extended MX.

1. Translation of Solution Tables

As previously mentioned, a FIND query may express a search problem as a problem of populating one or more solution tables, subject to a condition. Each n-column solution table may be represented by an n-ary expansion relation in the MX specification for the FIND query. The data type of each column in an expansion relation may be determined from the source column. In this illustrated embodiment, translating solution tables into MX may include translating column source constraints and column modifiers into MX.

As one illustrative example, column source constraints may be translated as follows:

Given a solution table R with columns c₁, . . . , cₙ, suppose c₁, . . . , cₙ are sourced from tables T₁, . . . , Tₗ; the source columns of c₁, . . . , cₙ are denoted as src(c₁), . . . , src(cₙ); the constraint that columns c₁, . . . , cₙ are sourced from tables T₁, . . . , Tₗ may be expressed with the following formula:

$$∀ {v}_{ 1} … {v}_{n} [ R ( {v}_{ 1} , … , {v}_{n} ) \to ∃ {u}_{11} … {u}_{1 {m}_{1}} … {u}_{l 1} … {u}_{{l m}_{l}} ( {{⋀}^{l}}_{i = 1} translate ( {T}_{i} ) ⋀ translate ( {C}_{T} ) ⋀ {{⋀}^{n}}_{j = 1} [ {v}_{i} = var ( src ( {c}_{i} ) ) ] ) .$$

In the above formula, the variables v₁, . . . , vₙ represent columns c₁, . . . , cₙ in R. The Boolean atom R(v₁, . . . , vₙ) is true if and only if the values of v₁, . . . , vₙ, form a tuple in R. For each i between 1 and l, the variables u₁, . . . , uₘ represent the columns in Tᵢ. The notation translate(Tᵢ) is the translation of Tᵢ. Similarly, translate(C_{T}) is the translation of the condition C_{T}, which is the condition on the tuples in the source tables. In the rest of this section, the notation translate(ρ) denotes the translation of an SQL expression ρ.

Column modifiers may be used to impose constraints on columns in one or more solution tables. In one embodiment, column modifiers may be expressed using keywords COMPLETE and UNIQUE. For example, the modifier UNIQUE specifies that one or more columns in a solution table are unique such that the solution table may not have two distinct tuples that share the same combination of values for the unique columns. Suppose a column cᵢ is unique in a solution table R. The uniqueness constraint may be expressed with the following formula:

∀v₁ . . . vₙu₁ . . . uᵢ₋₁uᵢ₊₁ . . . uₙ [symbol] (R(v₁, . . . , vₙ) [symbol] R(u₁, . . . , uᵢ₋₁, v₁, uᵢ₊₁, . . . , uₙ) [symbol] ((u₁<v₁) [symbol] (uᵢ₋₁<vᵢ₋₁) [symbol] (uᵢ₊₁<vᵢ₊₁) [symbol] (uₙ<vₙ))).

In cases where two or more columns are unique in R, such as, for example, if columns cᵢ and cⱼ are unique, the uniqueness constraint may be expressed with the following formula:

∀v₁ . . . vₙu₁ . . . uᵢ₋₁uᵢ₊₁ . . . uⱼ₋₁ . . . uⱼ₊₁ . . . uₙ [symbol] (R(v₁, . . . , vₙ) [symbol] R(u₁, . . . , uᵢ₋₁, v₁, uᵢ₊₁, . . . , uⱼ₋₁, vⱼ, uⱼ₊₁, . . . , uₙ) [symbol] ((u₁<v₁) [symbol] (uᵢ₋₁<vᵢ₋₁) [symbol] (uᵢ₊₁<vᵢ₊₁) [symbol] (uⱼ₋₁<vⱼ₋₁) [symbol] (uⱼ₊₁<vⱼ₊₁) [symbol] (uₙ<vₙ)))

The modifier COMPLETE may specify that one or more columns in a solution table are complete. Given a solution table R containing columns c₁, . . . , cₘ, suppose the domains of c₁, . . . , cₘ are D₁, . . . , Dₘ, respectively. Then c₁, . . . , cₘ are jointly complete if and only if for each tuple (a₁, . . . , aₘ) in D₁× . . . ×Dₘ, R has at least one tuple r such that r.cᵢ=aᵢ for all i=1 to m, as long as the source tables allow R to have such a tuple. Suppose a column cᵢ is complete in a solution table R, and cᵢ is sourced from a column in a table T. Then the completeness constraint may be expressed with the following formula:

∀vᵢ([∃u₁ . . . uₘ(translate(T) [symbol] translate(C_{T}) [symbol] [vᵢ=var(src(cᵢ))])]→[∃v₁ . . . vᵢ₋₁vᵢ₊₁ . . . vₙR(v₁, . . . , vₙ)])

In cases where two or more columns are complete in R, such as, for example, if columns cᵢ and cⱼ are complete, and both are sourced from table T, then the completeness constraint may be expressed with the following formula:

∀vᵢvⱼ([∃u₁ . . . uₘ(translate(T) [symbol] translate(C_{T}) [symbol] [vᵢ=var(src(cᵢ))] [symbol] [vⱼ=var(src(cⱼ))])]→[∃v₁ . . . vᵢ₋₁vᵢ₊₁ . . . vⱼ₋₁vⱼ₊₁ . . . vₙR(v₁, . . . , vₙ)]).

Columns cᵢ and cⱼ may be sourced from different tables. If cᵢ is sourced from table T₁ and cⱼ is sourced from table T₂, then the completeness constraint may be expressed with the following formula:

∀vᵢvⱼ([∃u₁ . . . uₘw₁ . . . wₚ(translate(T₁) [symbol] translate(T₂) [symbol] translate(C_{T}) [symbol] [vᵢ=var(src(cᵢ))] [symbol] [vⱼ=var(src(cⱼ))])]→[∃v₁ . . . vᵢ₋₁vᵢ₊₁ . . . vⱼ₋₁vⱼ₊₁ . . . vₙR(v₁, . . . , vₙ)])

In the above formula, the variables u₁, . . . , uₘ represent the columns in T₁, and w₁, . . . , wₚ represent the columns in T₂.

2. Translation of Table Expressions

A table expression may occur in the FROM clause of a FIND query or the FROM clause of a SELECT query within FIND. It may be in the form of a table name or a query expression. If the table expression is a table name P, then it may be translated to a Boolean atom with P as the relation name. The columns in table P are represented as variables. Therefore, if table P has n columns, the table expression may be translated to an n-ary atom with n variables as arguments, such as,

translate(P):=P(v₁, . . . , vₙ).

If the table expression is a query, for example, a SELECT query, then it may be translated to an existential quantification, such as,

translate(SELECT e₁, . . . , eⱼ FROM T₁, . . . , Tₖ WHERE C):=∃v₁, . . . vₙ(translate(T₁) [symbol] translate(Tₖ) [symbol] translate(C) [symbol] (u₁=translate(e₁)) [symbol] (uⱼ=translate(eⱼ)))

The expressions e₁, . . . , eⱼ in the above presented SELECT query involve column names in tables T₁, . . . , Tₖ. The expression C in the query is Boolean. The variables v₁, . . . , vₙ represent the columns in tables T₁, . . . , Tₖ. The variables u₁, . . . , uⱼ represent the columns generated by the SELECT query.

3. Translation of Value Expressions

A value expression evaluates to a single value and may occur in the WHERE clause of a FIND query or the WHERE clause of a SELECT query within FIND.

Literals are translated to constants. A unique name is created for each constant, and the value of the constant is set to the corresponding literal.

Column references are translated to variables. A column reference refers to a column in a table. For example, consider the following SELECT query:

SELECT*FROM Coloring cg1, Coloring cg2, Edge e

WHERE cg1.vtx=e.vtx1 AND cg2.vtx=e.vtx2 AND cg1.col=cg2.col

In the query, cg1.vtx, cg1.col, cg2.vtx, cg2.col, e.vtx1 and e.vtx2 are column references, where cg1, cg2 and e identify the tables to which the column references refer.

AND, OR, NOT, IF and IFF expressions are translated to their counterparts in first-order logic, for example:

translate(expr₁ AND expr₂):=translate(exprᵢ) [symbol] translate(expr₂).

translate(expr₁ OR expr₂):=translate(expr₁) [symbol] translate(expr₂).

translate(NOT expr):= [symbol] translate(expr₁).

translate(expr₁ IF expr₂):=translate(expr₂)→translate(expr₁).

translate(expr₁ IFF expr₂):=translate(expr₁) [symbol] translate(expr₂).

Comparisons involving =, < >, >, <, ≧ and ≦ are translated to their counterparts in first-order logic, for example:

translate(expr₁=expr₂):=translate(expr₁)=translate(expr₂).

translate(expr₁< >expr₂):=translate(expr₁)≠translate(expr₂).

translate(expr₁>expr₂):=translate(expr₁)>translate(expr₂).

translate(expr₁<expr₂):=translate(expr₁)<translate(expr₂).

translate(expr₁≧expr₂):=translate(expr₁)≧translate(expr₂).

translate(expr₁≦expr₂):=translate(expr₁)≦translate(expr₂).

A BETWEEN expression is translated to a conjunction of a greater-equal comparison and a less-equal comparison:

translate(expr BETWEEN expr₁ AND expr₂):=(translate(expr)≧translate(expr₁)) [symbol] (translate(expr)≦translate(expr₂)).

An IN list expression is translated to a disjunction of equalities:

translate(expr IN(expr₁, . . . , exprₖ)):=(translate(expr)=translate(expr₁)) [symbol] (translate(expr)=translate(exprₖ)).

An IS NULL expression is translated to an equality to a constant whose value is designated for NULL:

translate(expr IS NULL):=translate(expr)=NULL_CONST.

The value of the constant NULL_CONST is designated for NULL. For an IS NOT NULL expression, the translation is the same except the equality is negated:

Translate(expr IS NOT NULL):= [symbol] (translate(expr)=NULL_CONST).

An EXISTS expression is true if and only if the subquery in the expression returns a non-empty set. It is translated to an existential quantification:

translate(EXISTS(SELECT*FROM T₁, . . . , Tₙ WHERE C)):=∃v₁ . . . vₙ(translate(T₁) [symbol] translate(Tₙ) [symbol] translate(C)).

The variables v₁, . . . , vₙ represent the columns in tables T₁, . . . , Tₙ.

ANY and ALL expressions are syntactic variants of the EXISTS expressions:

translate(expr₁ op ANY(SELECT expr₂ FROM T₁, . . . , Tₙ WHERE C):=translate(EXISTS(SELECT*FROM T₁, . . . , Tₙ WHERE C AND expr₁ op expr₂))

translate(expr₁ op ALL(SELECT expr₂ FROM T₁, . . . , Tₙ WHERE C):=translate(NOT EXISTS(SELECT*FROM T₁, . . . , Tₙ WHERE C AND NOT(expr₁ op expr₂))).

The symbol op above may be one of =, < >, >, <, ≧ and ≦.

IN and NOT IN expressions are syntactic variants of ANY and ALL expressions, respectively:

translate(expr₁ IN(SELECT expr₂ FROM T₁, . . . , Tₙ WHERE C):=translate(expr₁=ANY(SELECT expr₂ FROM T₁, . . . , Tₙ WHERE C))

translate(expr₁ NOT IN(SELECT expr₂ FROM T₁, . . . , Tₙ WHERE C):=translate(expr₁< >ALL(SELECT expr₂ FROM T₁, . . . , Tₙ WHERE C)).

FORALL and FORSOME expressions are syntactic variants of EXISTS expressions:

translate(FORALL(SELECT*FROM T₁, . . . , Tₙ WHERE C₁)t REQUIRING C₂):=translate(NOT EXISTS(SELECT*FROM (SELECT*FROM T₁, . . . , Tₙ WHERE C₁) t WHERE NOT C₂)).

translate(FORSOME(SELECT*FROM T₁, . . . , Tₙ WHERE C₁)t REQUIRING C₂):=translate(EXISTS(SELECT*FROM(SELECT*FROM T₁, . . . , Tₙ WHERE C₁)t WHERE C₂)).

SUCC expressions are represented as SUCC expressions in MX:

translate(SUCC(expr₁, expr₂)):=SUCC(translate(expr₁), translate(expr₂)).

CYCLIC_SUCC expressions are represented using SUCC, MAX and MIN:

translate(CYCLIC_SUCC(expr₁, expr₂)):=SUCC(translate(expr₁), translate(expr₂)) [symbol] (translate(expr₁)=MAX [symbol] translate(expr₂)=MIN).

It should be noted that MAX and MIN as illustrated with respect to CYCLIC_SUCC are built-in symbols in MX denoting the largest and smallest value of a data type. They should not be confused with the aggregate operators MAX and MIN discussed elsewhere with respect to expanding MX to support aggregate operators.

4. Translation of Aggregate Queries

SQL aggregate queries without GROUP BY are translated to MX aggregate expressions, as shown by the following table:

| SQL Aggregate Query | MX Aggregate Expression |
|---|---|
| SELECT MAX(e) | MAX(translate(e); x̅₁, . . . , x̅ₙ; [symbol] ᵢ₋₁ⁿ translate(Tᵢ) [symbol] |
| FROM T₁, . . . , Tₙ WHERE C | translate(C)) |
| SELECT MIN(e) | MIN(translate(e); x̅₁, . . . , x̅ₙ; [symbol] ᵢ₋₁ⁿ translate(Tᵢ) [symbol] |
| FROM T₁, . . . , Tₙ WHERE C | translate(C)) |
| SELECT COUNT(*) | COUNT(1; x̅₁, . . . , x̅ₙ; [symbol] ᵢ₌₁ⁿ translate(Tᵢ) [symbol] |
| FROM T₁, . . . , Tₙ WHERE C | translate(C)) |
| SELECT COUNT(e) | COUNT(translate(e); x̅₁, . . . , x̅ₙ; [symbol] ᵢ₋₁ⁿ translate(Tᵢ) [symbol] |
| FROM T₁, . . . , Tₙ WHERE C | translate(C)) |
| SELECT COUNT(DISTINCT e) | DCOUNT(translate(e); x̅₁, . . . , x̅ₙ; [symbol] ᵢ₋₁ⁿ translate(Tᵢ) |
| FROM T₁, . . . , Tₙ WHERE C | [symbol] translate(C)) |
| SELECT SUM(e) | SUM(translate(e); x̅₁, . . . , x̅ₙ; [symbol] ᵢ₋₁ⁿ translate(Tᵢ) [symbol] |
| FROM T₁, . . . , Tₙ WHERE C | translate(C)) |
| SELECT SUM(DISTINCT e) | DSUM(translate(e); x̅₁, . . . , x̅ₙ; [symbol] ᵢ₋₁ⁿ translate(Tᵢ) [symbol] |
| FROM T₁, . . . , Tₙ WHERE C | translate(C)) |
| SELECT AVG(e) | AVG(translate(e); x̅₁, . . . , x̅ₙ; [symbol] ᵢ₋₁ⁿ translate(Tᵢ) [symbol] |
| FROM T₁, . . . , Tₙ WHERE C | translate(C)) |
| SELECT AVG(DISTINCT e) | DAVG(translate(e); x̅₁, . . . , x̅ₙ; [symbol] ᵢ₋₁ⁿ translate(Tᵢ) [symbol] |
| FROM T₁, . . . , Tₙ WHERE C | translate(C)) |

In the table above, x̅ᵢ are variables reprsenting the colums in each T₁.

In SQL, aggregate operators are often used with GROUP BY, for example:

SELECT MAX(e)

FROM T₁, . . . , Tₙ WHERE C GROUP BY c₁, . . . , cₗ

SELECT COUNT(*)

FROM T₁, . . . , Tₙ WHERE C GROUP BY c₁, . . . , cₗ

SELECT SUM(DISTINCT e) FROM T₁, . . . , Tₙ WHERE C GROUP BY c₁, . . . , cₗ

Each cⱼ is an expression composed of column names in one or more tables Tᵢ. For the purposes of this illustrated embodiment, it is assumed that each cⱼ is a column name, which is the most common case.

An aggregate query with GROUP BY may return more than one value, so strictly speaking it should be translated to a multiset. However, this is not necessary in the context of FIND. In a FIND query, aggregate queries with GROUP BY are used within ANY, ALL, IN or NOT IN expressions, for example:

ê≦ANY(SELECT MAX(e)FROM T₁, . . . , Tₙ, WHERE C GROUP BY c₁, . . . , cₗ)

ê>ALL(SELECT COUNT(*)FROM T₁, . . . , Tₙ WHERE C GROUP BY c₁, . . . , cₗ)

êIN(SELECT SUM(DISTINCT e)FROM T₁, . . . , Tₙ WHERE C GROUP BY c₁, . . . , cₗ)

êNOT IN(SELECT MIN(e)FROM T₁, . . . , Tₙ WHERE C GROUP BY c₁, . . . , cₗ)

IN and NOT IN are semantically equivalent to =ANY and < >ALL, respectively, therefore it is only necessary to address ANY and ALL below.

Let xᵢ be variables representing the columns in each Tᵢ, and \tilde{x} be variables representing c₁, . . . , cₗ such that \tilde{x}⊂{x₁, . . . , xₙ}. Additionally, let yᵢ be variables representing the columns in each Tᵢ, and \tilde{y} be variables representing c₁, . . . , cₗ such that \tilde{y}⊂{y₁, . . . , yₙ}. The ANY expression

êop ANY(SELECT MAX(e)FROM T₁, . . . , Tₙ WHERE C GROUP BY c₁, . . . , cₗ),

where op is =, < >, >, <, ≧ or ≦, may be translated to the following formula:

∃\tilde{x}(∃{x₁, . . . , xₙ}\\tilde{x}( [symbol] ᵢ₋₁ⁿ translate(Tᵢ) [symbol] translate(C)) [symbol] translate(ê)op MAX(translate(e)[\tilde{x}/\tilde{y}]; {y₁, . . . , yₙ}\\tilde{y}; [symbol] ᵢ₋₁ⁿ translate(Tᵢ)[\tilde{x}/\tilde{y}] [symbol] translate(C)[\tilde{x}/\tilde{y}])).

The notation ρ[\tilde{x}/\tilde{y}] means that the variables \tilde{x} replace \tilde{y} in the expression ρ. The formula above says that there exist some \tilde{x} such that the join of all Tᵢ has a tuple with (c₁, . . . , cₗ)=\tilde{x} that satisfies C, and among all such tuples the maximum value for e must be a value, say K, such that ê op K. Cases where the aggregate operator is not MAX are similar, and in such cases, for example, simply replace MAX in the above formula with the proper aggregate operator.

The ALL expression

êop ALL(SELECT MAX(e)FROM T₁, . . . , Tₙ WHERE C GROUP BY c₁, . . . , cₗ)

may be translated to the following formula:

∀\tilde{x}(∃{x₁, . . . xₙ}\\tilde{x}( [symbol] ᵢ₌₁ⁿ=translate(Tᵢ) [symbol] translate(C))→translate(ê)op MAX(translate(e)[\tilde{x}/\tilde{y}]; {y₁, . . . , yₙ}\\tilde{y}; [symbol] ᵢ₌₁ⁿ translate(Tᵢ)[\tilde{x}/\tilde{y}] [symbol] translate(C)[\tilde{x}/\tilde{y}])).

The formula above says that for all \tilde{x}, if the join of all Tᵢ has a tuple with (c₁, . . . , cₗ)=\tilde{x} that satisfies C, then among all such tuples the maximum value for e must be a value, for example, K, such that ê op K. Again, cases where the aggregate operator is not MAX are similar, and in such cases, for example, simply replace MAX in the above formula with the proper aggregate operator.

5. Translation of Set Operations

The set operators UNION, INTERSECT and EXCEPT may be used to produce the union, intersection and difference of two query results, respectively. In the context of a FIND query, expressions with set operators may be written in MX as logically equivalent expressions without set operators.

6. Translation of Optimization Objectives

Optimization objectives in a FIND query are specified in the PREFERRING clause. In this illustrated embodiment, there may be two kinds of objectives: base objectives and complex objectives. A base objective may be expressed as an aggregate query followed by the operator HIGHEST (for maximization) or LOWEST (for minimization). The aggregate query must return a single value, and therefore, the use of GROUP BY is disallowed in optimization objectives. A complex objective is composed of two or more base objectives connected by the Pareto and prioritization operators.

If the objective in the PREFERRING clause is a base objective, the objective may be translated it to an MX aggregate expression preceded by the keyword maximum (for HIGHEST) or minimum (for LOWEST) and placed into the newly added Optimizing section (as discussed above). If the objective is a complex objective, the objective may be translated to an expression involving the operators && or >>.

It will be appreciated that the above example translations of search problems expressed in a data query language into an expression in an intermediate mathematical language are provided for illustrative purposes and other translations may exist in other embodiments. For example, in other embodiments, other translations may be used instead of or in addition to the presented translations. In addition, other keywords and/or operations may be used to express translations similar to the above translations. In addition, although the preceding example embodiment describes using a data query language based on SQL, other data query languages may be used in other embodiments. In addition, other mathematical languages, in addition to or instead of MX, may be used as an intermediate mathematical language.

Example Problems and Translations

Various examples of specifying optimization problems as FIND queries and translations of those FIND queries into corresponding MX specifications in accordance with the described techniques are now presented. In these examples, standard MX syntax is followed, such that ? represents ∃, ! represents ∀, & represents [symbol] |represents [symbol] ^{˜} represents [symbol] and =>represents →. These examples are merely illustrative are not intended to be inclusive.

1. Freight Transfer

In the example freight transfer problem, there are a fleet of trucks of various types. Each type of truck has a capacity (in tons), a cost of operations (in dollars) and a quantity (number of trucks of that type). In this example, a solution table is sought that consists of the cheapest way of shipping 42 tons subject to the constraint that at most 8 trucks may be used. A database table named Fleet describes the different types of trucks available in a fleet of 12 vehicles:

| type | quantity | capacity | cost |
|---|---|---|---|
| 1 | 3 | 7 | 90 |
| 2 | 3 | 5 | 60 |
| 3 | 3 | 4 | 50 |
| 4 | 3 | 3 | 40 |

This example freight transfer problem may be expressed as an integer programming formulation:

min 90x₁+60x₂+50x₃+40x₄

such that: 7x₁+5x₂+4x₃+3x₄≧42

x₁+x₂+x₃+x₄≦8

In this formulation xᵢ ε{0, 1, 2, 3} represents the number of trucks of type i used. The objective to be minimized gives the costs of operating the trucks. The first constraint ensures that the total capacity is at least 42 tons, and the second constraint makes sure that no more than 8 trucks are used.

The freight transfer problem may be formulated as the following FIND query:

| 1. | FIND Allocation(type UNIQUE COMPLETE, intvalue AS num_used) | |
|---|---|---|
| 2. | FROM Fleet, INTRANGE(0, SELECT MAX(quantity) FROM Fleet) | |
| 3. | WHERE | (SELECT SUM(capacity * num_used) FROM Fleet f, |
| 4. | | Allocation a WHERE f.type = a.type) >= 42 |

| 5. | AND | (SELECT SUM(num_used) FROM Allocation) <= 8 | |
|---|---|---|---|
| 6. | AND | FORALL (SELECT * FROM Allocation) a | |
| 7. | | REQUIRING EXISTS | (SELECT * FROM Fleet f |

| | |
|---|---|
| 8. | WHERE f.type = a.type AND f.quantity >= |
| 9. | a.num_used) |

| | | |
|---|---|---|
| 10. | PREFERRING | (SELECT SUM(cost * num_used) FROM Fleet f, |
| 11. | | Allocation a WHERE f.type = a.type) LOWEST |

The FIND query may be translated to the following MX specification:

| | |
|---|---|
| 1. | Given: |
| 2. | type Type Quantity Capacity Cost NumUsed; |
| 3. | Fleet(Type,Quantity,Capacity,Cost) |
| 4. | Find: |
| 5. | Allocation(Type,NumUsed) |
| 6. | Satisfying: |
| 7. | SUM(p * u; t,q,p,c,u; Fleet(t,q,p,c) & Allocation(t,u)) >= 42 |
| 8. | SUM(u; t,u; Allocation(t,u)) <= 8 |
| 9. | ! t u : (Allocation(t,u) => ? q>=u p c : Fleet(t,q,p,c)) |
| 10. | ! t u1 u2>u1 : ~(Allocation(t,u1) & Allocation(t,u2)) |
| 11. | ! t : ? u : Allocation(t,u) |
| 12. | Optimizing: |
| 13. | minimum SUM(c * u; t,q,p,c,u; Fleet(t,q,p,c) & |
| 14. | Allocation(t,u)) |

2. Product Configuration

The product configuration problem is to decide which type of power supply, disk driver and memory to install in a laptop computer. In this example, a solution is sought such that the total weight of the laptop is minimized while meeting the various requirements on disk space, memory and power. There are different variants for the power supply, disk drive and memory. In addition, only one power supply, at most 3 disk drives and at most 3 memory chips may be used. Given these components, it is also required that the laptop have a net power generation that is nonnegative, an amount of disk space that is at least 700, and a memory that is at least 850.

The possible component parts in this example may be described by a database table named Component, such as:

| type | variant | power | space | capacity | weight | max |
|---|---|---|---|---|---|---|
| ‘power’ | A | 70 | NULL | NULL | 200 | 1 |
| ‘power’ | B | 100 | NULL | NULL | 250 | 1 |
| ‘power’ | C | 150 | NULL | NULL | 350 | 1 |
| ‘disk’ | A | −30 | 500 | NULL | 140 | 3 |
| ‘disk’ | B | −50 | 800 | NULL | 300 | 3 |
| ‘memory’ | A | −20 | NULL | 250 | 20 | 3 |
| ‘memory’ | B | −25 | NULL | 300 | 25 | 3 |
| ‘memory’ | C | −30 | NULL | 400 | 25 | 3 |

The column type indicates the type of component, variant indicates the variant within the type, power is the net power generation, space is the disk space supplied by the component, capacity is the disk capacity of the component, weight is its weight, and max is the maximum number of such type of components that can be used. There are 3 power supply variants, 2 disk drive variants, and 3 memory variants.

The solution sought after is described by the schema Config(type, variant, num_used) which gives for each power, disk, and memory component, the variant used and the number of such variants used. A FIND query specifying this example problem may be formulated as follows:

| 1. | FIND Config(type, variant, intvalue AS num_used, | |
|---|---|---|
| 2. | | UNIQUE(type,variant)) |

| 3. | FROM Component, INTRANGE(0, SELECT MAX(quantity) FROM Component) | | |
|---|---|---|---|
| 4. | WHERE | (SELECT SUM(space * num_used) FROM Component cp, Config cf | |
| 5. | | WHERE | cp.type = cf.type AND cp.type = ‘disk’ AND |

| | |
|---|---|
| 6. | cp.variant = cf.variant) >= 700 |

| | | |
|---|---|---|
| 7. | AND | (SELECT SUM(space * num_used) FROM Component cp, Config cf |
| 8. | | WHERE cp.type = cf.type AND cp.type = ‘memory’ AND |

| | |
|---|---|
| 9. | cp.variant = cf.variant) >= 850 |

| | | |
|---|---|---|
| 10. | AND | (SELECT SUM(power * num_used) FROM Component cp, Config cf |
| 11. | | WHERE cp.type = cf.type AND cp.variant = cf.variant) >= 0 |
| 12. | AND | FORALL (SELECT type, max FROM Component) cp |
| 13. | | REQUIRING max >= (SELECT SUM(num_used) FROM Config cf WHERE |

| | |
|---|---|
| 14. | cp.type = cf.type) |

| | | |
|---|---|---|
| 15. | PREFERRING | (SELECT SUM(weight * num_used) |
| 16. | | FROM Component cp, Config cf |
| 17. | | WHERE cp.type = cf.type AND cp.variant = cf.variant) |

| | |
|---|---|
| 18. | LOWEST |

The FIND query may be translated to the following MX specification:

| | |
|---|---|
| 1. | Given: |
| 2. | type Type Variant Power Space Capacity Weight Max |
| | NumUsed; |
| 3. | Component(Type,Variant,Power,Space,Capacity,Weight,Max) |
| 4. | Find |
| 5. | Config(Type,Variant,NumUsed) |
| 6. | Satisfying: |
| 7. | SUM(s * u; v,p,s,c,w,m,u; Component(DISK,v,p,s,c,w,m) & |
| 8. | Config(DISK,v,u)) >= 700 |
| 9. | SUM(c * u; v,p,s,c,w,m,u; Component(MEMORY,v,p,s,c, |
| | w,m) & |
| 10. | Config(MEMORY,v,u)) >= 850 |
| 11. | SUM(p * u; t,v,p,s,c,w,m,u; Component(t,v,p,s,c,w,m) & |
| 12. | Config(t,v,u)) >= 0 |
| 13. | ! t v p s c w m : (Component(t,v,p,s,c,w,m) => (m >= |
| | SUM(u; |
| 14. | v,u; Config(t,v,u)))) |
| 15. | ! t v u1 u2>u1 : ~(Config(t,v,u1) & Config(t,v,u2)) |
| 16. | Optimizing: |
| 17. | minimum SUM(w * u; t,v,p,s,c,w,m,u; |
| | Component(t,v,p,s,c,w,m) |
| 18. | & Config(t,v,u)) |

In another example, a new column cost may be added to the table Component to store the cost of each component. In this example, in addition to minimizing the total weight, it is also desirable to minimize the total cost. This is an example of a Pareto of optimization objectives. In Preference SQL, the Pareto operator is AND. Therefore, in order to support the Pareto of optimization objectives in this example, the PREFERRING clause of the FIND query in the above example is modified to the following:

```
PREFERRING (SELECT SUM(weight * num_used)
            FROM Component cp, Config cf
            WHERE cp.type = cf.type AND cp.variant =
                        cf.variant) LOWEST
AND (SELECT SUM(cost * num_used) FROM Component cp, Config cf
    WHERE cp.type = cf.type AND cp.variant = cf.variant)
                        LOWEST
```

Now the FIND query may be translated to the following MX specification:

| | |
|---|---|
| 1. | Given: |
| 2. | type Type Variant Power Space Capacity Weight Max |
| | NumUsed; |
| 3. | Component(Type,Variant,Power,Space,Capacity,Weight,Max) |
| 4. | Find |
| 5. | Config(Type,Variant,NumUsed) |
| 6. | Satisfying: |
| 7. | SUM(s * u; v,p,s,c,w,m,u; Component(DISK,v,p,s,c,w,m) & |
| 8. | Config(DISK,v,u)) >= 700 |
| 9. | SUM(c * u; v,p,s,c,w,m,u; |
| | Component(MEMORY,v,p,s,c,w,m) & |
| 10. | Config(MEMORY,v,u)) >= 850 |
| 11. | SUM(p * u; t,v,p,s,c,w,m,u; Component(t,v,p,s,c,w,m) & |
| 12. | Config(t,v,u)) >= 0 |
| 13. | ! t v p s c w m : (Component(t,v,p,s,c,w,m) => (m >= SUM(u; |
| 14. | v,u; Config(t,v,u)))) |
| 15. | ! t v u1 u2>u1 : ~(Config(t,v,u1) & Config(t,v,u2)) |
| 16. | Optimizing: |
| 17. | minimum SUM(w * u; t,v,p,s,c,w,m,o,u; |
| 18. | Component(t,v,p,s,c,w,m,o) & |
| 19. | Config(t,v,u)) && |
| 20. | minimum SUM(o * u; t,v,p,s,c,w,m,o,u; |
| 21. | Component(t,v,p,s,c,w,m,o) & |
| 22. | Config(t,v,u)) |

In another example, the cost objective may be less important than the weight objective, i.e., a lighter but more expensive laptop is considered better than a heavier but cheaper laptop. This is an example of a prioritization of optimization objectives. In Preference SQL, the prioritization operator is PRIOR TO. Therefore, we modify the PREFERRING clause of the FIND query to the following:

```
PREFERRING (SELECT SUM(weight * num_used)
        FROM Component cp, Config cf
        WHERE cp.type = cf.type AND cp.variant =
                cf.variant) LOWEST
PRIOR TO (SELECT SUM(cost * num_used)
    FROM Component cp, Config cf
    WHERE cp.type = cf.type AND cp.variant =
                cf.variant) LOWEST
```

Now, in this example, the Optimizing section of the MX specification becomes the following:

Optimizing:

```
minimum SUM(w * u; t,v,p,s,c,w,m,o,u;
                    Component(t,v,p,s,c,w,m,o) &
                    Config(t,v,u)) >>
minimum SUM(o * u; t,v,p,s,c,w,m,o,u;
                    Component(t,v,p,s,c,w,m,o) &
                    Config(t,v,u))
```

3. Maximum Independent Set

Given a graph with some vertices and edges, the independent set problem is to find a subset of the vertices such that no two vertices in the subset are joined by an edge. Such a subset is called an independent set of the graph. The maximum independent set (MIS) problem is to find a largest independent set for a given graph.

Two database tables named Vertex and Edge may store the vertices and the edges of a graph, respectively. This example MIS problem may be formulated as the following FIND query:

| | |
|---|---|
| 1. | FIND MIS(vtx) |
| 2. | FROM Vertex |
| 3. | WHERE NOT EXISTS (SELECT * FROM Edge e, MIS m1, |
| | MIS m2 |
| 4. | WHERE e.vtx1 = m1.vtx AND e.vtx2 = m2.vtx) |
| 5. | PREFERRING (SELECT COUNT(*) FROM MIS) HIGHEST |

The FIND query may be translated to the following MX specification:

| | |
|---|---|
| 1. | Given: |
| 2. | type Vtx; |
| 3. | Edge(Vtx,Vtx) |
| 4. | Find: |
| 5. | MIS(Vtx) |
| 6. | Satisfying: |
| 7. | ! v1 v2 : ~(Edge(v1,v2) & MIS(v1) & MIS(v2)) |
| 8. | Optimizing: |
| 9. | maximum COUNT(1; v; MIS(v)) |

4. Traveling Salesman

Given a number of cities and the costs of travelling from any city to any other city, the traveling salesman problem is to find the least-cost round-trip route that visits each city exactly once and then returns to the starting city.

In this example, it is assumed that the cost of traveling from one city to another is given by the distance between the two cities. Two database tables named City and Road may store all cities in a region and the distances between cities. This example traveling salesman problem may be formulated as the following FIND query:

| | |
|---|---|
| 1. | FIND TravelPlan(c1.name AS name1 COMPLETE, c2.name AS |
| | name2 UNIQUE) |
| 2. | Permutation(c1.name COMPLETE, intvalue AS num UNIQUE) |
| 3. | FROM City c1, City c2, INTRANGE(1, SELECT COUNT(*) |
| | FROM City) |
| 4. | WHERE (FORALL (SELECT * FROM TravelPlan) tp |
| 5. | REQUIRING EXISTS (SELECT * FROM Road r |
| 6. | WHERE (r.name1 = tp.name1 AND r.name2 = |
| 7. | tp.name2) |
| 8. | OR (r.name1 = tp.name2 AND r.name2 = |
| | tp.name1)) |
| 9. | AND (FORALL (SELECT * FROM Permutation) p1 |
| 10. | REQUIRING EXISTS (SELECT * FROM Permutation p2, |
| 11. | TravelPlan tp |
| 12. | WHERE CYCLIC_SUCC(p2.pos.p1.pos) |
| 13. | AND tp.name1 = p1.name |
| 14. | AND tp.name2 = p2.name)) |
| 15. | PREFERRING (SELECT SUM(distance) FROM Road r, |
| | TravelPlan tp |
| 16. | WHERE (r.name1 = tp.name1 AND r.name2 = |
| | tp.name2) |
| 17. | OR (r.name1 = tp.name2 AND r.name2 = tp.name1)) HIGHEST |
| 18. | |
| 19. | |

The FIND query can be translated to the following MX specification:

| | |
|---|---|
| 1. | Given: |
| 2. | type CityName Distance Number: |
| 3. | Road(CityName,CityName,Distance) |
| 4. | Find: |
| 5. | TravelPlan(City,City) |
| 6. | Permutation(City,Number) |
| 7. | Satisfying: |
| 8. | ! c1 c2 : (TravelPlan(c1,c2) => (Road(c1,c2) \| Road(c2,c1))) |
| 9. | ! c1 n1 : (Permutation(c1,n1) => |
| 10. | ? c2 n2 : (Permutation(c2,n2) & |
| | TravelPlan(c1,c2) & |
| 11. | (SUCC(n2.n1) \| (n2 = MAX & n1 = MIN)))) |
| 12. | ! c1 : ? c2 : TravelPlan(c1,c2) |
| 13. | ! c1 c2>c1 c3 : ~(TravelPlan(c1,c3) & TravelPlan(c2,c3)) |
| 14. | ! c : ? n : Permutation(c,n) |
| 15. | ! c1 c2>c1 n : ~(Permutation(c1,n) & Permutation(c2,n)) |
| 16. | Optimizing: |
| 17. | minimum SUM(d; c1,c2,d; Travelplan(c1,c2) & (Road(c1,c2,d) \| |
| 18. | 20.Road(c2,c1,d))) |
| 19. | |

5. Weighted MAX-3-SAT

SAT is the problem of determining if the variables of a given Boolean formula can be assigned in such a way as to make the formula evaluate to true. MAX-SAT is an optimization version of SAT in which the objective is to maximize the number of clauses that can be satisfied by any assignment. A common variant of MAX-SAT is weighted MAX-SAT, where each clause is associated with a numeric weight and the objective is to maximize the total weight of the satisfied clauses. Weighted MAX-3-SAT is a subclass of weighted MAX-SAT in which each clause has exactly three literals (variables or negated variables).

For this example, it is assumed that each clause in a MAX-3-SAT instance is associated with a nonnegative weight. Those with a weight of zero must be satisfied. A table named Clause may store the clauses in the given formula. Clause has the schema Clause(var1, sign1, var2, sign2, var3, sign3, weight), where var? give the variables in the clause, sign? give their signs, and weight gives the weight of the clause. This example weighted MAX-3-SAT problem may be formulated as the following FIND query:

| | |
|---|---|
| 1. | FIND Assignment(var UNIQUE COMPLETE, sign) |
| 2. | FROM Clause |
| 3. | WHERE FORALL (SELECT * FROM clause WHERE weight = 0) c |
| 4. | REQUIRING EXISTS (SELECT * FROM Assignment a |
| 5. | WHERE (a.var = c.var1 AND |
| | a.sign = c.sign1) |
| 6. | OR (a.var = c.var2 AND a.sign = c.sign2) |
| 7. | OR (a.var = c.var3 AND a.sign = c.sign3) |
| 8. | PREFERRING (SELECT SUM(weight) FROM Clause |
| | c. Assignment a |
| 9. | WHERE (a.var = c.var1 AND a.sign = c.sign1) |
| 10. | OR (a.var = c.var2 AND a.sign = c.sign2) |
| 11. | OR (a.var = c.var3 AND |
| | a.sign = c.sign3)) HIGHEST |

The FIND query may be translated to the following MX specification:

| | |
|---|---|
| 1. | Given: |
| 2. | type Var Sign Weight |
| 3. | Clause(Var,Sign,Var,Sign,Var,Sign,Weight) |
| 4. | Find: |
| 5. | Assignment(Var,Sign) |
| 6. | Satisfying: |
| 7. | ! v1 s1 v2 s2 v3 s3 : |
| 8. | (Clause(v1,s1,v2,s2,v3,s3,0) => |
| 9. | (Assignment(v1,s1) \| Assignment(v2,s2) \| |
| | Assignment(v3,s3))) |
| 10. | ! v s1 s2>s1 : ~(Assignment(v,s1) & Assignment(v,s2)) |
| 11. | ! v : ? s : Assignment(v,s) |
| 12. | Optimizing: |
| 13. | maximum SUM(w; v1,s1,v2,s2,v3,s3,w; |
| 14. | Clause(v1,s1,v2,s2,v3,s3,w) & |
| 15. | (Assignment(v1,s1) \| Assignment(v2,s2) \| |
| | Assignment(v3,s3))) |
| 16. | |
| 17. | |

6. SONET Configuration

A SONET communication network may comprise a number of rings, each joining a number of computers. In this example, a computer may be installed on a ring using an add-drop multiplexer (ADM) and there may be a capacity bound on the number of ADMs that can be installed on a ring. Each computer can be installed on more than one ring. Communication can be routed between a pair of computers only if both are installed on a common ring. Given the capacity bound and a specification of which pairs of computers must communicate, the problem is to allocate a set of computers to each ring so that the given communication demands are met and the number of computers in each ring is no more than the capacity bound. In this example, the objective is to minimize the number of ADMs used.

Two database tables named Computer and Demand may store the computers and the communication demands, respectively. This example SONET configuration problem may be formulated as the following FIND query:

| | |
|---|---|
| 1. | FIND Network(computer_id, intvalue AS ring_id) |
| 2. | FROM Computer, INTRANGE(1, SELECT COUNT(*) FROM |
| | Computer) |
| 3. | WHERE (FORALL (SELECT * FROM Demand) d |
| 4. | REQUIRING EXISTS (SELECT * FROM Network n1, |
| | Network n2 |
| 5. | WHERE d.computer_id1 = n1.computer_id |
| 6. | AND d.computer_id2 = n2.computer_id |
| 7. | AND n1.ring_id = n2.ring_id)) |
| 8. | AND B >= ALL (SELECT COUNT(*) FROM Network GROUP BY |
| | ring_id) |
| 9. | PREFERRING (SELECT MAX(ring_id) FROM Computer) |
| | LOWEST |

The FIND query may be translated to the following MX specification:

| | |
|---|---|
| 1. | Given: |
| 2. | type ComputerID RingID |
| 3. | Demand(ComputerID.ComputerID) |
| 4. | Find: |
| 5. | Network(ComputerID,RingID) |
| 6. | Satisfying: |
| 7. | ! c1 c2 : (Demand(c1,c2) => ? r : (Network(c1,r) & |
| | Network(c2.r))) |
| 8. | ! r c1 : (Network(c1,r) => (COUNT(1; c2; Network(c2,r)) <= |
| | B)) |
| 9. | Optimizing: |
| 10. | minimum COUNT(1; c,r; Network(c,r)) |
| 11. | |
| 12. | |

The symbol B in the above FIND query and MX specification of this example SONET problem represents the capacity bound.

Transformations of an Intermediate Language

As discussed previously, a significant advantage of translating a data query language, such as SQL extended with FIND, into an intermediate language (e.g., such as one based on first order logic, etc.) is that the intermediate representation may be more conveniently transformed and adapted for improved performance. In this section we provide examples of two classes of such transformations. The first class of transformations may be referred to as logical rewriting. In logical rewriting, rules are applied to rewrite one logical expression into another equivalent expression that may be more easily solved by solvers. The second class of transformations allow for the use of specialized solvers, such as solvers that are specialized for certain classes of problems. Recognizing these classes is much simpler once a search problem is expressed in an intermediate language.

In some embodiments, a problem expression in an intermediate language, such as an intermediate mathematical language, may be rewritten such that the problem becomes easier to solve. For example, in one embodiment, where search problems in a DQL are translated to intermediate problem expressions based on first order logic, such as a problem expression in MX, appropriate simplifications may be made to the formulas in the MX problem specification to make the problem easier to solve. Such simplifications may include, for example, removing redundant variables, setting bounds for variables, rewriting negations, removing redundant relations, and constraint handling rules, etc.

In some embodiments, a problem expressed in an intermediate first order logic language may be simplified by removing redundant variables. For example, in an existential quantification Φ, if the condition is a conjunction, and one of the conjuncts is an equality v=e or e=v, where v is a variable quantified in Φ and e is a constant or a variable, then all occurrences of v in Φ can be replaced by e, and the equality v=e or e=v can be discarded. For example, the formula

∃v₁v₂v₃(R(v₁, v₂, v₃) [symbol] v₁=v₂)

may be simplified as

∃v₁v₃R(v₁, v₁, v₃).

As another example, the formula

∃v₁v₂v₃(R(v₁, v₂, v₃) [symbol] v₂=x [symbol] v₃=CONST)

may be simplified as

∃v₁R(v₁, x, CONST).

In some embodiments, a problem expressed in an intermediate first order logic language may be simplified by setting bounds for variables. For example, in an existential quantification Φ, if the condition is a conjunction, and one of the conjuncts is an inequality v>e or e<v, where v is a variable quantified in Φ and e is a constant or a variable quantified before v, then e can be set as the bound of v, and the inequality v>e or e<v can be discarded. For example, the formula

∃v₁v₂v₃v₄(R(v₁,v₂,v₃) [symbol] R(v₁,v₄,v₃) [symbol] v₄>v₂)

may be simplified as

∃v₁v₂v₃v₄>v₂(R(v₁,v₂,v₃) [symbol] R(v₁,v₄,v₃)).

In this simplified formula, the variable V4 is bounded by v₂.

By setting a bound on a quantified variable, the number of values that need to be enumerated for the variable may be limited. This results in a more efficient processing of the entire formula. The simplification scheme also applies to inequalities involving <, ≧, ≦ and ≠.

In addition, in some embodiments, a problem expressed in an intermediate first order logic language may be simplified by rewriting negations. For example, in some embodiments, the following rewriting procedures may be performed to negations:

[symbol]

Φ₁ [symbol] Φ₂) to Φ₁ [symbol] Φ₂

[symbol]

Φ₁ [symbol] :Φ₂) to Φ₁ [symbol] Φ₂

[symbol]

(Φ₁→ [symbol] Φ₂) to Φ₁ [symbol] ₂

[symbol]

(e₁=e₂) to e₁≠e₂

[symbol]

(e₁≠e₂) to e₁≠e₂

[symbol]

(e₁>e₂) to e₁≦e₂

[symbol]

(e₁<e₂) to e₁≧e₂

[symbol]

(e₁≧e₂) to e₁<e₂

[symbol]

(e₁≦e₂) to e₁>e₂

[symbol]

v₁ . . . vₙΦ to ∀v₁ . . . vₙΦ

[symbol]

v₁ . . . vₙΦ to ∀v₁ . . . vₙΦ

The symbols Φ₁, Φ₂ and Φ are formulas, while e₁ and e₂ are variables or constants. The rewriting procedures listed above aim at reducing the length of a formula by reducing the number of negations in it.

In addition, in some embodiments, a problem expressed in an intermediate first order logic language may be simplified by removing redundant relations. For example, if a relation is a unary instance relation interpreted on a type t, and the number of tuples in the relation is equal to the number of elements in t, then for each element e in t, e is a tuple in the relation. In this case, the relation may be removed from the first order logic expression, such as the MX specification. Any atom of that relation may be replaced by T (true). For example, consider the following formula:

∀v(P(v)→∃uR(u,v)).

If P is an instance relation interpreted on a type t, and the number of tuples in P is equal to the number of elements in t, then the formula may be simplified as

∀v(T→∃uR(u,v))

which is equivalent to

∀v(∃uR(u,v)).

As previously noted, translating a search problem in a DQL to a problem in an intermediate language may facilitate the use of specialized solvers to improve performance of solving problems. Optimization algorithms are often specialized to a certain class of problems for best performance. Thus, in some embodiments, a suite of optimization solvers may be provided to solve different classes of problems. For example problems involving permutations like scheduling are very different from problems defined on networks. Solvers have been developed for each class. Solvers have also been constructed which are specially adapted to treating certain types of constraints. Recognizing such problem types is dramatically simpler in a formal intermediate language (e.g., a first order logic language, etc.), rather than in the high level human-readable data query language.

In addition, symmetries may commonly occur in optimization problems. For example, if variables X and Y both assume one of the values {small, large}, and the constraint X≠Y then there are two solutions (X=small, Y=large) and (X=large, Y=small). This redundancy is due to a symmetry that there is no other distinction between small and large. Such symmetries may make solving a problem dramatically more difficult. However, using a formal intermediate language, in some cases, allows such symmetries to be recognized automatically and then exploited for faster solution.

It will be appreciated that the foregoing transformations are merely illustrative, and other transformations may be employed in other embodiments such that an intermediate problem expression may be transformed to improve performance of solving search problems.

Bytecode Representation of MX

In some embodiments, a search problem expressed in an intermediate problem expression, such as a problem expressed in an intermediate mathematical language (e.g., MX, etc.) may be transformed into a more space efficient form, such as a bytecode representation of the problem expressed in the intermediate mathematical language. Such a representation may allow for, for example, more efficient transmission over a network, and may be interpreted efficiently by a solver, a grounder, etc.

In the following illustrative example, one embodiment of how an intermediate problem expressed in a mathematical language may be represented as a bytecode is provided with respect to MX. It will be apparent that the techniques described with respect to the bytecode representation of MX may used in many situations where it is desirable to represent MX problems in a space efficient form and not just with respect to the embodiments disclosed herein. In addition, although the following example embodiment is described with respect to MX, in other embodiments, other mathematical languages may be similarly represented in accordance with the described techniques.

As previously discussed, the model expansion (MX) syntax consists of two parts: problem description and instance description.

First, the problem description is described.

In this embodiment, a 32-bit bytecode representation of the problem description will start with a header, which contains relevant information about the structure of the remainder. An MX problem description has three sections: Given, Find, and Satisfying, and in this embodiment, the bytecode is structured accordingly. For example, the bytecode has three main sections, the starting offset of which may be stored in the header. Additionally, a symbol table may be provided with the following high-level file structure:

| | | | | |
|---|---|---|---|---|
| Header | Symbols | Given | Find | Satisfying. |

The last byte of the file is the trailer for the file. In some embodiments, this may be used to denote whether the file is a problem or instance description (0 or 1 respectively).

The following table shows an example of a header:

Header

| Offset | Size (B) | Description |
|---|---|---|
| 0x00000000 | 16 | MD5 Hash of bytes 0x00000010-end |
| 0x00000010 | 4 | Offset to symbol table (usually 0x30) |
| 0x00000014 | 4 | Size of symbol table (B) |
| 0x00000018 | 4 | Offset to Given section |
| 0x0000001c | 4 | Size of Given section (B) |
| 0x00000020 | 4 | Offset to Find section |
| 0x00000024 | 4 | Size of Find section (B) |
| 0x00000028 | 4 | Offset to Satisfying section |
| 0x0000002c | 4 | Size of Satisfying section (B) |

In some embodiments, the symbol table may be a lookup table that includes explicit and implicit symbols. A symbol is explicit when it is declared in the Given or Find sections of the problem specification and is implicit when it is declared in the Satisfying section by a quantifier.

Each entry in the lookup table may consist of an unsigned 8-bit integer length (i.e., the length of the symbol) followed by a string of single-byte ASCII characters representing the symbol's name:

| | |
|---|---|
| length | string. |

A symbol may then be referenced elsewhere by substituting for it its offset into the table, which may be referred to as its symbol entry or simply symbol. For example, if a relation, someTable, is stored at offset 0x0000abcd, then the offset 0x0000abcd would be used in place of someTable in the remainder of the bytecode, and the information stored in the symbol table starting at offset 0x0000abcd may be: 09 73 6f 6d 65 54 61 62 6c 65 (e.g., the first byte “09” indicates the length of the string is 9 characters, and remaining bytes are “someTable” in ASCII). The original symbol may be retrieved by, starting to the symbol offset plus the symbol table offset, reading the byte storing the length of the symbol, n, and then reading the subsequent n bytes, or ASCII characters.

It will be appreciated that although this example uses an ASCII character set, the bytecode description could easily be modified to support other character sets, such as, for example, Unicode. In addition, although the previous example limits the length of the symbol to 256 characters (e.g., based on the 8-bit integer length), other lengths may be used in other embodiments.

In the Given section, types, relations, and constants may be declared. For example, in MX, constants are of the form: c: t. Therefore, the constants table, starting at byte 0x20 of the Given section, may be a list of symbol pairs: (constant symbol, type symbol).

Types are given in MX as a space separated list of names following the keyword type and terminating in a semi-colon. The corresponding type list in the bytecode representation may be a list of symbol entries. In addition, each relation in MX is of the form: relation(types, . . . ). This may be represented in the bytecode as a relation symbol followed by a list of type symbols, accompanied by an unsigned 8-bit integer for the number of type symbols; that is, the arity of the relation. The relation entry then can be of the form: (table symbol, arity, type symbols, . . . ). For example,

| Entry | Form |
|---|---|
| Constants | (constant symbol, type symbol) |
| Type | (type symbol) |
| Relation | (arity, table symbol, type symbols, . . . ) |

The following table describes an example of how the Given section may be structured in some embodiments:

Given Section

| Offset | Size (B) | Description |
|---|---|---|
| 0x00000000 | 4 | Offset to type entries |
| 0x00000004 | 4 | Total size of type entries (B) |
| 0x00000008 | 4 | Offset to relation entries |
| 0x0000000c | 4 | Total size of relation entries (B) |
| 0x00000010 | 4 | Size of constants table (B) |
| 0x00000014 | 12 | EMPTY |
| 0x00000020 | ? | Constants table |
| 0x???????? | ? | Type list |
| 0x???????? | ? | Relation list |

The Find section declares the expansion relations to find. This is simply a list of relations like those of the Given section; hence, each may be expressed in the form: (table symbol, arity, type symbols, . . . ).

The satisfying section supports qualifiers over relations as well as first-order-logic and binary-comparison operators. Each operator is assigned an opcode, for example:

| Opcode | MX Symbol | Operator | # Operands |
|---|---|---|---|
| 0x01 | ? | ∃ | ? |
| 0x02 | ! | ∀ | ? |
| 0x03 | & | [symbol] | 2 |
| 0x04 | \| | [symbol] | 2 |
| 0x05 | ~ | [symbol] | 1 |
| 0x06 | => | → | 2 |
| 0x11 | = | = | 2 |
| 0x12 | ~= | ≠ | 2 |
| 0x13 | > | > | 2 |
| 0x14 | < | < | 2 |
| 0x15 | >= | ≧ | 2 |
| 0x16 | <= | ≦ | 2 |

All operators act upon symbols described in the symbol table. However, the ∃ and ∀ operators declare variables that do not have corresponding entries in the symbol table. This may be remedied, in one embodiment, by generating unique temporary symbols in the symbol table for each quantified variable. Furthermore, these two operators have an unspecified number of operands. Therefore, directly following this byte will be a 8-bit integer value specifying the number of operands it acts upon.

As well, most of the operators can take not only qualified variables as operands but relations as well. In this case, a reference to a relation may be considered to be of the form: (relation symbol, arg1 symbol, . . . , argn symbol, where the number of arguments must match the declared arity of the relation.

In addition, an entry in the satisfying section may be stored using standard prefix notation, where a relation (relation symbol, arg1 symbol, . . . , argn symbol) may be considered to be an operand. For example,

∃xy, x<y

becomes, in MX:

!xy: x<y

and, may be represented in a bytecode (assuming that the relevant operator occurs at 0x00001234 and the temporary symbols start at 0x0000aaaa) as follows:
0x00001234: 02 00 00 ad aa 00 00 aa ac 14 00 00 aa aa 00 00 ad ac
0x0000aaaa: 01 78 01 79

As one illustrative example of representing an MX problem in a bytecode as described above, a graph coloring problem in MX may be expressed as follows:

### Given:

type Vertex, Color;

Edge(Vertex, Vertex)

### Find:

Coloring(Vertex, Color)

### Satisfying:

!x y z: ˜(Edge(x, y) & Coloring(x, z) & Coloring(y, z))

! x: ? y: Coloring(x,y)

!x y1 y2: ˜(Coloring(x,y1) & Coloring(x,y2) & y1<y2)

After converting this problem expression to the described bytecode, the following bytecode may result:

| | |
|---|---|
| 0000:0000 2f 28 bf 8c 7e e2 8b 55 93 b4 7c d3 64 41 49 07 | /( .~ .U. \| dAI. |
| 0000:0010 00 00 00 30 00 00 00 35 00 00 00 65 00 00 00 35 | ...0...5...e...5 |
| 0000:0020 00 00 00 9a 00 00 00 0d 00 00 00 a7 00 00 00 87 | ........... .... |
| 0000:0030 06 56 65 72 74 65 78 06 43 6f 6c 6f 75 72 04 45 | .Vertex.Color.E |
| 0000:0040 64 67 65 09 43 6f 6c 6f 75 72 69 6e 67 02 78 31 | dge.Coloring.x1 |
| 0000:0050 02 78 32 02 78 33 02 78 34 02 78 35 02 78 36 02 | .x2.x3.x4.x5.x6. |
| 0000:0060 78 37 02 78 38 00 00 00 20 00 00 00 08 00 00 00 | x7.x8... ....... |
| 0000:0070 8d 00 00 00 0d 00 00 00 00 ff ff ff ff ff ff ff | ......... |
| 0000:0080 ff ff ff ff ff 00 00 00 30 00 00 00 37 00 00 00 | ...0...7... |
| 0000:0090 3e 02 00 00 00 30 00 00 00 30 00 00 00 43 02 00 | >....0...0...C.. |
| 0000:00a0 00 00 30 00 00 00 37 00 00 00 34 02 00 00 00 4d | ..0...7...4....M |
| 0000:00b0 00 00 00 50 00 00 00 53 05 03 03 00 00 00 3e 00 | ...P...S......>. |
| 0000:00c0 00 00 4d 00 00 00 50 00 00 00 43 00 00 00 4d 00 | ..M...P...C...M. |
| 0000:00d0 00 00 53 00 00 00 43 00 00 00 50 00 00 00 53 00 | ..S...C...P...S. |
| 0000:00e0 00 00 16 02 00 00 00 56 01 00 00 00 59 00 00 00 | .......V....Y... |
| 0000:00f0 43 00 00 00 56 00 00 00 59 00 00 00 31 02 00 00 | C...V...Y...1... |
| 0000:0100 00 5c 00 00 00 5f 00 00 00 62 05 03 14 03 00 00 | .♯..._...b...... |
| 0000:0110 00 43 00 00 00 5c 00 00 00 5f 00 00 00 43 00 00 | .C...♯..._...C.. |
| 0000:0120 00 5c 00 00 00 62 00 00 00 5f 00 00 00 62 00 | .♯...b..._...b. |

Next, the instance description is described.

The instance description defines the types, relations, and constants declared in the problem description. That is, it provides an instantiation of the types, relations, and constants declared in the problem description. For example, in the graph coloring problem described above, a type Vertex and a relation Edge are declared. In the instance description, the actual graph, given by its vertices and edges, may be provided.

The format of the file may consist of a header, body, and trailer, where the last byte of the file is the trailer, which may be used, for example, to denote whether the file is a problem or instance description (e.g., such as denoted by a 0 or 1, respectively).

An example header may be structured as follows:

Header

| Offset | Size (B) | Description |
|---|---|---|
| 0x00000000 | 16 | MD5 Hash of bytes 0x00000010- |
| | | end |
| 0x00000010 | 4 | Offset to symbol table (usually 0x20) |
| 0x00000014 | 4 | Size of symbol table (B) |
| 0x00000018 | 4 | Offset to Instance section |
| 0x0000001c | 4 | Size of Instance section (B) |

Every type, constant, and relation for the instance must have its symbol entered in the body section of the instance file. In one embodiment, every type, constant, and relation will consist of an unsigned 8-bit integer length (ie, the length of the symbol) followed by a string of single-byte ASCII characters representing the symbol's name:

| | |
|---|---|
| length | string. |

Furthermore, data which occur frequently in the instance data may also be stored in the symbol table. For example, if the name “John Smith” appears more then twice, it is more space efficient to create an 11 byte symbol entry—10 4A 6F 68 6E 20 53 6D 69 74 68—and then use the 4 byte address to represent it elsewhere in the instance description.

The body of the instance description may consist of a series of sections, each describing a type, constant, or relation and may be of the form:

| | | |
|---|---|---|
| symbol | length | data, |

where symbol is the offset into the symbol table, length is the number of bytes this entry uses in the data section, and data is the data in a form as described above.

When parsing the description, it may be necessary to be able to determine whether the datum is an address into the symbol table or simply a string of characters or numeric. This may be done by prefacing each datum with a byte denoting the contents of the entry. The following table describes the opcodes describing the contents:

Datum Contents

| Opcode | Description |
|---|---|
| 0x01 | Symbol address |
| 0x10 | Numeric mask |
| 0x11 | 8-bit Integer |
| 0x12 | 16-bit Integer |
| 0x13 | 32-bit Integer |
| 0x14 | 64-bit Integer |
| 0x15 | 32-bit Floating point |
| 0x16 | 64-bit Floating point |
| 0x20 | String mask |
| 0x21 | ASCII string (8-bit) |
| 0x22 | UTF-16 string (16-bit) |
| 0x23 | UTF-32 string (32-bit) |

For example, if the type is a string (e.g., the 0×20 bit is set), it may be immediately followed by a byte denoting its length n (in characters) and that is immediately followed by the string of the appropriate characters of length n.

An example instance description for the graph coloring problem described above may include the following instance data:

### Vertex=[1; 2; 3; 4; 5]

### Edge={1.2; 2.3; 4.3; 1.4; 5.4}.

After converting the data to the bytecode described above, the following bytecode may result:

| 0000:0000 79 b4 59 d6 2f 38 ee 6c 6a 17 5b 67 dd b3 e3 9e | yY/81j.[g. |
|---|---|
| 0000:0010 00 00 00 20 00 00 00 0c 00 00 00 2c bb bb bb bb | ... ......., |
| 0000:0020 06 56 65 72 74 65 78 04 45 64 67 65 00 00 00 20 | .Vertex.- |
| | Edge... |
| 0000:0030 00 00 00 0f 21 01 31 21 01 32 21 01 33 21 01 34 | ....!.1! |
| | .2!.3!.4 |
| 0000:0040 21 01 35 00 00 00 27 00 00 00 1e 21 01 31 21 01 | !.5...’ |
| | ....!.1!. |
| 0000:0050 32 21 01 32 21 01 33 21 01 34 21 01 33 21 01 31 | 2!.2!.3! |
| | .4!.3!.1 |
| 0000:0060 21 01 34 21 01 35 21 01 34 01 | !.4!.5!.4. |

In some embodiments, given the description of a bytecode for an MX problem description, simple obfuscation may be achieved by a hash of the symbol table. For example, for every symbol in the symbol table, generate a random n-character alphanumeric string to replace its actual name, where n is sufficiently large. Obviously, any obfuscation of this sort would have to be applied to a corresponding instance description in precisely the same fashion.

It will be appreciated that although the previous description uses 32-bit integers in most places, in other embodiments, 16-bit integers may be used.

In some embodiments, generating a bytecode representation from a MX file may be achieved by parse the MX file from top to bottom, and constructing a symbol table as it goes.

In addition, in some embodiments, a search problem expressed in a data query language may be translated into an intermediate problem expression in MX, which may then be further translated into a bytecode representation, such as, for example, to allow for rapid transmission of the intermediate problem expression over a network, such as the Internet.

In addition, in some embodiments, a bytecode representation of a problem expressed in MX may be parsed in a single pass from beginning to end. First, the symbol table may be read and stored in memory such that there is an entity for each symbol of the appropriate type. Next, these entities may be filled by processing the Given and Find sections. After this is done, these entities will now contain all the information necessary to process the remaining Satisfying section.

Mapping Extended MX to Integer Programming

As previously noted, in some embodiments, a search problem in an intermediate language, such as a first order logic language, may be further translated into one or more other languages, such as, for example Integer Programming. In the following example embodiments, an illustrated embodiment of how MX extended to support optimizations (e.g., arithmatics, aggregates, etc.), as described elsewhere, may be mapped to integer programming is provided.

First, an example of mapping MX extended with arithmetics to integer programming is described.

Let R be an expansion relation with columns c₁, . . . , cₙ, and let c₁, . . . , cₙ range over domains D₁, . . . , Dₙ, respectively. Suppose for some i between 1 and n, Dᵢ is infinite. This means the size of R, (e.g., the number of tuples in R) could be infinite. If an MX specification has an expansion relation whose size could be infinite, then it may not solvable.

However, there is at least one case where the size of R is finite, even though one of its columns ranges over an infinite domain. Suppose for all l≠i, Dₗ is finite. Let D_{\i} denote the set D₁× . . . ×Dᵢ₋₁×Dᵢ₊₁× . . . ×Dₙ. Let c denote columns c₁, . . . , cₙ. If columns c \ {cᵢ} are unique, then the size of R is bounded by the size of D_{\i}, which is finite. To translate an MX specification with R to an integer program, a binary variable xₐ_{₁}_{, . . . a}_{_{i−1}}_{, a}_{ᵢ₊₁}, . . . a_{ₙ} for each tuple (a₁, . . . , aᵢ₋₁,aᵢ₊₁, . . . , aₙ) in D_{\i} may be introduced. The binary variable is 1 if R has a tuple (a₁, . . . , aₙ) and is 0 otherwise, where aᵢ is in Dᵢ. In addition, a numeric variable yₐ_{₁}_{, . . . , a}_{_{i−1}}_{, a}_{ᵢ₊₁}_{, . . . , a}ₙ ranging over Dᵢ may be provided. If xₐ_{₁}_{, . . . , a}_{_{i−1}}_{, a}_{ᵢ₊₁}_{, . . . , a}_{ₙ} is 1, then the value of yₐ_{₁}_{, . . . , a}_{_{i−1}}_{, a}_{ᵢ₊₁}_{, . . . , a}_{ₙ}.

During the translation, if an atom of the form R(v₁, . . . , vₙ) is encountered in a formula, where v₁, . . . , vₙ are variables, all n variables are instantiated, except vᵢ, to each tuple (a₁, . . . , aᵢ₋₁, aᵢ₊₁, . . . , aₙ) in D_{\i}. The resulting atom R(a₁, . . . , aᵢ₋₁, vᵢ, aᵢ₊₁, . . . , aₙ) is mapped to the binary variable xₐ_{₁}_{, . . . a}_{_{i−1}}_{, a}_{ᵢ₊₁}_{, . . . , a}ₙ, and each occurrence of vᵢ in the formula is mapped to the numeric variable yₐ_{₁}_{, . . . , a}_{_{i−1}}_{, a}_{ᵢ₊₁}_{, . . . , a}ₙ.

Suppose for some j≠i, Dⱼ is also infinite. Let D_{\}_{i,j} denote the set D₁× . . . ×Dᵢ₋₁×Dᵢ₊₁× . . . ×Dⱼ₋₁×Dⱼ₊₁× . . . ×Dₙ. If columns c\{cᵢ, cⱼ} are unique, then the size of R is bounded by the size of D_{\i,j}, which is finite. A binary variable xₐ_{₁}_{, . . . , a}_{ᵢ₌₁}_{, a}_{ᵢ₊₁}_{, . . . , a}_{_{j−1}}_{, a}_{ⱼ₊₁}_{, . . . a}_{ₙ} may be introduced for each tuple (a₁, . . . , aᵢ₋₁, aᵢ₊₁, . . . , aⱼ₋₁, aⱼ₊₁, . . . , aₙ) in D_{\i,j}. The binary variable is 1 if R has a tuple (a₁, . . . , aₙ) and is 0 otherwise, where aᵢ is in Dᵢ and aⱼ is in Dⱼ. Two numeric variables yₐ_{₁}_{, . . . , a}_{ᵢ₌₁}_{, a}_{ᵢ₊₁}_{, . . . , a}_{_{j−1}}_{, a}_{_{j+1 . . . a}}ₙ and zₐ_{₁}_{, . . . , a}_{ᵢ₌₁}_{, a}_{_{i+1, . . . a}}_{_{j−1}}_{, a}_{_{j+1, . . . a}}_{ₙ} ranging over Dᵢ and Dⱼ, respectively, are also introduced. If xₐ_{₁}_{, . . . , a}_{ᵢ₌₁}_{, a}_{ᵢ₊₁}_{, . . . a}_{_{j−1}}_{,a}ⱼ₊₁_{, . . . a}_{ₙ} is 1, then the value of yₐ_{₁}_{, . . . , a}_{ᵢ₌₁}_{, a}ᵢ₊₁_{, . . . a}_{_{j−1}}_{, a}_{ⱼ₊₁}_{, . . . a}_{ₙ} is aᵢ, and that of zₐ_{₁}_{, . . . , a}_{ᵢ₌₁}_{, a}_{ᵢ₊₁}_{, . . . a}_{_{j−1}}_{, a}_{ⱼ₊₁}_{, . . . a}ₙ is aⱼ.

Cases where more than two of D₁, . . . , Dₙ are infinite are similar. In general, if some columns of an expansion relation range over infinite domains, the other columns of the relation are required to be unique so that the relation is guaranteed to be finite.

Some numeric domains are finite. For example, the domain of all integers between 1 and 100 is finite. Using the expansion relation R as an example, suppose Dᵢ is a finite numeric domain. If columns c\{cᵢ} are unique, the translation may be done in the same way as Dᵢ is infinite. If c\{cᵢ} are not unique, then a binary variable xₐ_{₁}_{, . . . , a}_{ₙ} for each tuple (a₁, . . . , aₙ) in D₁× . . . ×Dₙ is introduced. The binary variable is 1 if R has a tuple (a₁, . . . , aₙ) and is 0 otherwise. This translation scheme requires only binary variables and works no matter whether c\{cᵢ} are unique because D₁, . . . , Dₙ are finite. However, using a mixture of binary and numeric variables whenever possible may lead to a faster translation and an integer program with fewer variables.

An example embodiment of mapping MX extended with aggregates to integer programming is now described.

Given an aggregate expression MAX(ƒ( x̅); x̅; Φ( x̅)), a binary variable z _{x̅} for each instantiation of variables x̅ may be defined as follows:

z _{x̅}:=[Φ( x̅) [symbol] Null(ƒ( x̅)) [symbol] ∃ y̅( y̅≠ x̅ [symbol] Φ( y̅) [symbol] Null(ƒ( y̅)) [symbol] z _{y̅}) [symbol] ∃ w̅(Φ( w̅) [symbol] Null(ƒ( w̅)) [symbol] ƒ( w̅)>ƒ( x̅))]

where [p] is the indicator function which is 1 if the formula p is true and 0 otherwise. The MAX expression may be represented as

$${\sum }_{\tilde{x}} ( {z}_{\tilde{x}} * translate ( f ( \tilde{x} ) ) ) .$$

The notation translate (ƒ( x̅)) denotes the translation of ƒ( x̅) to an integer programming expression. ƒ( x̅) is an expression composed of constants, variables and arithmetic operators. The translation of ƒ( x̅) can be roughly defined as follows:

If ƒ( x̅) is a constant, translate(ƒ( x̅)) is a constant in integer programming with the same value as ƒ( x̅).

If ƒ( x̅) is a variable, then there are two cases: (1) If ƒ( x̅) is instantiated to some constant value a, translate (ƒ( x̅)) is the same as ƒ( x̅) is a constant with the value a. (2) If ƒ( x̅) is left uninstantiated, translate (ƒ( x̅)) is a numeric variable in integer programming.

If ƒ( x̅) is a unary arithmetic operation op g( x̅), where op is a unary arithmetic operator, translate(ƒ( x̅)) is op translate (g( x̅)).

If ƒ( x̅) is a binary arithmetic operation ƒ₁( x̅) op f₂( x̅), where op is a binary arithmetic operator, translate(ƒ( x̅)) is translate(ƒ₁( x̅)) op translate(ƒ₂( x̅)).

The formula in the indicator function may be translated to a set of propositional disjunctive clauses. Let the set of clauses be ClauseSet. Then the definition of z _{x̅} may be represented by the logical equivalence z _{x̅} [symbol] ClauseSet.

MIN is handled the same way as MAX, except that in the definition of z _{x̅}, the greater-than operator in ƒ( w̅)>ƒ( x̅) is be changed to the less-than operator.

Given an aggregate expression COUNT(ƒ( x̅); x̅; Φ( x̅)), a binary variable z _{x̅} for each instantiation of variables x̅ may be defined as follows:

z _{x̅}:=[Φ( x̅) [symbol] Null(ƒ( x̅))].

The COUNT expression may be represented as

$${\sum }_{\tilde{x}} {z}_{\tilde{x}} .$$

Given an aggregate expression is DCOUNT(ƒ( x̅); x̅;Φ( x̅)), the definition of z _{x̅} may be changed to the following:

z _{x̅}:=[Φ( x̅) [symbol] Null(ƒ( x̅)) [symbol] ∃ y̅( y̅≠ x̅ [symbol] Φ( y̅) [symbol] Null(ƒ( y̅)) [symbol] z _{y̅})].

Given an aggregate expression SUM(ƒ( x̅); x̅;Φ( x̅)), a binary variable z _{x̅} for each instantiation of variables x̅ may be defined as follows:

z _{x̅}:=[Φ( x̅) [symbol] Null(ƒ( x̅))].

The SUM expression may be represented as

$${\sum }_{\tilde{x}} ( {z}_{\tilde{x}} * translate ( f ( \tilde{x} ) ) ) .$$

Given an aggregate expression is DSUM(ƒ( x̅); x̅; Φ( x̅)), the definition of z _{x̅} may be changed to the following:

z _{x̅}:=[Φ( x̅) [symbol] Null(ƒ( x̅)) [symbol] ∃ y̅( y̅≠ x̅ [symbol] Φ( y̅) [symbol] Null(ƒ( y̅)) [symbol] z _{y̅})].

AVG may be expressed as the ratio of a SUM to a COUNT, and similarly DAVG can be expressed as the ratio of a DSUM and a DCOUNT. However, in some cases, a non-linear objective may be generated in each case.

In some embodiments, mapping an MX aggregate expression to integer programming may result in multilinear constraints in which each product term may have more than one binary variable. The standard approach to convert a multilinear constraint to one or more linear constraints is to introduce new variables representing the higher order terms and add appropriate constraints.

For example, given a term ax₁ . . . xₙ where a is a number and x₁ . . . xₙ are binary variables, x₁ . . . xₙ may be substituted with a new variable y and the following two constraints may be added:

$$( {\sum }_{i = 1}^{n} {x}_{i} ) - y \leq n - 1$$

$$( {\sum }_{i = 1}^{n} {x}_{i} ) - ny \geq 0.$$

### CONCLUSION

Although, in some of the described embodiments, SQL was used as an illustrative data query language, other data query languages may be utilized such as, Object Query Language (“OQL”), Enterprise Java Beans Query Language (“EJBQL”), XQUERY, etc. In addition, at least some of the described techniques may be integrated into other types of programming languages, software development environments, or modeling systems, possibly for use in domains other than databases. Other types of programming languages include scripting languages, imperative languages (e.g., C, Pascal, Ada, etc.), functional languages (e.g., ML, Haskell, Miranda, etc.), logic programming languages (e.g., Prolog), constraint programming languages (e.g., CLP(R)), object-oriented languages (e.g., C#, Java, Smalltalk, etc.), etc. For example, extensions to SQL described herein may be equivalently implemented as a form of language integrated query in a language such as C# or Visual Basic. In addition, the methods, system, and article may be used in other problem domains, not just for databases. For example, the techniques described herein may be utilized in the context of modeling systems and/or frameworks, such as GAMS (“General Algebraic Modeling System”), AMPL (“A Modeling Language for Mathematical Programming”), etc.

Furthermore, while relational databases were used as an exemplary data source, the methods, system, and article may be utilized with various data sources. For example, in one embodiment, an object oriented database and/or an XML database may be used in addition to, or instead of, a relational database.

In addition, although some of the above examples illustrate language features that may be utilized by a user to obtain a result (e.g., a database table) that exactly matches a specified set of constraints and/or optimizations, other matching semantics may also be supported. For example, in some embodiments, when no solution is found for a specified set of constraints, the constraints may be automatically relaxed so as to obtain one or more “approximate” solutions, even though that solution may not exactly match the specified set of constraints. In some cases, such approximate solutions may be ranked based on various criteria (e.g., number of constraints matched), so as to provide a “best” solution. In one embodiment, such automatic constraint relaxation may be implemented by configuring an analog processor to solve a maximum clique in a graph representative of the specified set of constraints. Additional details regarding automatic constraint relaxation and other techniques related to processing relational database problems using analog processors are provided in commonly assigned U.S. Provisional Patent Application No. 60/864,127, filed on Nov. 2, 2006, and entitled “PROCESSING RELATIONAL DATABASE PROBLEMS USING ANALOG PROCESSORS”.

All of the U.S. patents, U.S. patent application publications, U.S. patent applications, foreign patents, foreign patent applications and non-patent publications referred to in this specification, including but not limited to U.S. Patent Application Publication No. 2006-0147154, U.S. Provisional Patent Application Ser. No. 60/815,490, U.S. Provisional Patent Application Ser. No. 60/864,127, U.S. Provisional Patent Application No. 60/886,253, U.S. Provisional Patent Application No. 60/915,657, and U.S. Provisional Patent Application No. 60/975,083 are incorporated herein by reference, in their entirety and for all purposes.

As will be apparent to those skilled in the art, the various embodiments described above can be combined to provide further embodiments. Aspects of the present systems, methods and articles can be modified, if necessary, to employ systems, methods, articles and concepts of the various patents, applications and publications to provide yet further embodiments of the present systems, methods and apparatus. For example, the various methods described above may omit some acts, include other acts, and/or execute acts in a different order than set out in the illustrated embodiments.

Various ones of the modules may be implemented in existing database software, whether client-side or server-side. Suitable client-side software packages include use in database API layering (e.g., ODBC, JDBC). Similarly, suitable server-side software packages include, but are not limited to, SQL-based database engines (e.g., MySQL, Microsoft SQL Server, PostgreSQL, Oracle, etc.).

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the present systems, methods and apparatus to the specific embodiments disclosed in the specification and the claims, but should be construed to include all possible embodiments along with the full scope of equivalents to which such claims are entitled. Accordingly, the present systems, methods and apparatus is not limited by the disclosure, but instead its scope is to be determined entirely by the following claims.

While certain aspects of the present systems, methods and apparatus are presented below in certain claim forms, the inventors contemplate the various aspects of the present systems, methods and apparatus in any available claim form. For example, while only some aspects of the present systems, methods and apparatus may currently be recited as being embodied in a computer-readable medium, other aspects may likewise be so embodied.

We claim:

1. A method in a computing system to facilitate modeling and solving a constraint satisfaction and optimization problem, the method comprising:
receiving an indication of a statement in a data query language, the statement including an expression specifying source data, an expression specifying at least one constraint to apply to the source data, and an expression specifying at least one optimization criteria to apply to the source data that satisfies the at least one constraint;
computationally translating the statement in a data query language into a first problem expression in an intermediate mathematical language; and
computationally initiating at least one solvers to determine from the source data at least one solution that satisfies the at least one constraint and the at least one optimization criteria, based at least in part on the first problem expression in the intermediate language.

2. The method of claim 1, further comprising:
populating at least one solution table with the at least one determined solution that satisfies the at least one constraint and the at least one optimization criteria.

3. The method of claim 2, further comprising:
providing the at least one solution table in response to receiving the indication of the statement in the data query language.

4. The method of claim 1 wherein the source data includes at least some data stored in a database, and wherein the expression specifying the source data includes an expression specifying the at least some data stored in a database to be retrieved from the database, the method further comprising:
retrieving from the database the at least some data stored in the database in accordance with the expression specifying the at least some data stored in the database to be retrieved; and
after retrieving the data from the database, providing the source data to the at least one solver.

5. The method of claim 4, wherein the database is a relational database.

6. The method of claim 1, wherein the intermediate mathematical language is Model Expansion language (MX).

7. The method of claim 6, wherein the Model Expansion language further includes at least one of an arithmetic operator, an aggregate operator, or an optimization operator, to model constraint satisfaction and optimization problems.

8. The method of claim 7, wherein the optimization operator includes at least one of a first operator indicative of a maximization objective, a second operator indicative of a minimization objective, a third operator indicative of a Pareto of at least one optimization objective, and a fourth operator indicative of a prioritization of at least one optimization objective.

9. The method of claim 1, wherein computationally translating the statement in a data query language into a first problem expression in an intermediate mathematical language includes computationally translating the statement into the first problem expression in a first-order logic based mathematical language.

10. The method of claim 1, wherein computationally translating the statement in a data query language into a first problem expression in an intermediate mathematical language includes computationally translating the statement into the first problem expression in A Modeling Language for Mathematical Programming (AMPL).

11. The method of claim 1, wherein receiving an indication of a statement in a data query language includes receiving the statement in a data query language based at least in part on Structured Query Language (SQL).

12. The method of claim 1, wherein the expression specifying source data includes an expression of at least one of a table name and at least one instruction expressed in the data query language for extracting data from a database.

13. The method of claim 1, wherein the expression specifying at least one optimization criteria includes at least one of a maximizing of a function, a minimizing of a function, a Pareto of at least one optimization criteria, and a prioritization of at least one optimization criteria.

14. The method of claim 1, wherein the statement in a data query language includes an expression specifying at least one solution table, further comprising:
populating the at least one solution table with the at least one determined solution that satisfies the at least one constraints and the at least one optimization criteria.

15. The method of claim 14, wherein the at least one constraint to apply to the source data includes at least one of a condition constraining which data from the source data may appear in the at least one solution table or a condition that must be satisfied by the at least one solution table.

16. The method of claim 14, wherein the at least one optimization criteria includes at least one of a preference indicative of which data from the source data may appear in the at least one solution table or a preference indicative of which of the at least one solution table is preferred relative to other of the at least one solution table.

17. The method of claim 14, wherein the statement that the data query language includes has at least one of an expression specifying that at least one column in the at least one solution table is unique and an expression specifying that at least one column in the at least one solution table is complete.

18. The method of claim 14, wherein the expression specifying the at least one solution table follows a first keyword indicative of at least one solution table, wherein the expression specifying source data follows a second keyword indicative of a source of data, wherein the expression specifying the one or more constraints follows a third keyword indicative of at least one constraint, and wherein the expression specifying the at least one optimization criteria follows a fourth keyword indicative of the at least one optimization criteria, such as to model constraint satisfaction and optimization problems in the data query language.

19. The method of claim 1, further comprising:
optimizing the first problem expression in an intermediate mathematical language.

20. The method of claim 19, wherein optimizing the problem expression in an intermediate mathematical language includes at least one of removing redundant variables from the first problem expression, setting bounds for variables in the first problem expression, rewriting negations in the first problem expression, and removing redundant relations from the first problem expression.

21. The method of claim 1, further comprising:
analyzing the first problem expression;
determining if the first problem expression is related to at least one defined type of problem; and
wherein automatically initiating at least one solver includes selecting the at least one solver based at least in part on determining if the first problem expression is related to the at least one defined type of problem.

22. The method of claim 1, further comprising:
translating the first problem expression in an intermediate mathematical language into a second problem expression in a language different than the intermediate mathematical language.

23. The method of claim 22, further comprising:
providing the second problem expression to the at least one solver.

24. The method of claim 22, wherein the language different than the intermediate mathematical language is one of at least integer programming and A Modeling Language for Mathematical Programming (AMPL).

25. The method of claim 1, further comprising:
translating the first problem expression in an intermediate mathematical language into a second problem expression in a bytecode representation of the intermediate mathematical language.

26. The method of claim 25, wherein translating the first problem expression in an intermediate mathematical language into a second problem expression includes generating a problem description and an instance description.

27. The method of claim 25 wherein one or more of the one or more solvers are remotely located, further comprising:
Remotely providing the second problem expression in a bytecode representation to the at least one solver.

28. The method of claim 1, wherein automatically translating the statement in a data query language into a first problem expression in an intermediate mathematical language includes automatically translating the statement into a bytecode representation of the first problem expression in an intermediate mathematical language.

29. The method of claim 1, wherein automatically translating the statement in a data query language into a first problem expression in the intermediate mathematical language includes performing at least one of the following translations:
translating at least one indication of solution tables into the first problem expression,
translating at least one indication of source tables into the first problem expression,
translating at least one indication of value expressions into the first problem expression,
translating at least one indication of aggregate operations into the first problem expression,
translating at least one indication of set operations into the first problem expression, and
translating at least one indication of optimization objectives into the first problem expression.

30. A computer-readable medium whose contents enable a computing system to facilitate modeling and solving constraint satisfaction and optimization problems, by performing a method comprising:
receiving an indication of a statement in a data query language, the statement specifying source data, at least one constraint to apply to the source data, and at least one optimization criteria to apply to the source data that satisfies the at least one constraint;
computationally translating the statement in a data query language into a first problem expression in an intermediate mathematical language; and
computationally initiating the at least one solver to determine from the source data at least one solution that satisfies the at least one constraint and the at least one optimization criteria, based at least in part on the first problem expression in the intermediate language.

31. The computer-readable medium of claim 30, wherein the computer-readable medium is at least one of a memory of a computing system and a tangible data transmission medium that transmits a generated data signal containing the contents.

32. A computing system configured to facilitate modeling and solving constraint satisfaction and optimization problems, the computing system comprising:
one or more memories; and
a data query language processing component configured to receive an indication of a statement in a data query language, the statement specifying source data, at least one constraint to apply to the source data, and at least one optimization criteria to apply to the source data; translate the statement in a data query language into a first problem expression in an intermediate mathematical language; and initiate at least one solver to determine from the source data at least one or more solution that satisfies the at least one constraint and the at least one optimization criteria, based at least in part on the first problem expression in the intermediate language.

33. The computing system of claim 32, wherein the data query language processing component is a software application that includes instructions for execution by the computing system.

34. The computing system of claim 32, wherein the at least one solver is executing on a digital processor.

35. The computing system of claim 32, wherein the at least one solver is executing on an analog processor.

36. A method for processing problems expressed in a data query language, the method comprising:
receiving an expression in a data query language;
interacting with an analog processor configured to determine a response to at least some of the received expression; and
providing the determined response.

37. The method of claim 36, further comprising:
transforming the received expression into a primitive problem expression.

38. The method of claim 37 wherein interacting with an analog processor includes invoking an optimization solver configured to determine a solution to the primitive problem expression, the optimization solver executing on the analog processor.

39. The method of claim 37 wherein transforming the received expression into a primitive problem expression includes transforming the received expression into a propositional logic formula, and wherein the analog processor is configured to determine a satisfying assignment to the propositional logic formula.

40. The method of claim 37 wherein transforming the received expression includes interacting with at least one data source to obtain data, and wherein the primitive problem expression is based at least in part on the obtained data.

41. The method of claim 36 wherein receiving an expression in a data query language includes receiving an expression of an optimization problem.

42. The method of claim 36 wherein receiving an expression in a data query language includes receiving an expression of a constraint satisfaction problem.

43. The method of claim 36 wherein the receiving an expression in a data query language includes receiving an expression of a search problem.

44. The method of claim 36, further comprising:
interacting with a digital processor configured to determine a response to at least some of the received expression.

45. A computer-readable medium storing instructions for causing a computing system to process problems expressed in a data query language, by performing a method comprising:
receiving a statement in a data query language;
utilizing an analog processor configured to determine a response to at least some of the received statement; and
providing the determined response.

46. The computer-readable medium of claim 45 wherein the determined response includes a plurality of solutions, and wherein providing the determined response includes providing two or more of the plurality of solutions.

47. The computer-readable medium of claim 45 wherein receiving a statement in a data query language includes receiving a statement that requests a predetermined number of solutions to an optimization problem.

48. The computer-readable medium of claim 45 wherein providing the determined response includes translating the determined response into a solution.

49. The computer-readable medium of claim 45 wherein providing the determined response includes mapping the determined response to a data query response based at least in part on data stored in a database.

50. The computer-readable medium of claim 45 wherein the method further comprises:
obtaining data from a database based on a portion of the received statement, the portion of the received statement being distinct from the at least some of the received statement, wherein providing the determined response is based at least in part on the obtained data.

51. The computer-readable medium of claim 45 wherein the computer-readable medium is a recordable computer-readable medium.

52. The computer-readable medium of claim 45 wherein the computer readable medium is a data transmission medium.

53. A system for processing problems expressed in a data query language, the system comprising:
a memory; and
a module stored on the memory that is configured, when executed, to:
receive a query in a data query language;
invoke an analog processor configured to determine an answer to a portion of the received query; and
provide the determined answer.

54. The system of claim 53 wherein the system is a computing system, and wherein the module contains instructions for execution in the memory of the computing system.

55. The system of claim 53 wherein the module is an optimization solver system.

56. The system of claim 53 wherein the analog processor includes a quantum processor including a plurality of qubits and a plurality of coupling devices coupling respective pairs of qubits.

57. The system of claim 53 wherein the portion of the received query expresses an optimization problem, and wherein the analog processor is configured to solve a graph problem that is equivalent to the optimization problem.

58. The system of claim 53 wherein the query is received from a client program executing on a remote computing system.

59. The system of claim 53 wherein the module is further configured to compile the query into a primitive problem solvable by the analog processor.

60. The system of claim 53, further comprising:
a module stored on the memory that is configured, when executed, to invoke a digital processor configured to determine an answer to a portion of the received query.

61. A method for processing problems expressed in a data query language, the method comprising:
receiving an expression in a data query language;
transforming the received expression into a primitive problem expression;
invoking an optimization solver configured to determine one or more solutions to the primitive problem expression; and
providing the determined one or more solutions as a response to the received expression.

62. The method of claim 61 wherein the optimization solver executes on one or more analog processors.

63. The method of claim 61 wherein the optimization solver executes on a digital processor.

64. The method of claim 61 wherein receiving an expression in a data query language includes receiving an expression of a constraint satisfaction problem.

65. The method of claim 64 wherein invoking an optimization solver includes configuring an analog processor to provide an approximate solution to the constraint satisfaction problem by solving a graph problem representative of the constraint satisfaction problem.

66. The method of claim 61 wherein the receiving an expression in a data query language includes receiving an expression of a search problem.

67. The method of claim 61 wherein transforming the received expression into a primitive problem expression includes compiling the received expression into the primitive problem expression.

68. The method of claim 61 wherein transforming the received expression into a primitive problem expression includes grounding a first order logic formula into a propositional logic formula by replacing variables in the first order logic formula with constant symbols based at least in part on data stored in a database.

69. The method of claim 61 wherein the received expression includes a token indicating that the received expression specifies an optimization problem.

70. The method of claim 61, further comprising:
receiving a second expression in a data query language;
determining that the second expression does not specify an optimization problem;
interacting with a database system configured to determine a response to the second expression; and
providing the determined response to the received second expression.

71. The method of claim 70 wherein determining that the second expression does not specify an optimization problem is based at least in part on the second expression not including a token indicating that the second expression specifies an optimization problem.

72. The method of claim 61 wherein receiving an expression in a data query language includes receiving an expression of an NP-hard problem.

73. The method of claim 61, further comprising:
performing the method a first time to obtain a solution to a specified problem with respect to a dataset of a first size;
performing the method a second time to obtain a solution to the specified problem with respect to a dataset of a second size, wherein the second size is larger than the first size, and wherein the received expression is unchanged between the first and second performance of the method.

74. A computer-readable medium storing instructions for causing a computing system to process problems expressed in a data query language, by performing a method comprising:
receiving a query;
transforming a portion of the received query into a primitive problem expression;
invoking an optimization solver configured to determine one or more solutions to the primitive problem expression; and
providing the determined one or more solutions as a response to the received query.

75. The computer-readable medium of claim 74 wherein invoking an optimization solver includes interacting with a quantum processor configured to solve optimization problems.

76. The computer-readable medium of claim 74 wherein the method further comprises:
obtaining data from a database based on at least some of the received query, the at least some of the received query being distinct from the portion of the received query, wherein providing the determined one or more solutions is based at least in part on the obtained data.

77. The computer-readable medium of claim 74 wherein receiving a query includes receiving a query that requests multiple solutions to an optimization problem, wherein the determined response includes a plurality of solutions, and wherein providing the determined one or more solutions includes providing two or more of the plurality of solutions.

78. The computer-readable medium of claim 74 wherein providing the determined one or more solutions includes translating at least one of the one or more solutions into data query language response based on data provided by a remote database system.

79. A system for processing problems expressed in a data query language, the system comprising:
a memory; and
a module stored on the memory that is configured, when executed, to:
receive an statement in a data query language;
compile a part of the received statement into a primitive problem expression;
interact with an optimization solver configured to determine one or more solutions to the primitive problem expression; and
provide the determined one or more solutions as a response to the received statement.

80. The system of claim 79 wherein the system is a computing system, and wherein the module contains instructions for execution in the memory of the computing system.

81. The system of claim 79 wherein the module is an optimization solver system.

82. The system of claim 79 wherein the optimization solver executes on a remote analog processor.

83. The system of claim 79 wherein the statement expresses an optimization problem, and wherein the optimization solver is configured to solve a graph problem that is equivalent to the optimization problem.

84. The system of claim 79 wherein the statement is received from a program executing on a remote computing system coupled to the system via a network.

85. The system of claim 79 wherein the data query language includes at least one of Structured Query Language, Object Query Language, and Enterprise Java Beans Query Language.

86. The system of claim 79 wherein the module includes an interface configured to provide data query functionality to a client program, the data query functionality being accessed by instructions of the client program, the instructions being in a programming language that is not a data query language.

87. The system of claim 86 wherein the programming language is Java.

88. A method in a client program executing on a client computing system for processing optimization problems, the method comprising:
invoking one or more functions provided by an application program interface on the client computing system, the application program interface operable to:
receive a first problem expression from the client program;
provide a second problem expression to a server computing system operable to obtain a response to the second problem expression from an analog processor, the second problem expression based on the first problem expression;
obtain the response from the server computing system; and
provide a result to the client program, the result based on the obtained response.

89. The method of claim 88 wherein the application program interface is further operable to translate the first problem expression into the second problem expression, wherein the analog processor is configured to determine a response to the second problem expression.

90. The method of claim 88 wherein the application program interface is further operable to post-process the obtained response to obtain the result.

91. The method of claim 88 wherein the first problem expression is identical to the second problem expression.

92. The method of claim 88 wherein the second problem expression defines a decision problem solvable by the quantum processor.

93. A computer readable medium containing an application program interface for obtaining solutions to optimization problems, the application program interface containing instructions that, when executed by a computing system, perform a method comprising:
receiving a first problem expression from a client program executing on the computing system;
providing a second problem expression to a server computing system operable to obtain a response to the second problem expression from an analog processor, the second problem expression based on the first problem expression;
obtaining the response from the server computing system; and
providing a result to the client program, the result based on the obtained response.

94. The computer-readable medium of claim 93 wherein the method further comprises translating the first problem expression into the second problem expression.

95. The computer-readable medium of claim 93 wherein obtaining the response from the server computing system includes polling the server computing system for an indication that the quantum processor has provided the response.
